(19) United States
(12) Patent Application Publication
(10) Pub. No.: US 2019/0385276 A1
(43) Pub. Date: Dec. 19, 2019

(54) IMAGE PROCESSING APPARATUS AND IMAGE PROCESSING METHOD

(71) Applicant: SONY CORPORATION, Tokyo (JP)

(72) Inventor: Kenji KONDO, Tokyo (JP)

(73) Assignee: SONY CORPORATION, Tokyo (JP)

(21) Appl. No.: 16/471,273

(22) PCT Filed: Dec. 28, 2017
(86) PCT No.: PCT/JP2017/047288

§ 371 Date: Jun. 19, 2019

(30) Foreign Application Priority Data
Jan. 13, 2017 (JP) 2017-003917
Aug. 14, 2017 (JP) 2017-156505

(51) Int. Cl. G06T 3/20; G06T 3/40; G06T 3/60; G06T 5/50; G06T 7/215

(52) U.S. Cl. CPC G06T 3/20; G06T 3/40; G06T 2207/20201; G06T 5/50; G06T 7/215; G06T 3/60

(57) ABSTRACT

There is provided an image processing apparatus and an image processing method, both which are to make it possible to reduce overhead in a case in which a highly precise predicted image is generated on the basis of motion vectors. A prediction unit generates a predicted image by performing motion compensation on a reference image in one mode among a translation mode in which the motion compensation is performed by translation, an affine transformation mode in which the motion compensation is performed by an affine transformation, a translation-rotation mode in which the motion compensation is performed by translation and rotation, and a translation-scaling mode in which the motion compensation is performed by translation and scaling. The present disclosure may be applied to an image encoding apparatus, for example.

### TECHNICAL FIELD

The present disclosure relates to an image processing apparatus and an image processing method, and particularly to an image processing apparatus and an image processing method for enabling overhead to be reduced in a case in which a highly precise predicted image is generated on the basis of motion vectors.

### BACKGROUND ART

The Joint Video Exploration Team (JVET), in their search for next-generation video encoding of the International Telecommunication Union Telecommunication Standardization Sector (ITU-T), has proposed inter-prediction processes (affine motion compensation (MC) prediction) by performing an affine transformation on a reference image on the basis of motion vectors of two vertexes (for example, see Non-Patent Literatures 1 and 2). Thus, a highly precise predicted image can be generated by compensating for not only translation (parallel translation) but also motion in a rotational direction between screens and a change in a shape such as expansion or contraction at the time of an inter-prediction process.

### CITATION LIST

### Non-Patent Literature

Non-Patent Literature 1: Jianle Chen and others, “Algorithm Description of Joint Exploration Test Model 4 (JVET-C1001),” JVET of ITU-T SG16 WP3 and ISO/IEC JTC1/SC29/WG11, 26 May to 1 Jun. 2016

Non-Patent Literature 2: Feng Zou, “Improved affine motion prediction (JVET-C0062),” JVET of ITU-T SG16 WP3 and ISO/IEC JTC1/SC29/WG11, 26 May to 1 Jun. 2016

### DISCLOSURE OF INVENTION

### Technical Problem

However, the number of parameters used in the inter-prediction process using affine transformation is more than in an inter-prediction process of compensating for only translation on the basis of one motion vector to generate a predicted image. Accordingly, overhead increases and encoding efficiency deteriorates.

The present disclosure is devised in view of such circumstances and enables overhead to be reduced in a case in which a highly precise predicted image is generated on the basis of motion vectors.

### Solution to Problem

An aspect of the present technology is an image processing apparatus including: a prediction unit configured to generate a predicted image by performing motion compensation on a reference image in one mode among a translation mode in which the motion compensation is performed by translation, an affine transformation mode in which the motion compensation is performed by an affine transformation, a translation-rotation mode in which the motion compensation is performed by translation and rotation, and a translation-scaling mode in which the motion compensation is performed by translation and scaling.

An image processing method according to another aspect of the present disclosure corresponds to the image processing apparatus according to the aspect of the present disclosure.

According to an aspect of the present technology, a prediction unit generates a predicted image by performing motion compensation on a reference image in one mode among a translation mode in which the motion compensation is performed by translation, an affine transformation mode in which the motion compensation is performed by an affine transformation, a translation-rotation mode in which the motion compensation is performed by translation and rotation, and a translation-scaling mode in which the motion compensation is performed by translation and scaling.

### Advantageous Effects of Invention

According to an aspect of the present disclosure, it is possible to generate a predicted image. In addition, according to the aspect of the present disclosure, it is possible to reduce overhead in a case in which a highly precise predicted image is generated on the basis of motion vectors.

Note that the advantageous effects described here are not necessarily limiting and any advantageous effect described in the present disclosure may be obtained.

### BRIEF DESCRIPTION OF DRAWINGS

FIG. 1 is an explanatory diagram illustrating an inter-prediction process of performing motion compensation on the basis of one motion vector.

FIG. 2 is an explanatory diagram illustrating an inter-prediction process of performing motion compensation on the basis of one motion vector and a rotational angle.

FIG. 3 is an explanatory diagram illustrating an inter-prediction process of performing motion compensation on the basis of two motion vectors.

FIG. 4 is an explanatory diagram illustrating an inter-prediction process of performing motion compensation on the basis of three motion vectors.

FIG. 5 is an explanatory diagram illustrating blocks before and after an affine transformation based on three motion vectors.

FIG. 6 is an explanatory diagram illustrating a QTBT.

FIG. 7 is an explanatory diagram illustrating a first example of motion occurring in each PU in an image.

FIG. 8 is an explanatory diagram illustrating a second example of motion occurring in each PU in an image.

FIG. 9 is an explanatory diagram illustrating a third example of motion occurring in each PU in an image.

FIG. 10 is an explanatory diagram illustrating a fourth example of motion occurring in each PU in an image.

FIG. 11 is a block diagram illustrating a configuration example of an embodiment of an image encoding apparatus.

FIG. 12 is an explanatory diagram illustrating a translation mode.

FIG. 13 is an explanatory diagram illustrating a first example of a translation-rotation mode.

FIG. 14 is an explanatory diagram illustrating a second example of a translation-rotation mode.

FIG. 15 is an explanatory diagram illustrating a first example of a translation-scaling mode.

FIG. 16 is an explanatory diagram illustrating a second example of a translation-scaling mode.

FIG. 17 is an explanatory diagram illustrating motion compensation mode information and parameter information.

FIG. 18 is an explanatory diagram illustrating a motion vector included in an adjacent parameter which is a candidate for a prediction vector.

FIG. 19 is an explanatory flowchart illustrating an image encoding process.

FIG. 20 is an explanatory flowchart illustrating an inter-prediction process mode setting process.

FIG. 21 is an explanatory flowchart illustrating a merge mode encoding process.

FIG. 22 is an explanatory flowchart illustrating an AMVP mode encoding process.

FIG. 23 is a block diagram illustrating a configuration example of an embodiment of an image decoding apparatus.

FIG. 24 is an explanatory flowchart illustrating an image decoding process.

FIG. 25 is an explanatory flowchart illustrating a motion compensation mode information decoding process.

FIG. 26 is an explanatory flowchart illustrating a merge mode decoding process.

FIG. 27 is an explanatory flowchart illustrating an AMVP mode decoding process.

FIG. 28 is an explanatory diagram further illustrating motion compensation of a translation-rotation mode (an inter-prediction process by the motion compensation).

FIG. 29 is an explanatory diagram illustrating motion compensation based on a vertical difference dv_{y} in a case in which a rotational angle θ is a size which cannot be called small.

FIG. 30 is an explanatory diagram illustrating motion compensation for suppressing contraction of a reference block in motion compensation based on the vertical difference dv_{y} and causing precision of a predicted image of PU31 to be improved.

FIG. 31 is an explanatory flowchart illustrating an example of a process for motion compensation of a translation-rotation mode in a case in which motion compensation based on a horizontal difference dvₓ is adopted as motion compensation of the translation-rotation mode.

FIG. 32 is an explanatory diagram illustrating another example of the motion compensation mode information.

FIG. 33 is a block diagram illustrating a hardware configuration example of a computer.

FIG. 34 is a block diagram illustrating an example of a schematic configuration of a television apparatus.

FIG. 35 is a block diagram illustrating an example of a schematic configuration of a mobile telephone.

FIG. 36 is a block diagram illustrating an example of a schematic configuration of a recording/reproducing apparatus.

FIG. 37 is a block diagram illustrating an example of a schematic configuration of an imaging apparatus.

FIG. 38 is a block diagram illustrating one example of a schematic configuration of a video set.

FIG. 39 is a block diagram illustrating one example of a schematic configuration of a video processor.

FIG. 40 is a block diagram illustrating another example of a schematic configuration of a video processor.

FIG. 41 is a block diagram illustrating one example of a schematic configuration of a network system.

### MODE(S) FOR CARRYING OUT THE INVENTION

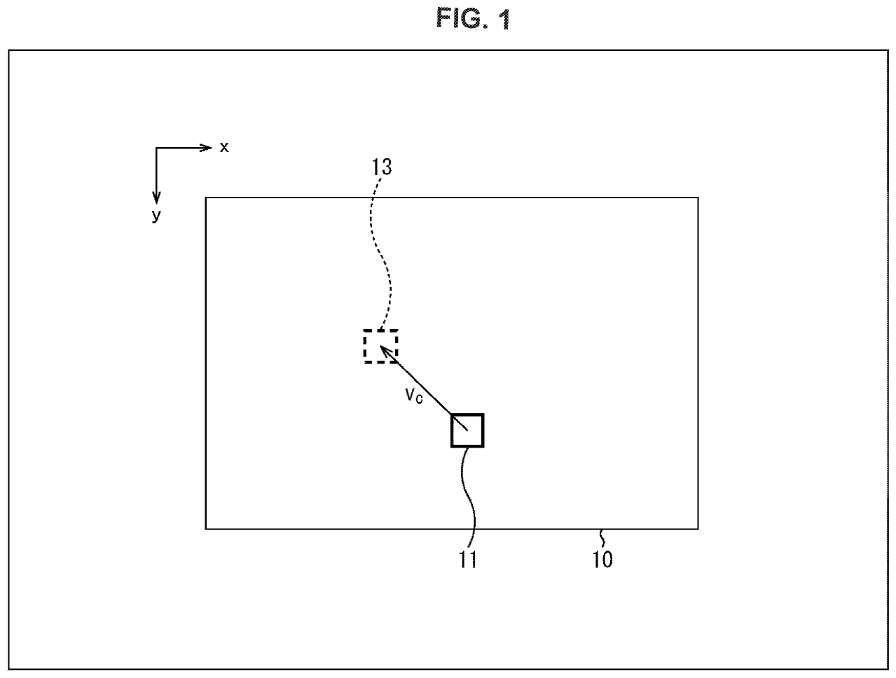

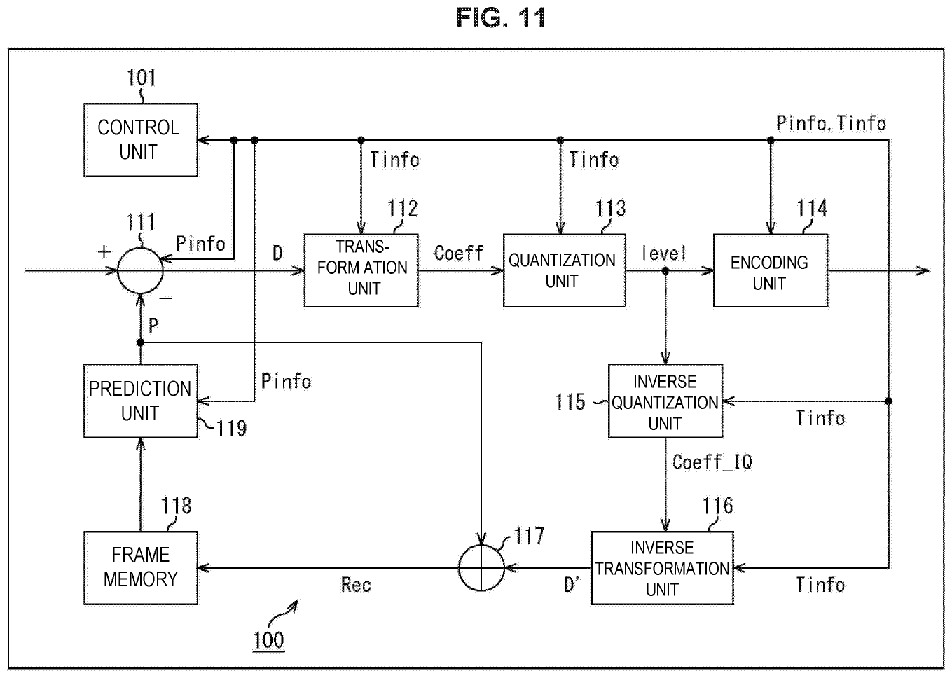

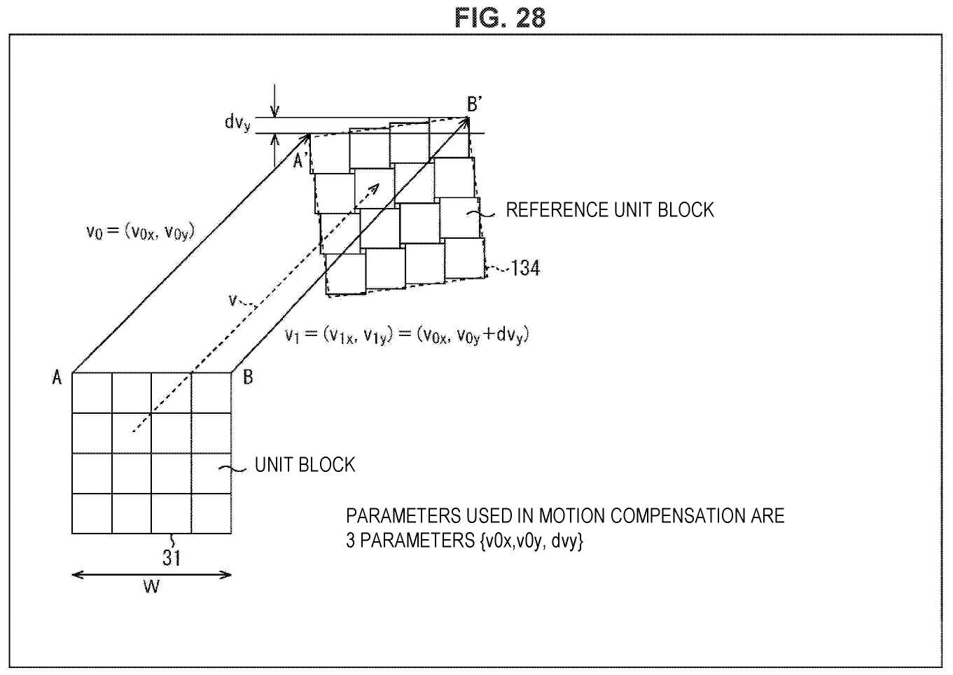

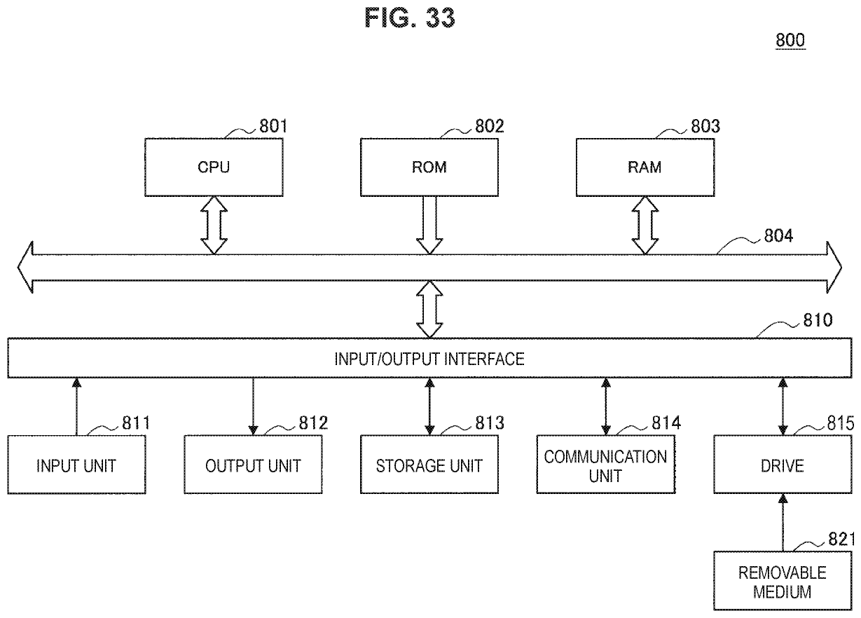

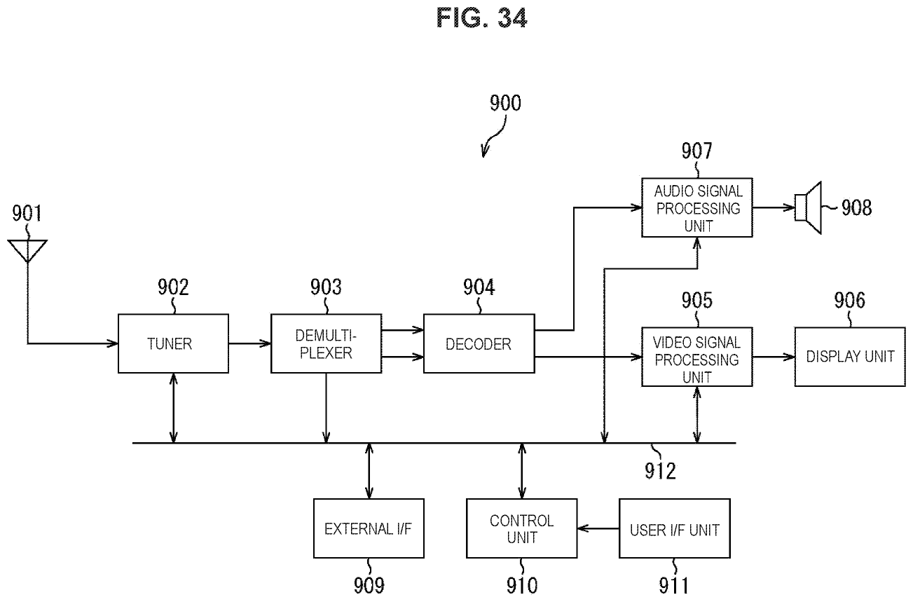

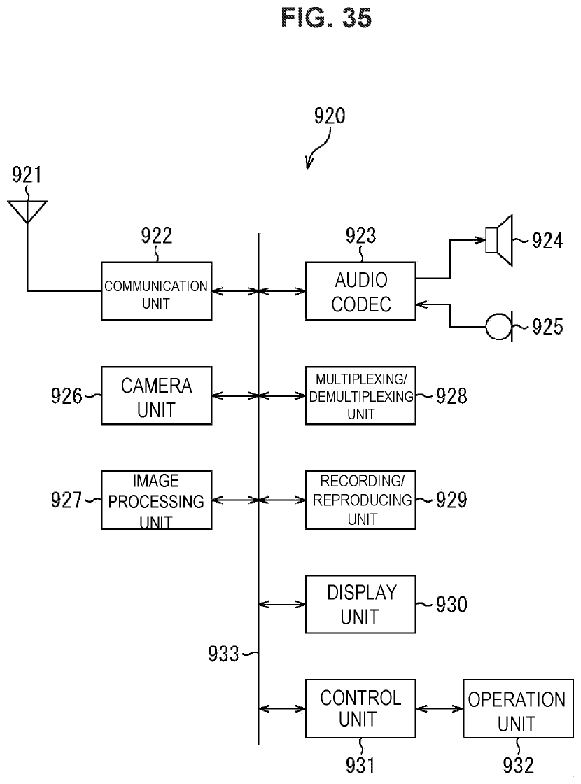

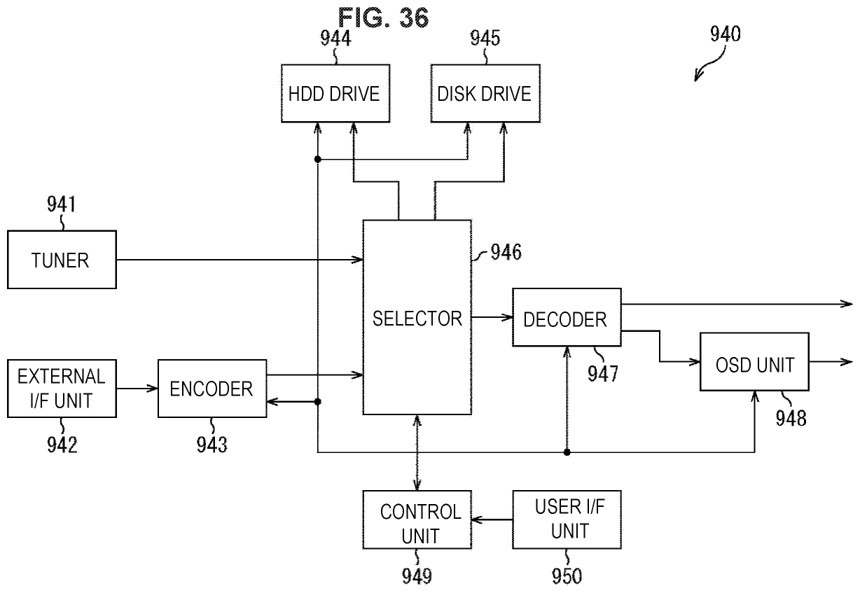

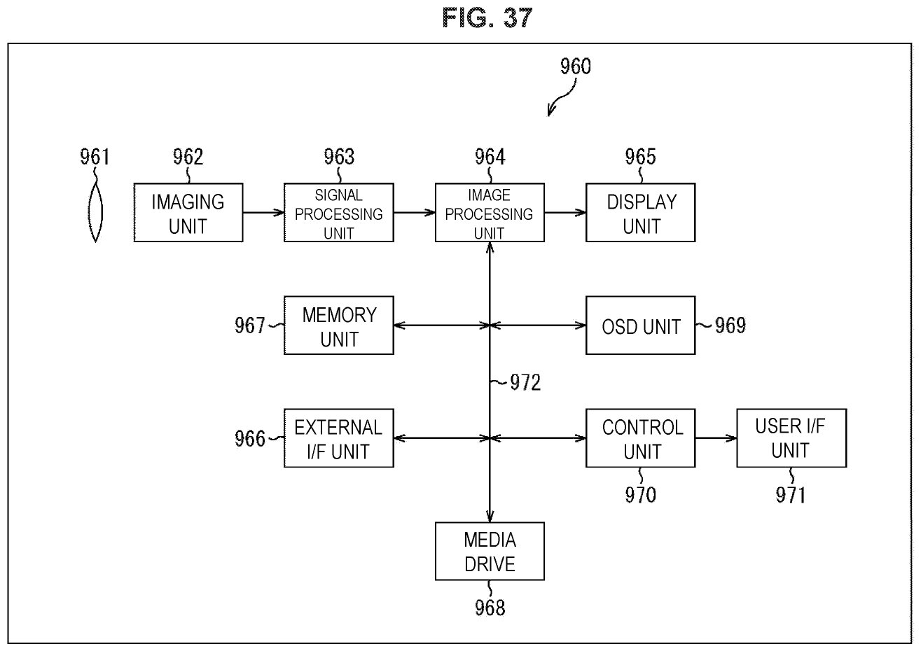

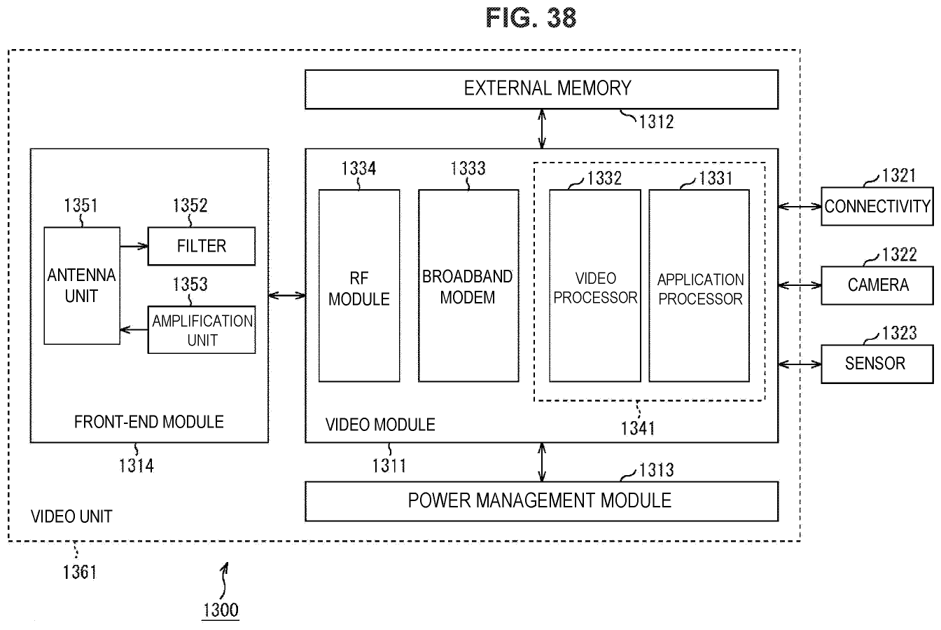

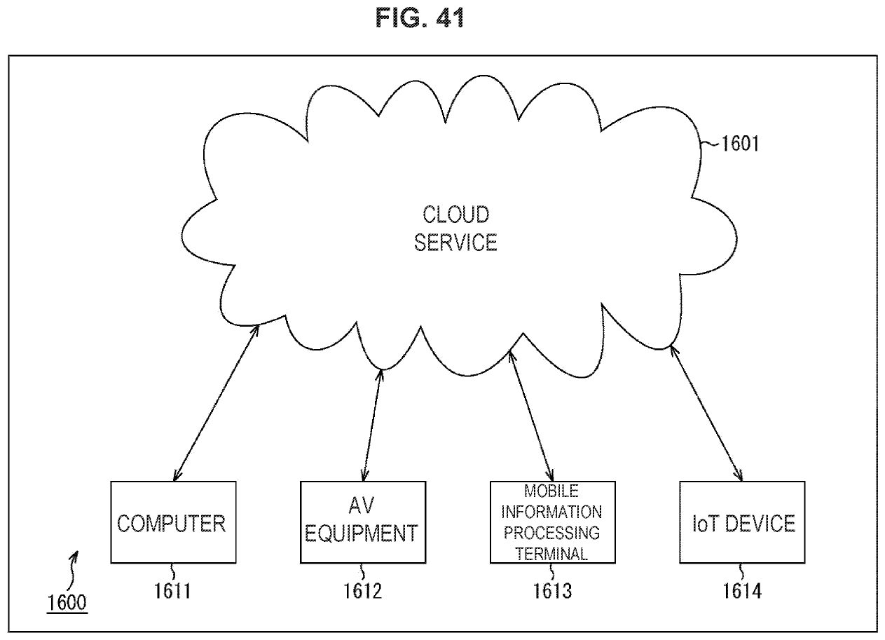

Hereinafter, the premise of the present disclosure and a mode for carrying out the present disclosure (hereinafter referred to as an embodiment) will be described. Note that the description will be mode in the following order.
0. Premise of present disclosure (FIGS. 1 to 10)
1. First embodiment: image processing apparatus (FIGS. 11 to 27)
2. Second embodiment: motion compensation of translation-rotation mode (FIGS. 28 to 32)
3. Third embodiment: computer (FIG. 33)
4. Fourth embodiment: television apparatus (FIG. 34)
5. Fifth embodiment: mobile telephone (FIG. 35)
6. Sixth embodiment: recording/reproducing apparatus (FIG. 36)
7. Seventh embodiment: imaging apparatus (FIG. 37)
8. Eighth embodiment: video set (FIGS. 38 to 40)
9. Ninth embodiment: network system (FIG. 41)

### <Premise of Present Disclosure>

### (Description of Inter-Prediction Process of Performing Motion Compensation on Basis of One Motion Vector)

FIG. 1 is an explanatory diagram illustrating an inter-prediction process of performing motion compensation on the basis of one motion vector (hereinafter referred to as a 2-parameter MC prediction process).

Note that, hereinafter, the longitudinal direction (horizontal direction) of an image (picture) is referred to as an x direction and a transverse direction (vertical direction) is referred to as a y direction unless otherwise stated.

As illustrated in FIG. 1, in the 2-parameter MC prediction process, one motion vector v_{c} (v_{cx}, v_{cy}) is decided for a prediction target PU 11 (a current block). Then, a predicted image of PU 11 is generated through motion compensation by translating a block 13 with the same size as the PU 11 and for which a distance from the PU 11 is the motion vector v_{c} in a reference image at a different time from a picture 10 including the PU 11, on the basis of the motion vector v_{c}.

That is, in the 2-parameter MC prediction process, a predicted image obtained by compensating for only translation between screens of the reference image without performing an affine transformation is generated. In addition, two parameters, v_{cx}, and v_{cy} are used in the inter-prediction process. The inter-prediction process is adopted in Advanced Video Coding (AVC) or High Efficiency Video Coding (HEVC) or the like.

### (Explanation of an Inter-Prediction Process of Performing Motion Compensation on the Basis of One Motion Vector and a Rotational Angle)

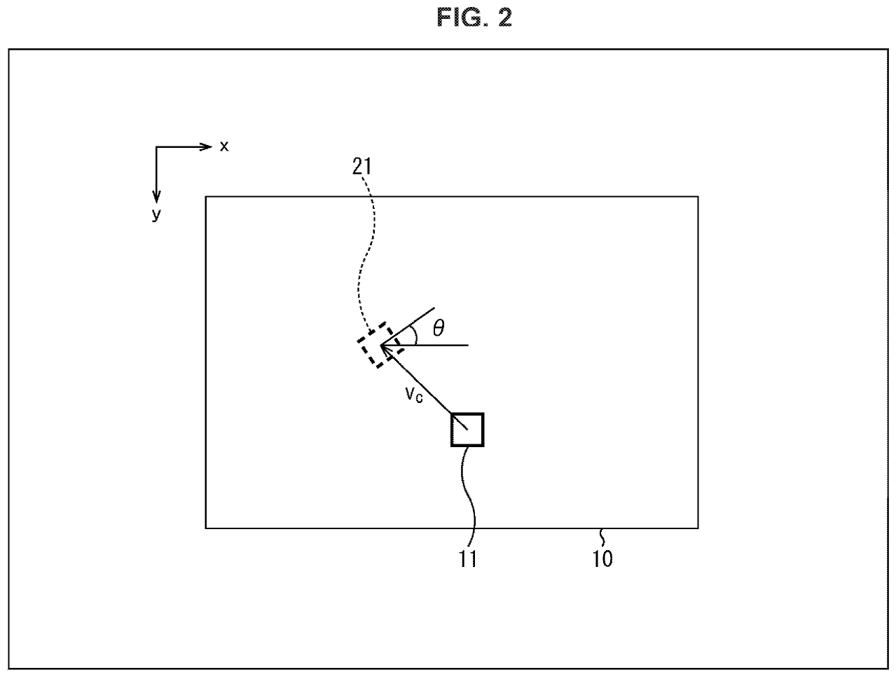

FIG. 2 is an explanatory diagram illustrating an inter-prediction process of performing motion compensation on the basis of one motion vector and a rotational angle.

As illustrated in FIG. 2, one motion vector v^{c} (v_{cx}, v_{cy}) and a rotational angle θ are decided for the prediction target PU 11 in an inter-prediction process of performing motion compensation on the basis of one motion vector and a rotational angle. Then, a predicted image of the PU 11 is generated through motion compensation by performing an affine transformation on the basis of the motion vector v_{c} and the rotational angle θ on a block 21 with the same size as the PU 11 which is at an inclination of the rotational angle θ at a position for which a distance from the PU 11 is the motion vector v_{c} in the reference image at a different time from a picture 10 including the PU 11.

That is, in the inter-prediction process of performing the motion compensation on the basis of one motion vector and a rotational angle, an affine transformation is performed on the reference image on the basis of one motion vector and the rotational angle. Thus, a predicted image obtained by compensating for translation and a motion in a rotational direction between screens is generated. Accordingly, precision of the predicted image is improved above that in the 2-parameter MC prediction process. In addition, three parameters, v_{cx}, v_{cy}, and θ, are used in the inter-prediction process.

### (Explanation of an Inter-Prediction Process of Performing Motion Compensation on the Basis of Two Motion Vectors)

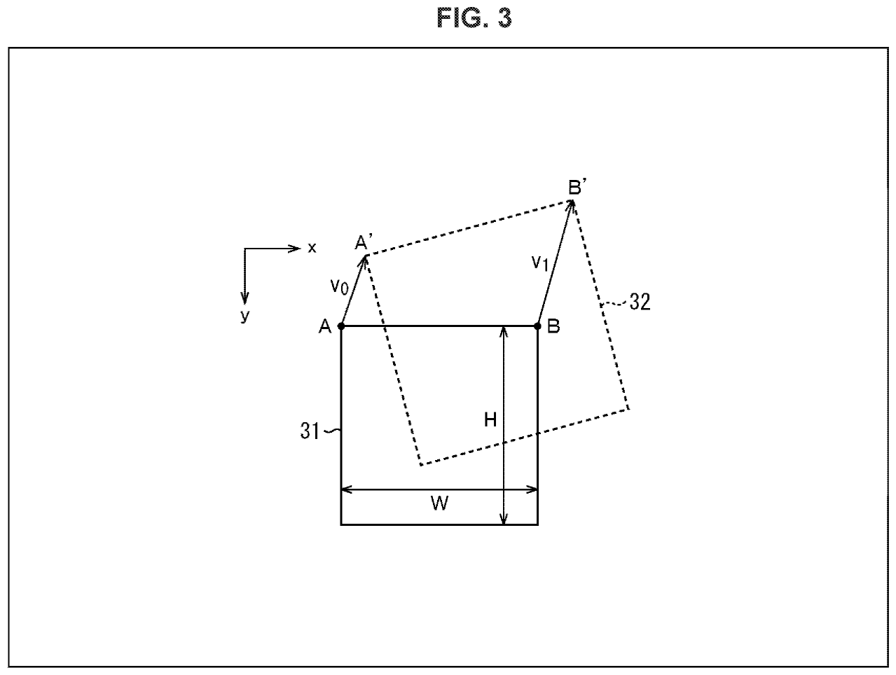

FIG. 3 is an explanatory diagram illustrating an inter-prediction process of performing motion compensation on the basis of two motion vectors (hereinafter referred to as a 4-parameter affine MC prediction process).

As illustrated in FIG. 3, in a 4-parameter affine MC prediction process, a motion vector v₀ (v₀ₓ, v_{0y}) at a top left vertex A of a prediction target PU 31 and a motion vector v₁ (v₁ₓ, v_{1y}) at a top right vertex B of the prediction target PU 31 are decided.

Then, the motion compensation is performed by performing an affine transformation on the basis of a motion vector v₀ and a motion vector v₁ on a block 32 in which a point A′ for which a distance from the vertex A is the motion vector v₀ is set as the top left vertex and a point B′ for which a distance from the vertex B is the motion vector v1 is set as the top right vertex in a reference image at a different time from a picture including PU 31, to generate a predicted image of PU 31.

Specifically, PU 31 is split into blocks with a predetermined size (hereinafter referred to as unit blocks). Then, a motion vector v (vₓ, v_{y}) of each unit block is obtained by Expression (1) below on the basis of the motion vector v₀ (v₀ₓ, v_{0y}) and the motion vector v₁ (v₁ₓ, v_{1y}).

$$\begin{matrix}[ Math . 1 ] & \\ {v}_{x} = \frac{( {v}_{1 x} - {v}_{0 x} )}{W} x - \frac{( {v}_{1 y} - {v}_{0 y} )}{H} y + {v}_{0 x} \\ {v}_{y} = \frac{( {v}_{1 y} - {v}_{0 y} )}{W} x + \frac{( {v}_{1 x} - {v}_{0 x} )}{H} y + {v}_{0 y} & ( 1 )\end{matrix}$$

Note that W is a size of PU 31 in the x direction and H is a size of PU 31 in the y direction. Accordingly, in a case in which PU 31 is a square, W and H are equal. In addition, x and y are a position of the unit block in the x direction and the y direction. According to Expression (1), the motion vector v of the unit block is decided on the basis of the position (x, y) of the unit block.

Then, a predicted image of each unit block is generated by translating a block with the same size as the unit block and for which a distance from each unit block is the motion vector v in the reference image on the basis of the motion vector v, and the predicted image of PU 31 is generated in accordance with the predicted image of each unit block.

As described above, in the 4-parameter affine MC prediction process, the affine transformation is performed on the reference image on the basis of the two motion vectors. Thus, a predicted image obtained by compensating for not only translation and a motion in the rotational direction between screens but also a change in a shape such as expansion or contraction is generated. Accordingly, precision of the predicted image is improved above that in the inter-prediction process of performing the motion compensation on the basis of one motion vector and a rotational angle. In addition, four parameters, v₀ₓ, v_{0y}, v₁ₓ and v_{1y}, are used in the inter-prediction process. The inter-prediction process is adopted as Joint Exploration Model (JEM) reference software.

Note that an affine transformation based on two motion vectors is an affine transformation based on the premise that blocks before and after the affine transformation are rectangular. Even in a case in which the blocks before and after the affine transformation are quadrangles other than rectangles, three motion vectors are necessary to perform the affine transformation.

### (Explanation of an Inter-Prediction Process of Performing Motion Compensation on the Basis of Three Motion Vectors)

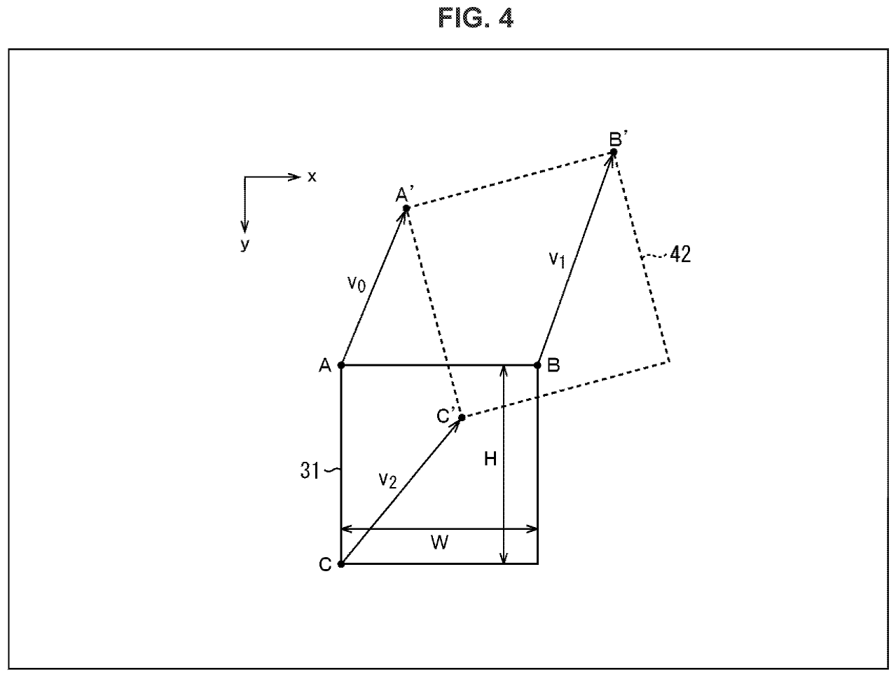

FIG. 4 is an explanatory diagram illustrating an inter-prediction process of performing motion compensation on the basis of three motion vectors (hereinafter referred to as a 6-parameter affine MC prediction process).

As illustrated in FIG. 4, in a 6-parameter affine MC prediction process, not only the motion vector v₀ (v₀ₓ, v_{0y}) and the motion vector v₁ (v₁ₓ, v_{1y}), but also a motion vector v₂ (v₂ₓ, v_{2y}) of a bottom left vertex C is decided for the prediction target PU 31.

Then, the motion compensation is performed by performing an affine transformation on the basis of a motion vector v₀ to a motion vector v₂ on a block 42 in which a point A′ for which a distance from the vertex A is the motion vector v₀ is set as the top left vertex, a point B′ for which a distance from the vertex B is the motion vector v1 is set as the top right vertex, and a point C′ for which a distance from the vertex C is the motion vector v₂ is set as the bottom left vertex in a reference image at a different time from a picture including PU 31, to generate a predicted image of PU 31.

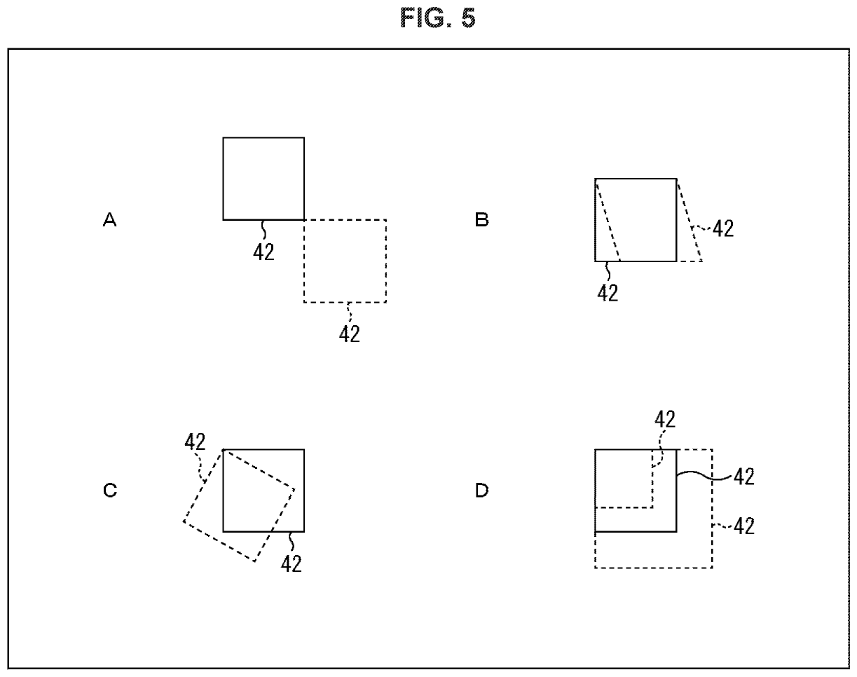

That is, in the 6-parameter affine MC prediction process, the affine transformation is performed on the reference image on the basis of three motion vectors. Thus, a block 42 is translated as illustrated in A of FIG. 5, is skewed as illustrated in B of FIG. 5, is rotated as illustrated in C of FIG. 5, or is expanded or contracted (scaled) as illustrated in D of FIG. 5.

As a result, a predicted image obtained by compensating for a change in the shape such as translation and motion in a rotational direction between screens and expansion or contraction and skewing is generated. Note that the block 42 before the affine transformation is indicated by a solid line and the block 42 after the affine transformation is indicated by a dotted line in FIG. 5.

On the other hand, in the 4-parameter affine MC prediction process described in FIG. 3, skewing of the predicted image may not be compensated for, but the change in the shape such as translation and the motion in the rotational direction between the screens and the expansion or contraction can be compensated for. Accordingly, in the 4-parameter affine MC prediction process and the 6-parameter affine. MC prediction process, the precision of the predicted image is improved above that in the 2-parameter MC prediction process of compensating for only the translation between the screens.

However, in the 4-parameter affine MC prediction process, four parameters, v₀ₓ, v_{0y}, v₁ₓ, and v_{1y}, are used in the inter-prediction process. In addition, in the 6-parameter affine MC prediction process, six parameters, v₀ₓ, v_{0y}, v₁ₓ, v_{1y}, v₂ₓ, and v_{2y}, are used in the inter-prediction process. Accordingly, the number of parameters used in the inter-prediction process increases more than in the 2-parameter MC prediction process. Accordingly, suppression of overhead and improvement in the prediction precision of the inter-prediction process have a tradeoff relation.

Note that JVET has proposed a technology for switching between the 4-parameter affine MC prediction process and the 6-parameter affine MC prediction process in accordance with a control signal.

### (Description of QTBT)

In an existing image encoding scheme such as Moving Picture Experts Group 2 (MPEG2) (ISO/IEC 13818-2) or AVC, an encoding process is performed in units of processes called macroblocks. A macroblock is a block that has a size equal to 16×16 pixels. On the other hand, in HEVC, an encoding process is performed in units of processes (encoding units) called CUs. A CU is a block that is formed by recursively splitting a largest coding unit (LCU) which is a maximum encoding unit and has a variable size. A selectable maximum size of the CU is 64×64 pixels. A selectable minimum size of the CU is 8×8 pixels. The CU with the minimum size is referred to as a smallest coding unit (SCU). Note that the maximum size of the CU is not limited to 64×64 pixels, but may be a larger block size such as 128×128 pixels or 256×256 pixels.

In this way, as a result obtained by adopting a CU that has a variable size, it is possible to adaptively adjust image quality and encoding efficiency in accordance with content of an image in HEVC. A prediction process for prediction encoding is performed in units of processes called PUs. A PU is formed h splitting a CU in one of several splitting patterns. In addition, the PU is configured in a process unit called a prediction block (PB) for each luminance (Y) and color difference (Cb, Cr). Further, an orthogonal transformation process is performed in units of processes called transform units (TUs). A TU is formed by splitting a CU or a PU in a certain depth. In addition, a TU is configured in units of processes (transformation blocks) called transform blocks (TBs) for each luminance (Y) and color difference (Cb, Cr).

Hereinafter, “block” is used as a process unit or a partial region of an image (picture) for description in some cases (which is not a block of a processing unit). In this case, “block” indicates any partial region in the picture and the size, shape, characteristics, and the like of the block are not limited. That is, in this case, “block” is assumed to include, for example, any partial region (units of processes) such as a TB, a TU, a PB, a PU, an SCU, a CU, an LCU (CTB), a subblock, a macroblock, a tile, or a slice.

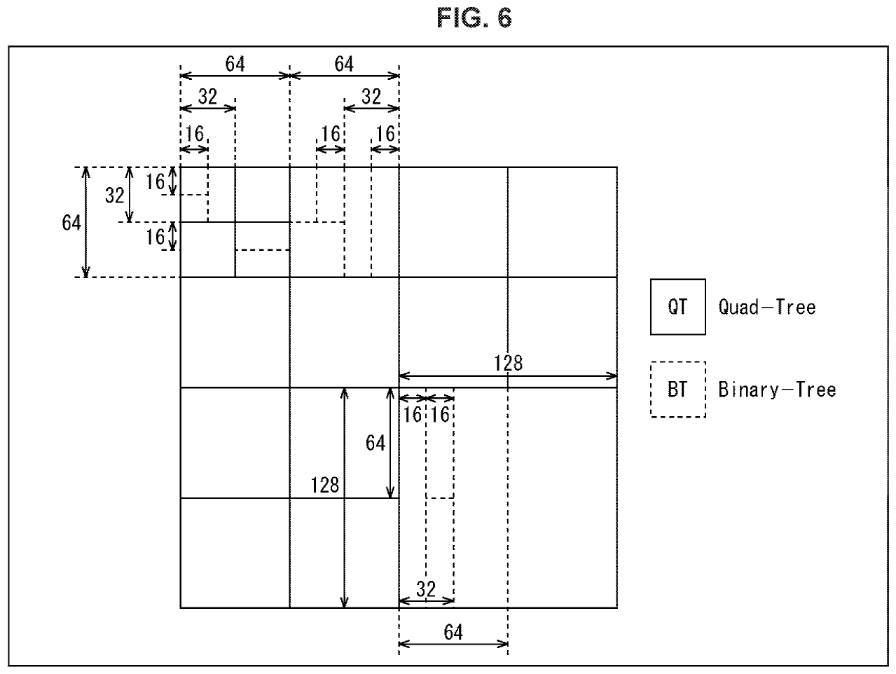

FIG. 6 is an explanatory diagram illustrating a quad tree plus binary tree (QTBT) adopted in JVET.

In HEVC, one block can be split into 4 (=2×2) subblocks in the horizontal direction and the vertical direction. In QTBT, on the other hand, one block can be split into 2 (=1×2 or 2×1) subblocks in only one of the horizontal direction or the vertical direction rather than the 4 (=2×2) subblocks. That is, in QTBT, in the formation of the coding unit (CU), splitting of one block into four or two subblocks is recursively repeated, and thus a tree structure with a quad-tree shape or a binary-tree shape is consequently formed. Accordingly, there is a possibility of the shape of the CU being rectangular rather than square. Note that the PU and TU are assumed to be the same as a CU below.

### (Description of Motion Occurring in Each PU)

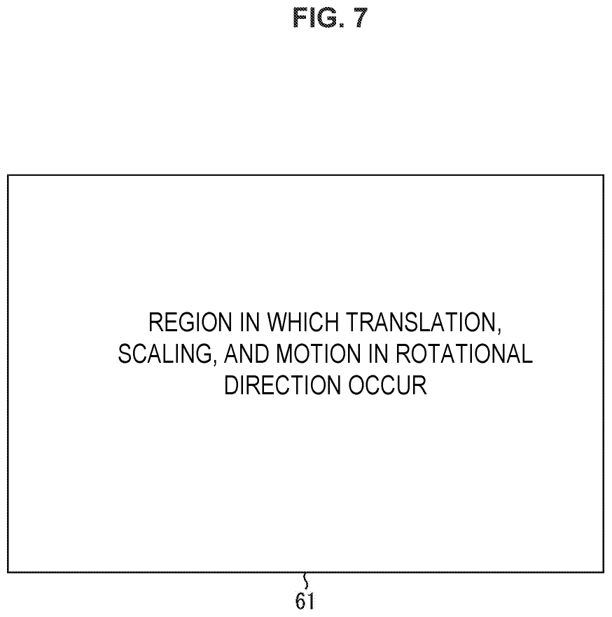

FIGS. 7 to 10 are explanatory diagrams illustrating motions occurring in each PU in an image.

In the example of FIG. 7, in the entire image 61, translation, scaling (expansion or contraction), and a motion in a rotational direction occur with respect to the reference image. In this case, in the inter-prediction process of all the PUs in the image 61, it is preferable to perform the 4-parameter alpine MC prediction process and generate a predicted image obtained by compensating for the translation, the scaling, and the motion in the rotational direction between screens.

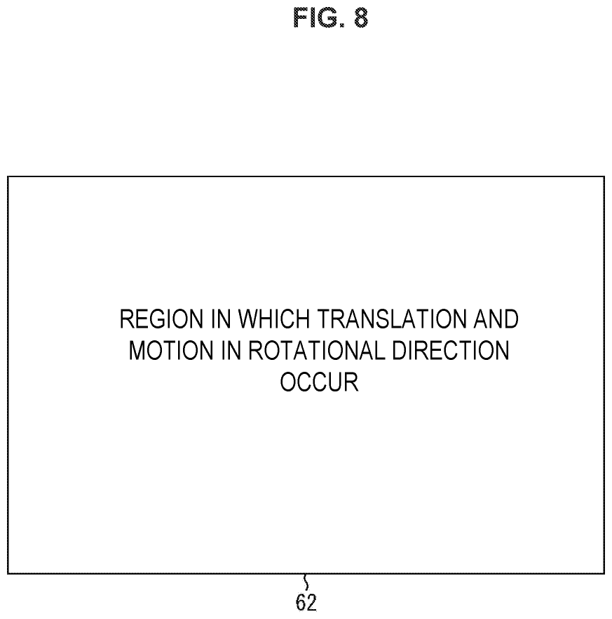

On the other hand, in the example of FIG. 8, in an entire image 62, translation and a motion in a rotational direction also occur between the reference image and the entire image 62 due to camera shake or the like at the time of photographing. In this case, in the inter-prediction process for all the PUs in the image 62, it is not necessary to compensate for the scaling in addition to the translation and the motion in the rotational direction between the screens by performing the 4-parameter affine MC prediction process.

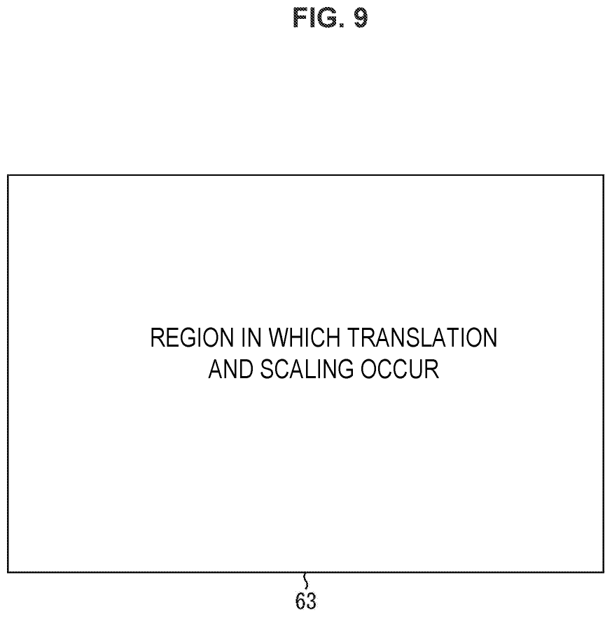

In addition, in the example of FIG. 9, in the entire image 63, translation and scaling occur between the reference image and the image 63 due to zoom-in or zoom-out at the time of photographing. In this case, in the inter-prediction process for all the PUs in the image 63, it is not necessary to compensate for the motion in the rotational direction in addition to the translation and the scaling between the screens by performing the 4-parameter affine MC prediction process.

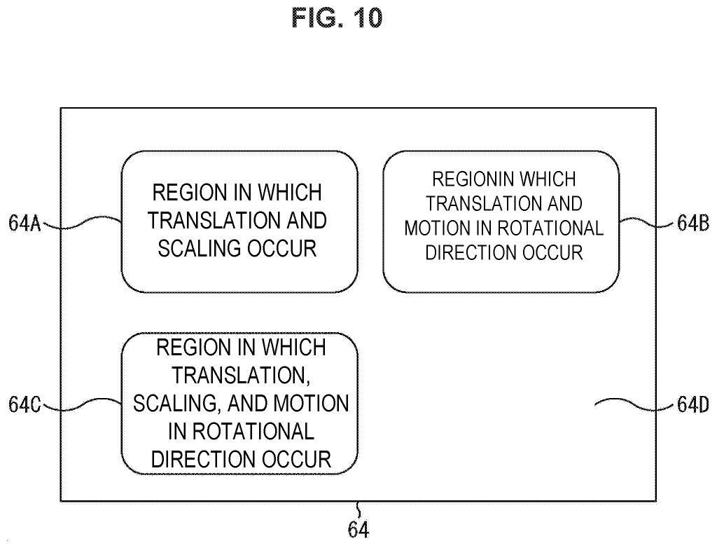

Further, in the example of FIG. 10, an image 64 includes a region 64A in which translation and scaling occur between a reference image and the image 64, a region 64B in which translation and a motion in a rotational direction occur, a region 64C in which translation, scaling, and a motion in a rotational direction occur, and a region 64D in which only translation occurs.

In this case, it is preferable to perform the 4-parameter affine MC prediction process in the inter-prediction process for the PUs in the region 64C. However, in the inter-prediction process for the PUs in the region 64A, the region 64B, and the region 64D, it is not necessary to perform the 4-parameter affine MC prediction process and compensate for all the translation, the motion in the rotational direction, and the scaling between the screens.

As described above, in an inter-prediction process for the PUs in which none of translation, a motion in a rotational direction, or scaling occurs, it is not necessary to perform the 4-parameter affine MC prediction process and compensate for all the translation, the motion in the rotational direction, and the scaling between the screens. Accordingly, when the 4-parameter affine MC prediction process is performed in the inter-prediction process for all the PUs, overhead (an encoding amount of overhead) may be unnecessarily increased and encoding efficiency may deteriorate.

Accordingly, in the present disclosure, a translation mode, a translation-rotation mode in which the 2-parameter MC prediction process is performed, a translation-scaling mode, and an affine transformation mode in which the 4-parameter affine MC prediction process is performed are prepared as motion compensation modes, and motion compensation is performed in a motion compensation mode appropriate for the inter-prediction process of each PU. Note that the translation-rotation mode is a mode in which translation and rotation are performed on the basis of three parameters of rotational angle information indicating a rotation angle and one motion vector v_{c} (v_{cx}, v_{cy}) to compensate for the translation and the motion in the rotational direction. The translation-scaling mode is a mode in which translation and scaling are performed on the basis of three parameters of scaling information indicating a scaling ratio and one motion vector v_{c} (v_{cx}, v_{cy}) to compensate for the translation and the scaling.

As described above, in the inter-prediction process for the PUs in which translation and a motion in a rotational direction occur, the motion compensation in the translation-rotation mode can be performed. In the inter-prediction process for the PUs in which translation and scaling occur, the motion compensation in the translation-scaling mode can be performed. As a result, the number of parameters used in the inter-prediction process for the PUs is three less than the number of parameters in the 4-parameter affine MC prediction process. Accordingly, in a case in which the 4-parameter affine MC prediction process is performed on all the PUs, overhead is reduced, thereby improving encoding efficiency.

### First Embodiment

### (Configuration Example of Image Encoding Apparatus)

FIG. 11 is a block diagram illustrating a configuration example of an embodiment of an image encoding apparatus serving as an image processing apparatus to which the present disclosure is applied. The image encoding apparatus 100 in FIG. 11 is an apparatus that encodes a prediction residual between an image and its predicted image as in AVC or HEVC. For example, a technology of HEVC or a technology proposed by JVET is mounted on the image encoding apparatus 100.

Note that FIG. 11 illustrates main configurations such as flows of processing units and data, and the like, and FIG. 11 is not illustrating entire configurations. That is, there may be processing units in the image encoding apparatus 100 that are not illustrated as blocks in FIG. 11 or flows of processes and data that are not indicated by arrows and the like in FIG. 11.

The image encoding apparatus 100 in FIG. 11 includes a control unit 101, a calculation unit 111, a transformation unit 112, a quantization unit 113, an encoding unit 114, an inverse quantization unit 115, an inverse transformation unit 116, a calculation unit 117, a frame memory 118, and a prediction unit 119. The image encoding apparatus 100 performs encoding on a picture which is a moving image of input units of frames for each CU.

Specifically, the control unit 101 (setting unit) of the image encoding apparatus 100 sets encoding parameters (header information Hinfo, prediction information Pinfo, transformation information Tinfo, and the like) on the basis of an input from the outside, rate-distortion optimization (RDO), and the like.

The header information Hinfo includes, for example, information regarding a video parameter set (VPS), a sequence parameter set (SPS), a picture parameter set (PPS), a slice header (SH), and the like. For example, the header information Hinfo includes information for defining an image size (a horizontal width PicWidth and a vertical width PicHeight), a bit depth (luminance bitDepthY and a color difference bitDepthC), a maximum value MaxCUSize/minimum value MinCUSize of the CU size, and the like. Of course, any content of the header information Hinfo may be used and any kind of information other than the above-described information may be included in the header information Hinfo.

The prediction information Pinfo includes, for example, a split flag indicating whether there is splitting in the horizontal direction or the vertical direction in each splitting hierarchy when the PU (the CU) is formed. In addition, the prediction information Pinfo includes mode information pred_mode_flag indicating whether a prediction process of a PU is an intra-prediction process or an inter-prediction process for each PU.

In a case in which the mode information pred_mode_flag indicates the inter-prediction process, the prediction information Pinfo includes a merge flag, motion compensation mode information, parameter information, reference image specifying information for specifying the reference image, and the like. The merge flag is information indicating whether a mode of the inter-prediction process is a merge mode or an AMVP mode. The merge mode is a mode in which the inter-prediction process is performed on the basis of a prediction parameter selected from candidates including parameters generated on the basis of parameters (a motion vector, rotational angle information, and scaling information) used in the motion compensation of an adjacent PU which is an encoded PU adjacent to a processing target PU (hereinafter referred to as an adjacent parameter). The AMVP mode is a mode in which the inter-prediction process is performed on the basis of the parameter of the processing target PU. The merge flag is 1 in a case in which the merge flag indicates the merge mode, and is 0 in a case in which the merge flag indicates the AMVP mode.

The motion compensation mode information is information indicating whether the motion compensation mode is the translation mode, the affine transformation mode, the translation-rotation mode, or the translation-scaling mode.

In a case in which the merge flag is 1, the parameter information is information for specifying parameters used in the inter-prediction process as prediction parameters (a prediction vector, prediction rotational angle information, and prediction scaling information) among candidates including the adjacent parameters. In addition, in a case in which the merge flag is 0, the parameter information is the information for specifying the prediction parameter and a difference between the parameter of the processing target PU and the prediction parameter.

In a case in which the mode information pred_mode_flag indicates the intra-prediction process, the prediction information Pinfo includes intra-prediction mode information indicating an intra-prediction mode which is a mode of the intra-prediction process, or the like. Of course, content of the prediction information Pinfo is arbitrary and any information other than the above-described information may be included in the prediction information Pinfo.

The transformation information Tinfo includes TBSize indicating the size of the TB, or the like. Of course, content of the transformation information Tinfo is arbitrary and any information other than the above-described information may be included in the transformation information Tinfo.

The calculation unit 111 sets input pictures as encoding target pictures in sequence and sets encoding target CUs (PUs or TUs) in the encoding target pictures on the basis of the split flag of the prediction information Pinfo. The calculation unit 111 obtains a prediction residue D by subtracting a predicted image P (predicted block) of the PU supplied from the prediction unit 119 from an image I (current block) of the encoding target PU and supplies the prediction residue D to the transformation unit 112.

The transformation unit 112 performs an orthogonal transformation or the like on the prediction residue D supplied from the calculation unit 111 on the basis of the transformation information Tinfo supplied from the control unit 101 to derive a transformation coefficient Coeff. The transformation unit 112 supplies the transformation coefficient Coeff to the quantization unit 113.

The quantization unit 113 scales (quantizes) the transformation coefficient Coeff supplied from the transformation unit 112 on the basis of the transformation information Tinfo supplied from the control unit 101 to derive a quantization transformation coefficient level level. The quantization unit 113 supplies the quantization transformation coefficient level level to the encoding unit 114 and the inverse quantization unit 115.

The encoding unit 114 encodes the quantization transformation coefficient level level or the like supplied from the quantization unit 113 in accordance with a predetermined method. For example, the encoding unit 114 transforms the encoding parameters (the header information Hinfo, the prediction information Pinfo, the transformation information Tinfo, and the like) supplied from the control unit 101 and the quantization transformation coefficient level level supplied from the quantization unit 113 into syntax values of each syntax component in accordance with definitions of the syntax table. Then, the encoding unit 114 performs encoding (for example, arithmetic encoding such as context-based adaptive binary arithmetic coding (CABAC)) on each syntax value.

At this time, the encoding unit 114 switches a context of a probability model of the CABAC on the basis of the motion compensation mode information of the adjacent PUs to set the probability model of the CABAC so that a probability of the motion compensation mode information of the adjacent PUs increases, and encodes the motion compensation mode information of the PUs.

That is, as illustrated in FIG. 10, it is predicted that the region 64A in which translation and scaling occur between the reference image and the image 64, the region 64B in which translation and a motion in a rotational direction occur, the region 64C in which translation, scaling, and a motion in a rotational direction occur, and the region 64D in which only translation occurs are collected and exist in the image 64. Accordingly, there is a high possibility of the motion compensation mode information of a certain PU and an adjacent PU being the same.

For example, in a case in which the adjacent PU of the certain PU exists in the region 64A and the translation-scaling mode is selected as the motion compensation mode, there is a high possibility of the PU also existing in the region 64A and the translation-scaling mode being selected as the motion compensation mode. In addition, in a case in which the adjacent PU of the certain PU exists in the region 64B and the translation-rotation mode is selected as the motion compensation mode, there is a high possibility of the PU also existing in the region 64B and the rotation scaling mode being selected as the motion compensation mode.

Further, in a case in which the adjacent PU of the certain PU exists in the region 64C and the affine transformation mode is selected as the motion compensation mode, there is a high possibility of the PU also existing in the region 64C and the affine transformation mode being selected as the motion compensation mode. In addition, in a case in which the adjacent PU of the certain PU exists in the region 64D and the translation mode is selected as the motion compensation mode, there is a high possibility of the PU also existing in the region 64D and the translation mode being selected as the motion compensation mode.

Accordingly, the encoding unit 114 sets a probability model of the CABAC so that the probability of the motion compensation mode information of the adjacent PUs increases and encodes the motion compensation mode information of the PUs. Thus, it is possible to reduce overhead, thereby improving encoding efficiency.

Note that, in a case in which the number of adjacent PUs is plural, the encoding unit 114 may set the probability model of the CABAC on the basis of the number of adjacent PUs for each piece of motion compensation mode information. In addition, the encoding unit 114 may switch a sign (bit string) allocated to the motion compensation mode information rather than switching context of the probability model of the CABAC on the basis of the motion compensation mode information.

For example, the encoding unit 114 multiplexes encoded data which is a bit string of each syntax component obtained as the encoding and outputs the multiplexed encoded data as an encoded stream.

The inverse quantization unit 115 scales (performs inverse quantization on) the value of the quantization transformation coefficient level level supplied from the quantization unit 113 on the basis of the transformation information Tinfo supplied from the control unit 101 to derive a transformation coefficient Coeff_IQ after the inverse quantization. The inverse quantization unit 115 supplies the transformation coefficient Coeff_IQ to the inverse transformation unit 116. The inverse quantization performed by the inverse quantization unit 115 is an inverse process to the quantization performed by the quantization unit 113 and is a similar process to the inverse quantization performed in an image decoding apparatus to be described below.

The inverse transformation unit 116 performs an inverse orthogonal transformation or the like on the transformation coefficient Coeff_IQ supplied from the inverse quantization unit 115 on the basis of the transformation information Tinfo supplied from the control unit 101 to derive a prediction residue D′. The inverse transformation unit 116 supplies the prediction residue D′ to the calculation unit 117. The inverse orthogonal transformation performed by the inverse transformation unit 116 is an inverse process to the orthogonal transformation performed by the transformation unit 112 and is a similar process to the inverse orthogonal transformation performed in the image decoding apparatus to be described below.

The calculation unit 117 adds the prediction residue D′ supplied from the inverse transformation unit 116 and the predicted image P corresponding to the prediction residue D′ and supplied from the prediction unit 119 to derive a local decoded image Rec. The calculation unit 117 supplies the local decoded image Rec to the frame memory 118.

The frame memory 118 reconstructs the decoded image in units of pictures using the local decoded image Rec supplied from the calculation unit 117 and stores the decoded image in a buffer in the frame memory 118. The frame memory 118 reads the decoded image designated by the prediction unit 119 as a reference image from the buffer and supplies the decoded image to the prediction unit 119. In addition, the frame memory 118 may store the header information Hinfo, the prediction information Pinfo, the transformation information Tinfo, and the like related to the generation of the decoded image in the buffer in the frame memory 118.

In a case in which the mode information pred_mode_flag of the prediction information Pinfo indicate the intra-prediction process, the prediction unit 119 acquires the decoded image at the same time as the encoding target CU stored in the frame memory 118 as a reference image. Then, the prediction unit 119 performs the intra-prediction process of the intra-prediction mode indicated by the intra-prediction mode information on the encoding target PU using the reference image.

In addition, in a case in which the mode information pred_mode_flag indicates the inter-prediction process, the prediction unit 119 acquires a decoded image at a different time from the encoding target CU stored in the frame memory 118 as a reference image on the basis of the reference image specifying information. The prediction unit 119 performs the inter-prediction process of the encoding target PU using the reference image on the basis of the merge flag, the motion compensation mode information, and the parameter information.

Specifically, in a case in which the motion compensation ode information indicates the translation mode, the prediction unit 119 performs the inter-prediction process of the translation mode by compensating for translation of the reference image on the basis of one motion vector. Note that in a case in which the merge flag is 1, one motion vector used in the inter-prediction process is one prediction vector specified by the parameter information. Conversely, in a case in which the merge flag is 0, one motion vector used in the inter-prediction process is one motion vector obtained by adding a difference included in the parameter information and one prediction vector specified by the parameter information.

In addition, in a case in which the motion compensation mode information indicates the affine transformation mode, the prediction unit 119 performs the inter-prediction process of the affine transformation mode by performing an affine transformation based on two motion vectors on the reference image to compensate for translation, scaling, and a motion in a rotational direction. Note that in a case in which the merge flag is 1, two motion vectors used in the inter-prediction process are two prediction vectors specified by the parameter information. Conversely, in a case in which the merge flag is 0, two motion vectors used in the inter-prediction process are two motion vectors which can be obtained by adding the two prediction vectors specified by the parameter information and differences included in the parameter information in correspondence with the prediction vectors.

Further, in a case in which the motion compensation mode information indicates the translation-rotation mode, the prediction unit 119 performs the inter-prediction process of the translation-rotation mode by compensating for the translation and the motion in the rotational direction on the reference image on the basis of one motion vector and the rotational angle information. Note that in a case in which the merge flag is 1, one motion vector and the rotational angle information used in the inter-prediction process are a prediction vector and prediction rotational angle information specified by the parameter information. Conversely, in a case in which the merge flag is 0, one motion vector used in the inter-prediction process is one motion vector obtained by adding one prediction vector specified by the parameter information and a difference included in the parameter information. In addition, the rotational angle information is one piece of rotational angle information obtained by adding the prediction rotational angle information specified by the parameter information and a difference included in the parameter information.

In a case in which the motion compensation mode information indicates the translation-scaling mode, the prediction unit 119 performs the inter-prediction process of the translation-scaling mode by compensating for the translation and the scaling on the reference image on the basis of one motion vector and the scaling information. Note that in a case in which the merge flag is 1, one motion vector and the scaling information used in the inter-prediction process are a prediction vector and prediction scaling information specified by the parameter information. Conversely, in a case in which the merge flag is 0, one motion vector used in the inter-prediction process is one motion vector obtained by adding one prediction vector specified by the parameter information and a difference included in the parameter information. In addition, the scaling information is one piece of scaling information obtained by adding the prediction scaling information specified by the parameter information and a difference included in the parameter information.

The prediction unit 119 supplies the predicted image P generated as a result of the intra-prediction process or the inter-prediction process to the calculation unit 111 or the calculation unit 117.

### (Description of Translation Mode)

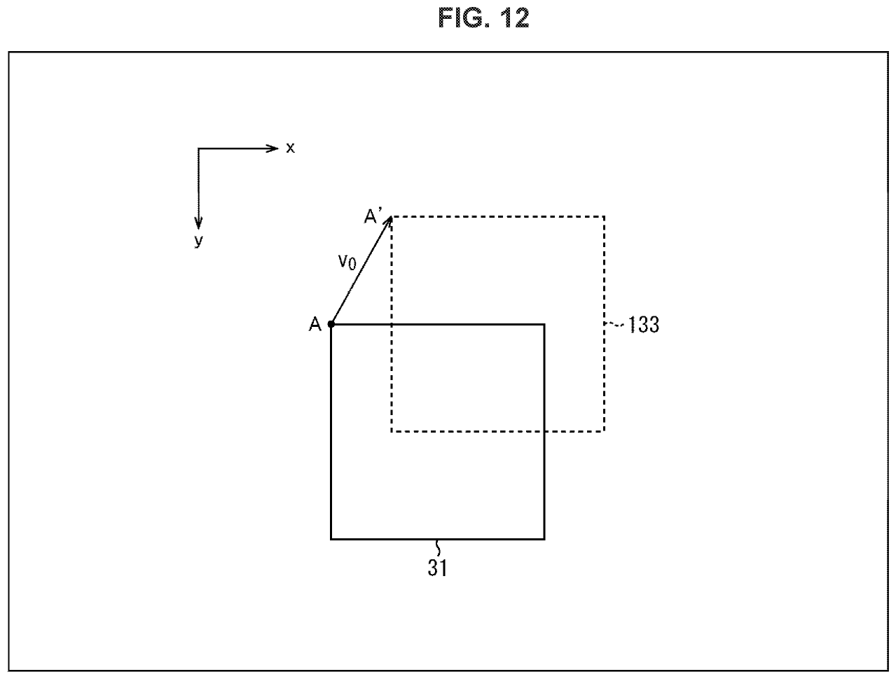

FIG. 12 is an explanatory diagram illustrating the translation mode.

As illustrated in FIG. 12, in a case in which the motion compensation mode is the translation mode, the prediction unit 119 translates a block 133 that has the same size as the PU 31 and has a point A′ for which a distance from PU 31 is the motion vector v₀ in the reference image as the top left vertex on the basis of the motion vector v0 of the top left vertex A of the processing target PU 31. Then, the prediction unit 119 sets the block 133 after the translation as a predicted image of the PU 31. In this case, the parameters used in the inter-prediction process are two parameters, v₀ₓ and v_{0y}.

### (Description of Translation-Rotation Mode)

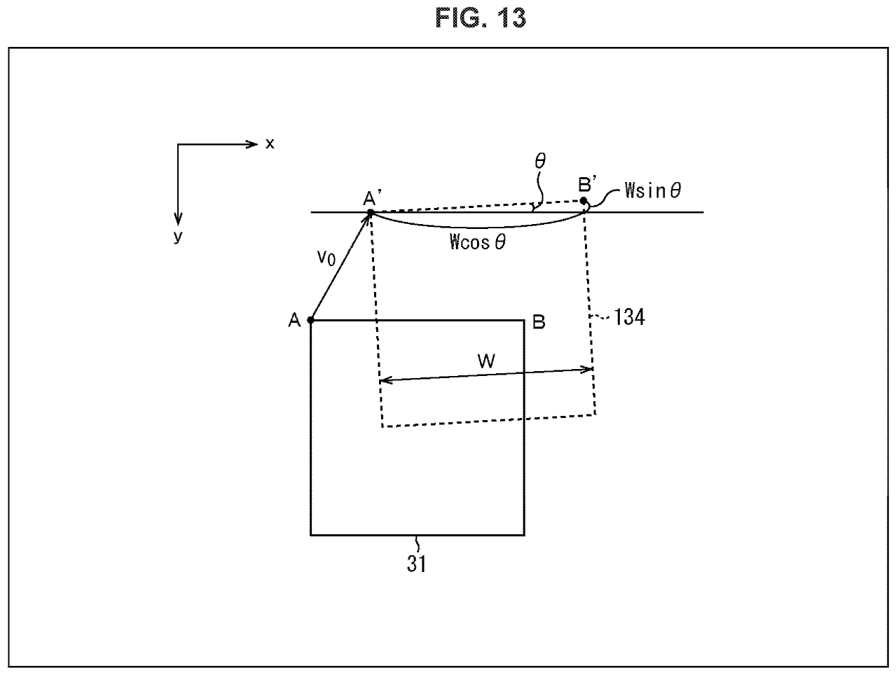

FIG. 13 is an explanatory diagram illustrating the translation-rotation mode.

As illustrated in FIG. 13, in a case in which the motion compensation mode is the translation-rotation mode, the prediction unit 119 sets the point A′ for which a distance from the PU 31 is the motion vector v₀ in the reference image as the top left vertex on the basis of the motion vector v₀ of the vertex A of the processing target PU 31 and the rotational angle θ serving as the rotational angle information and translates and rotates a block 134 that has the same size as the PU 31 and is rotated by the rotational angle θ. Then, the prediction unit 119 sets the block 134 after the translation and the rotation as a predicted image of the PU 31. In this case, three parameters, v₀ₓ, v_{0y}, and θ are used in the inter-prediction process.

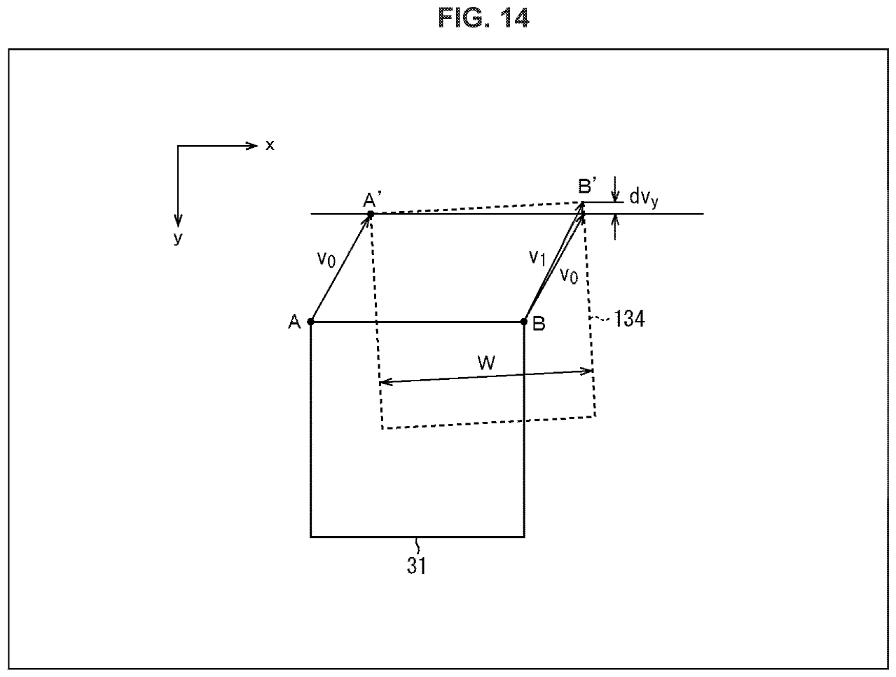

Note that in the example of FIG. 13, the rotational angle θ is used as the rotational angle information. However, as illustrated in FIG. 14, a difference dv_{y} between the motion vector v₀ of the vertex A and the motion vector v₁ of the vertex B in the vertical direction may be used. That is, in a case in which θ is small, W sin θ can be approximated to the difference dv_{y}. Therefore, the rotational angle θ may be substituted with the difference dv_{y}. In this case, it is not necessary to calculate a trigonometric function at the time of the motion compensation and reduce a calculation amount at the time of the motion compensation.

### (Description of Translation-Scaling Mode)

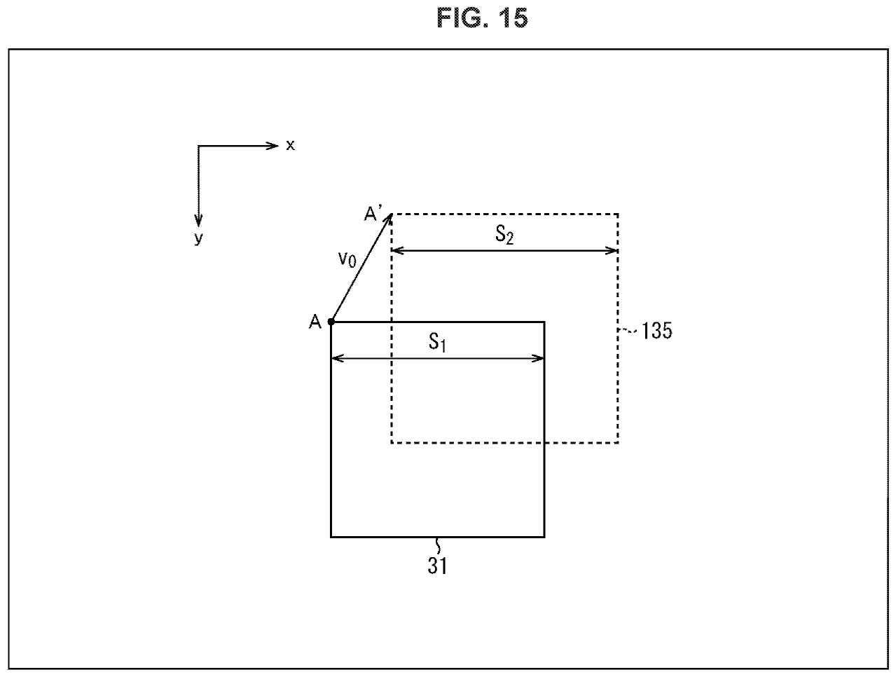

FIG. 15 is an explanatory diagram illustrating the translation-scaling mode.

As illustrated in FIG. 15, in a case in which the motion compensation mode is the translation-scaling mode, the prediction unit 119 performs the translation and the scaling on a block 135 that has an S multiple of the size of the PU 31 and has the point A′ for which a distance from the PU 31 is the motion vector v₀ as the top left vertex in the reference image by 1/s multiples on the basis of motion vector v₀ of the vertex A of the processing target PU 31 and a scaling ratio S serving as scaling information. Then, the prediction unit 119 sets a block 135 after the translation and the scaling as a predicted image of the PU 31. In this case, three parameters, v₀ₓ, v_{0y}, and S are used in the inter-prediction process.

Note that the scaling ratio S is represented as S₂/S₁ when a size W of the PU 31 is S₁ and the size of the block 135 in the x direction is S₂. Since the size S₁ is known, the size S₂ can be obtained from the size S₁ using the scaling ratio S.

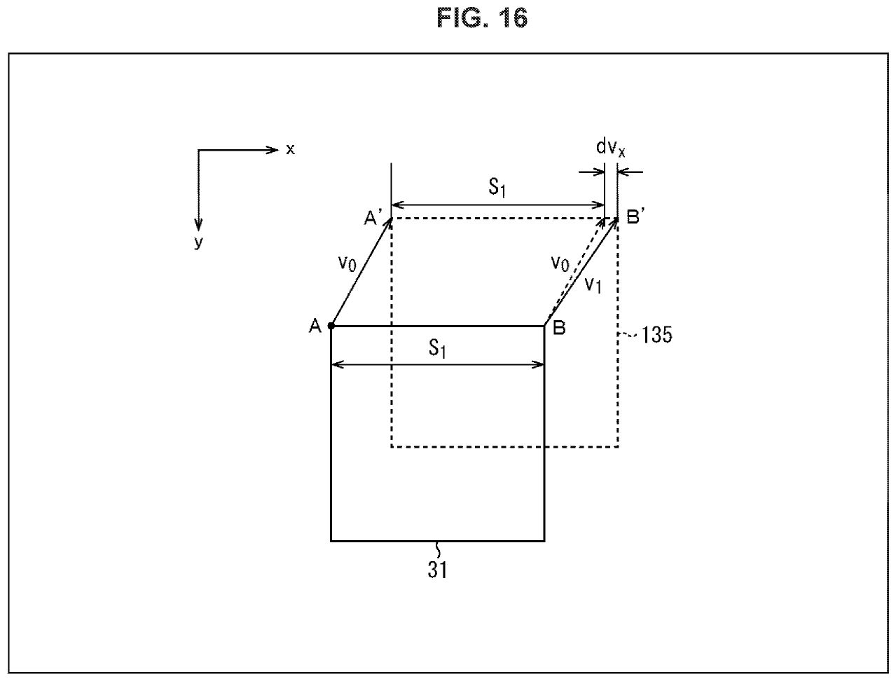

In the example of FIG. 15, the scaling ratio S is used as the scaling information. However, as illustrated in FIG. 16, a difference dvₓ between the motion vector v₀ of the vertex A and the motion vector v₁ of the vertex B in the horizontal direction may be used. That is, the size S₂ may be approximated to S₁+dvₓ. In this case, the size S of the block 135 in the horizontal direction can be obtained through only addition of the size S₁ and the difference dvₓ, and thus a calculation amount at the time of the motion compensation can be reduced. In addition, the scaling ratio S is (S₁+dvₓ)/S₁.

### (Description of Motion Compensation Mode Information and Parameter Information)

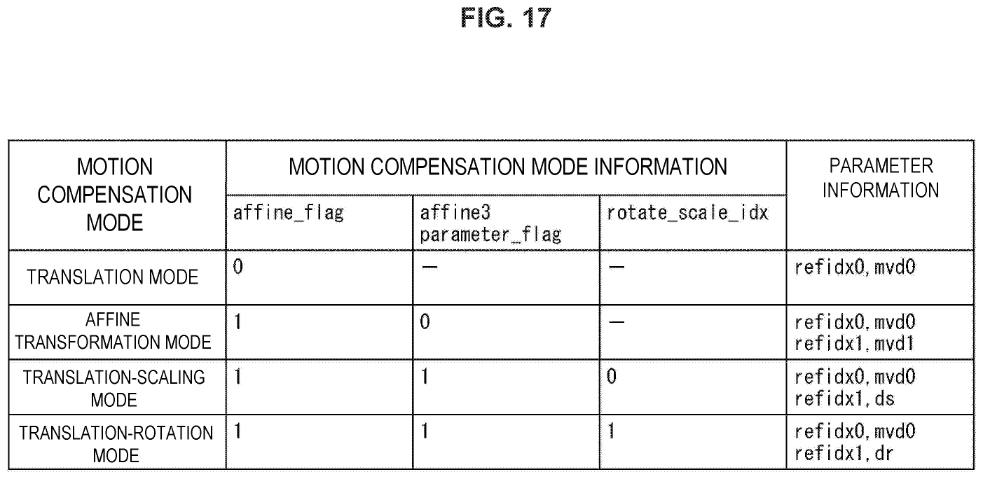

FIG. 17 is an explanatory diagram illustrating motion compensation mode information and parameter information.

As illustrated in FIG. 17, the motion compensation mode information includes affine_flag, affine3parameter_flag, and rotate_scale_idx.

Here, affine_flag (affine transformation information) is information indicating whether the motion compensation mode is the affine transformation mode, the translation-scaling mode, or the translation-rotation mode other than a normal translation mode. In a case in which the motion compensation mode is the affine transformation mode, the translation-rotation mode, or the translation-scaling mode, affine_flag is 1. Conversely, in a case in which the motion compensation mode is not the affine transformation mode, the translation-rotation mode, and the translation-scaling mode, that is, the motion compensation mode is the translation mode, affine_flag is 0.

In addition, affine3parameter_flag (translation expansion information) is information indicating whether the motion compensation mode is the translation-scaling mode or the translation-rotation mode and is set in a case in which affine_flag is 1. In a case in which the motion compensation mode is the translation-scaling mode or the translation-rotation mode, affine3parameter_flag is 1. Conversely, in a case in which the motion compensation mode is not the translation-scaling mode and the translation-rotation mode, that is, indicates that the motion compensation mode is the affine transformation mode, affine3parameter_flag is 0.

In addition, rotate_scale_idx (translation rotation information) is information indicating whether the motion compensation mode is the translation-rotation mode and is set in a case in which affine3parameter_flag is 1. In a case in which the motion compensation mode is the translation-rotation mode, rotate_scale_idx is 1. In a case in which the motion compensation mode is not the translation-rotation mode, that is, that the motion compensation mode is the translation-scaling mode, rotate_scale_idx is 0.

Accordingly, in a case in which the motion compensation mode is the translation mode, the motion compensation mode information includes affine_flag and affine_flag is 0. In addition, in a case in which the motion compensation mode is the affine transformation mode, the motion compensation mode information includes affine_flag and affine3parameter_flag, affine_flag is 1, and affine3parameter_flag is 0.

Further, in a case in which the motion compensation mode is the translation-scaling mode or the translation-rotation mode, the motion compensation mode information includes affine_flag, affine3parameter_flag, and rotate_scale_idx. In addition, in a case in which the motion compensation mode is the translation-scaling mode, affine_flag and affine3parameter_flag are 1 and rotate_scale_idx is 0. In addition, in a case in which the motion compensation mode is the translation-rotation mode, affine_flag, affine3parameter_flag, and rotate_scale_idx are 1.

In addition, in a case in which a mode of the inter-prediction process is the AMVP mode, information for specifying a prediction vector corresponding to one motion vector of a processing target PU is set as refidx0 of the parameter information and a difference between the one motion vector and the prediction vector is set as mvd0 of the parameter information when the motion compensation mode is the translation mode.

When the motion compensation mode is the affine transformation mode, refidx0 and mvd0 of the parameter information are set as in the translation mode. In addition, information for specifying a prediction vector corresponding to another motion vector of the processing target PU is set as refidx1 of the parameter information and a difference between the motion vector and the prediction vector is set as mvd1 of the parameter information.

When the motion compensation mode is the translation-scaling mode, refidx0 and mvd0 of the parameter information are set as in the translation mode. In addition, information for specifying prediction scaling information corresponding to scaling information of the processing target PU is set as refidx1 of the parameter information and a difference between the scaling information and the prediction scaling information is set as ds of the parameter information.

Accordingly, in a case in which the scaling information indicates the scaling ratio S, ds is a difference dS between the scaling ratio S of the processing target PU and the scaling ratio S serving as the prediction scaling information. On the other hand, in a case in which the scaling information indicates the difference dvₓ, ds is a difference mvd1.x between the difference dvₓ of the processing target PU and the difference dvₓ serving as the prediction scaling information.

When the motion compensation mode is the translation-rotation mode, refidx0 and mvd0 of the parameter information are set as in the translation mode. In addition, information for specifying prediction angle information corresponding to angle information of the processing target PU is set as refidx1 and a difference between the angle information and the prediction angle information is set as dr.

Accordingly, in a case in which the angle information indicates the rotational angle θ, dr is a difference dθ between the rotational angle θ of the processing target PU and a rotational angle θ′ serving as the prediction angle information. On the other hand, in a case in which the angle information indicates the difference dv_{y}, dr is a difference mvd1.y between the difference dv_{y} of the processing target PU and the difference dv_{y} serving as the prediction angle information. Note that in a case in which the mode of the inter-prediction process is a merge mode, mvd0, mvd1, ds, dr, refidx0, and refidx1 are not set.

### (Description of Candidates for Prediction Vector)

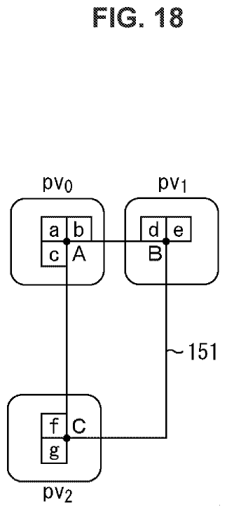

FIG. 18 is an explanatory diagram illustrating a motion vector included in an adjacent parameter which is a candidate for a prediction vector (hereinafter referred to as an adjacent vector).

The prediction unit 119 generates an adjacent vector which is a candidate for a prediction vector pv₀ of the motion vector v₀ of the top left vertex A of a prediction target PU 151 in FIG. 18 on the basis of the motion vector of a block a which is an encoded top left PU of the PU 151 that has the vertex A as a vertex, a block b which is a top encoded PU, or a block c which is a left encoded PU.

In addition, the prediction unit 119 generates an adjacent vector which is a candidate for a prediction vector pv₁ of the motion vector v₁ of the top right vertex B of the PU 151 on the basis of the motion vector of a block d which is a top encoded PU of the PU 151 that has the vertex B as a vertex or a block e which is a top right encoded PU. Note that the motion vectors of the blocks a to e are one motion vector maintained in the prediction unit 119 in each block.

As described above, combination candidates of the motion vectors used to generate adjacent vectors which are candidates for the prediction vectors pv₀ and pv₁ are 6 (=3×2). The prediction unit 119 selects a combination in which DV obtained by Expression (2) below is the smallest among the 6 combination candidates as a combination of the motion vectors used to generate adjacent vectors which are candidates for the prediction vectors pv₀ and pv₁.

[Math. 2]

DV=|(v₁ₓ′−v₀ₓ′)H−(v_{2y}′−v_{0y}′)W|+|(v_{1y}′−v_{0y}′)H−(v_{2y}′−v₀ₓ′)W| (2)

Note that v₀ₓ′ and v_{0y}′ are motion vectors in the x and y directions of one of the blocks a to c used to generate the prediction vector pv₀. In addition, v₁ₓ′ and v_{1y}′ are motion vectors in the x and y directions of one of the blocks d and e used to generate the prediction vector pv₁. In addition, v₂ₓ′ and v_{2y}′ are motion vectors in the x and y directions of one of a block f which is a left encoded PU of the PU 151 that has the vertex C of the PU 151 as a vertex and a block g which is the bottom left encoded PU. The motion vectors of the blocks f and g are one motion vector maintained in the prediction unit 119 in each block.

According to Expression (2), in a case in which the change in the shape is performed by an affine transformation based on the motion vectors v₀′ (v₀ₓ′, v_{0y}′) to v₂′ (v₂ₓ′, v_{2y}′) except for skewing which is not possible in the affine transformation based on two motion vectors, DV decreases.

### (Description of Process of Image Processing Apparatus)

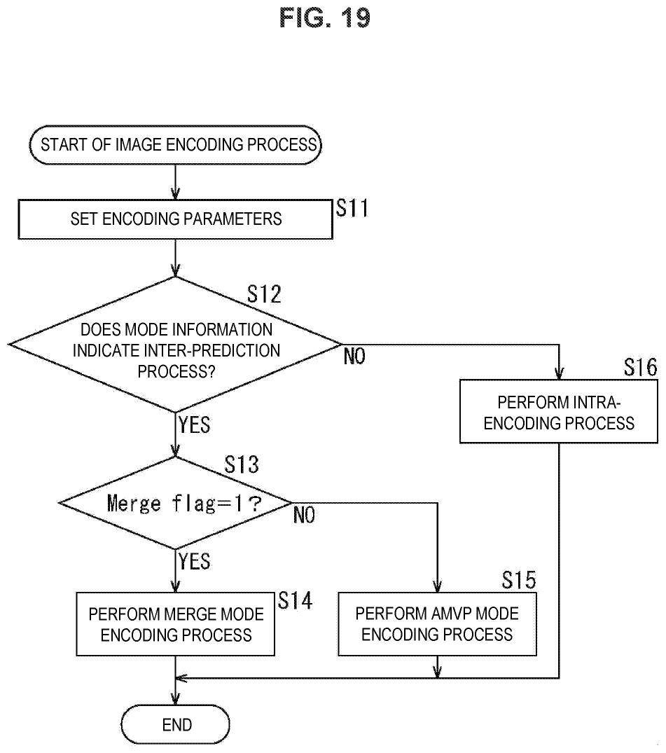

FIG. 19 is an explanatory flowchart illustrating an image encoding process of the image encoding apparatus 100 in FIG. 11.

In step S11 of FIG. 19, the control unit 101 sets the encoding parameters (the header information Hinfo, the prediction information Pinfo, the transformation information Tinfo, and the like) on the basis of RDO, an input, and the like from the outside. The control unit 101 supplies the set encoding parameters to each block.

In step S12, the prediction unit 119 determines whether the mode information pred_mode_flag of the prediction information Pinfo indicates the inter-prediction process. In a case in which the prediction unit 119 determines in step S12 that the mode information pred_mode_flag of the prediction information Pinfo indicates the inter-prediction process, the prediction unit 119 determines in step S13 whether the merge flag of the prediction information Pinfo is 1.

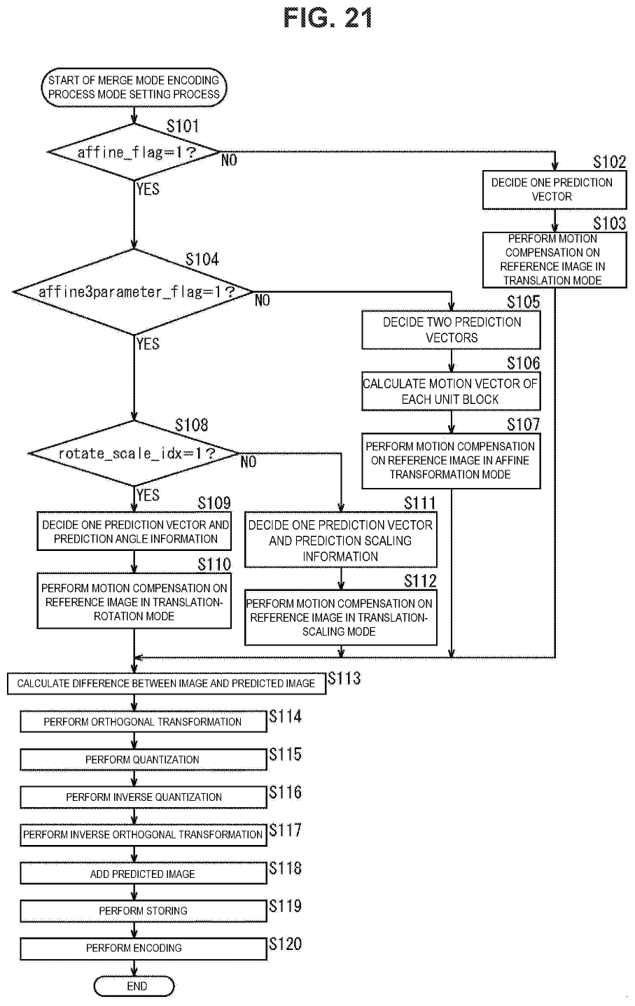

In a case in which the prediction unit 119 determines in step S13 that the merge flag is 1, the prediction unit 119 performs a merge mode encoding process of encoding an encoding target image using the predicted image P generated through the inter-prediction process of the merge mode in step S14. The details of the merge mode encoding process will be described with reference to FIG. 21 to be described below. After the merge mode encoding process ends, the image encoding process ends.

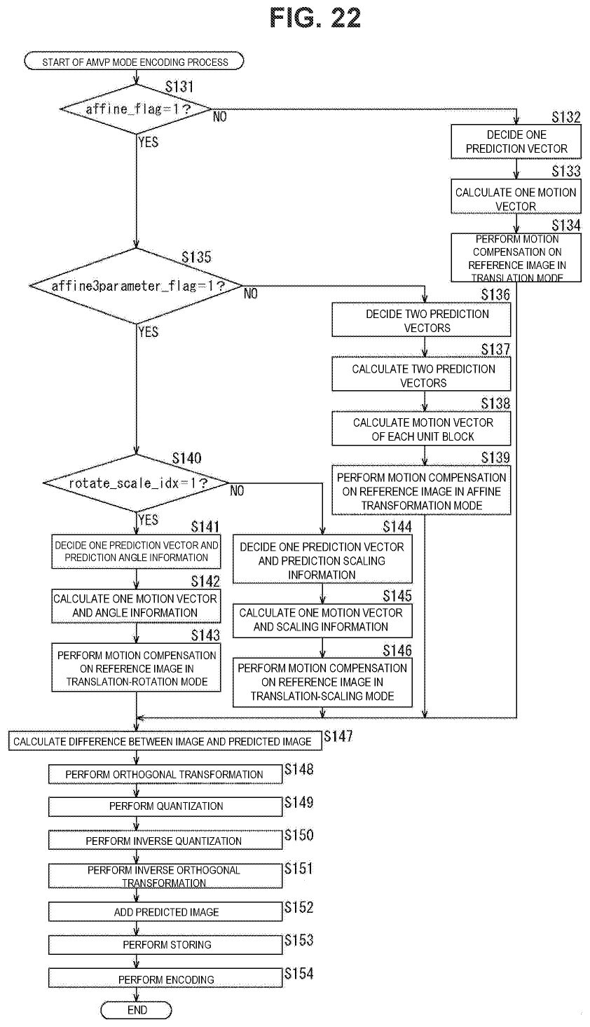

On the other hand, in a case in which the prediction unit 119 determines in step S13 that the merge flag is not 1, the prediction unit 119 performs an AMVP mode encoding process of encoding an encoding target image using the predicted image P generated through the inter-prediction process of the AMVP mode in step S15. The details of the AMVP mode encoding process will be described with reference to FIG. 22 to be described below. After the AMVP mode encoding process ends, the image encoding process ends.

Conversely, in a case in which it is determined in step S12 that the mode information pred_mode_flag of the prediction information Pinfo does not indicate the inter-prediction process, that is, a case in which the mode information pred_mode_flag indicates the intra-prediction process, the process proceeds to step S16.

In step S16, the prediction unit 119 performs the intra-encoding process of encoding an encoding target image I using the predicted image P generated through the intra-prediction process. Then, the image encoding process ends.

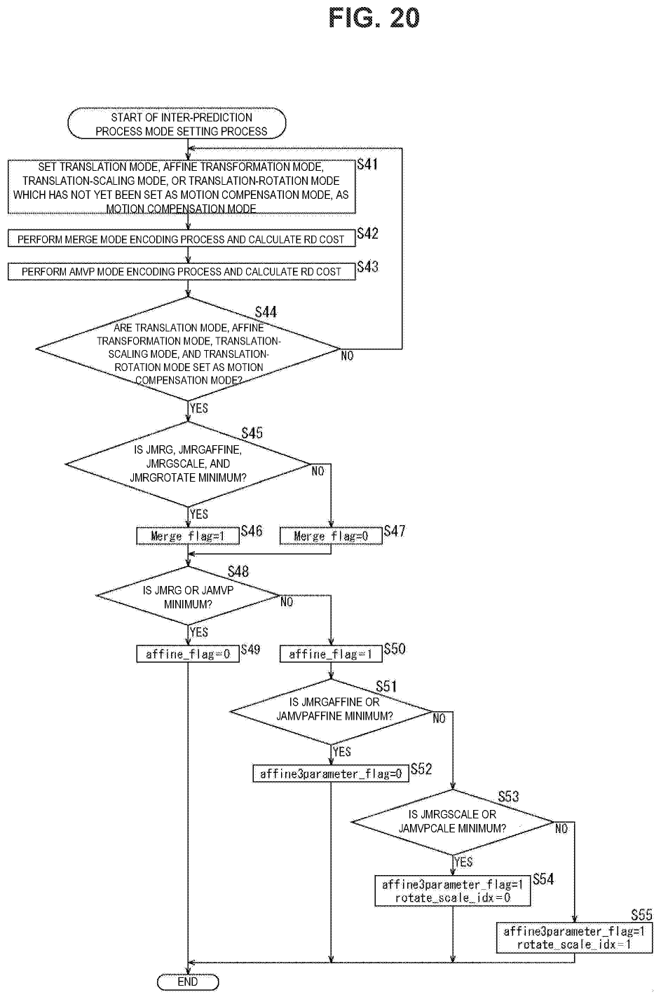

FIG. 20 is an explanatory flowchart illustrating an inter-prediction process mode setting process of setting the merge flag and the motion compensation mode information in the process of step S11 of FIG. 19. The inter-prediction process mode setting process is performed in, for example, units of the PUs (CUs).

In step S41 of FIG. 20, the control unit 101 sets the translation mode, the affine transformation mode, the translation-scaling mode, or the translation-rotation mode which has not yet been set as the motion compensation mode, as the motion compensation mode in step S41.

Specifically, in a case in which the translation mode has not yet been set as the motion compensation mode, the control unit 101 sets affine_flag to 0. In a case in which the affine transformation mode has not yet been set as the motion compensation mode, the control unit 101 sets affine_flag to 1 and sets affine3parameter_flag to 0. In a case in which the translation-scaling mode has not yet been set as the motion compensation mode, the control unit 101 sets affine_flag and affine3parameter_flag to 1 and sets rotate_scale_idx to 0. In a case in which the translation-rotation mode has not yet been set as the motion compensation mode, the control unit 101 sets affine_flag, affine3parameter_flag to 1, and rotate_scale_idx to 1.

In step S42, the control unit 101 controls each block to perform the merge mode encoding process on the processing target PU (CU) for each piece of prediction information Pinfo except for the merge flag and the motion compensation mode information which are candidates and calculate an RD cost. Note that the calculation of the RD cost is performed on the basis of an occurrence bit amount (encoding amount) obtained as the result of the encoding, an error sum of squares (SSE) of the encoded image, and the like.

In step S43, the control unit 101 controls each block to perform the AMVP mode encoding process on the processing target PU (CU) for each piece of prediction information Pinfo except for the merge flag and the motion compensation mode which are candidates and calculate an RD cost.

In step S44, the control unit 101 determines whether the translation mode, the affine transformation mode, the translation-scaling mode, and the translation-rotation mode are all set as the motion compensation mode in step S41.

In a case in which it is determined in step S44 that the translation mode, the affine transformation mode, the translation-scaling mode, and the translation-rotation mode have not yet been all set as the motion compensation mode, the process returns to step S41 and the processes of steps S41 to S44 are performed until all the modes are set as the motion compensation mode.

Conversely, in a case in which it is determined in step S44 that the translation mode, the affine transformation mode, the translation-scaling mode, and the translation-rotation mode have been all set as the motion compensation mode, the process proceeds to step S45.

In step S45, the control unit 101 determines whether a RD cost J_{MRG}, J_{MRGAFFINE}, J_{MRGSCALE}, or J_{MRGROTATE} obtained through the merge mode encoding process is the minimum between the RD costs calculated in steps S42 and S43. The RD costs J_{MRG}, J_{MRGAFFINE}, J_{MRGSCALE}, and J_{MRGROTATE} are RD costs obtained through the merge mode encoding process in a case in which the motion compensation mode is the translation mode, the affine transformation mode, the translation-scaling mode, and the translation-rotation mode, respectively.

In a case in which the control unit 101 determines in step S45 that the RD cost J_{MRG}, J_{MRGAFFINE}, J_{MRGSCALE}, or J_{MRGROTATE} is the minimum, the control unit 101 sets the merge flag of the processing target PU to 1 in step S46, and then the process proceeds to step S48.

Conversely, in a case in which the control unit 101 determines in step S45 that the RD cost J_{MRG}, J_{MRGAFFINE}, J_{MRGSCALE}, or J_{MRGROTATE} is not the minimum, the control unit 101 sets the merge flag of the processing target PU to 0 in step S47, and then the process proceeds to step S48.

In step S48, the control unit 101 determines whether the RD cost J_{MRG} or an RD cost J_{AMVP} obtained through the AMVP mode encoding process in a case in which the motion compensation mode is the translation mode is the minimum among the RD costs calculated in steps S42 and S43.

In a case in which the control unit 101 determines in step S48 that the RD cost J_{MRG} or the RD cost J_{AMVP} is the minimum, the control unit 101 sets affine_flag of the processing target PU to 0 in step S49, and then the inter-prediction process mode setting process ends.

Conversely, in a case in which it is determined in step S48 that the RD cost J_{MRG} or the RD cost J_{AMVP} is not the minimum, the process proceeds to step S50. In step S50, the control unit 101 sets affine_flag of the processing target PU to 1.

In step S51, the control unit 101 determines whether the RD cost J_{MRGAFFINE} or an RD cost J_{AMVPAFFINE} obtained through the AMVP mode encoding process in a case in which the motion compensation mode is the affine transformation mode is the minimum among the RD costs calculated in steps S42 and S43.

In a case in which it is determined in step S51 that the RD cost J_{MRGAFFINE} or the RD cost J_{AMVPAFFINE} is the minimum, the process proceeds to step S52. In step S52, the control unit 101 sets affine3parameter_flag of the processing target PU to 0, and then the inter-prediction process mode setting process ends.

Conversely, in a case in which it is determined in step S51 that the RD cost J_{MRGAFFINE} or the RD cost J_{AMVPAFFINE} is not the minimum, the process proceeds to step S53. In step S53, the control unit 101 determines whether the RD cost J_{MRGSCALE} or the RD cost J_{AMVPSCALE} is the minimum among the RD costs calculated in steps S42 and S43.

In a case in which it is determined in step S53 that the RD cost J_{MRGSCALE} or the RD cost J_{AMVPSCALE} is the minimum, the process proceeds to step S54. In step S54, the control unit 101 sets affine3parameter_flag of the processing target PU to 1 and sets rotate_scale_idx to 0. Then, the inter-prediction process mode setting process ends.

Conversely, in a case in which it is determined in step S53 that the RD cost J_{MRGSCALE} or the RD cost J_{AMVPSCALE} is not the minimum, that is, a case in which the RD cost J_{MRGROTATE} or the RD cost J_{AMVPROTATE} is the minimum, the process proceeds to step S55. In step S55, the control unit 101 sets affine3parameter_flag and rotate_scale_idx of the processing target PU to 1. Then, the inter-prediction process mode setting process ends.

Note that in the inter-prediction process mode setting process of FIG. 20, the translation mode, the affine transformation mode, the translation-scaling mode, and the translation-rotation mode are all set as the motion compensation mode in step S41, but the motion compensation mode set in step S41 may be limited on the basis of the motion compensation mode of the adjacent PU.

That is, as illustrated in FIG. 10, the region 64A of the PU in which the translation and the scaling occur, the region 64B of the PU in which the translation and the motion in the rotational direction occur, the region 64C of the PU in which the translation, the scaling, and the motion in the rotational direction occur, and the region 64D of the PU in which only the translation occurs are assumed to be collected in the image 64. Accordingly, there is a high possibility of the motion compensation mode of the prediction target PU and the adjacent PU being the same. Accordingly, for example, in a case in which the motion compensation mode of the adjacent PU is the translation-scaling mode, the prediction unit 119 may set only the translation mode and the translation-scaling mode in step S41. Thus, it is possible to further reduce a calculation amount of the image encoding process than in the inter-prediction process mode setting process of FIG. 20.

FIG. 21 is an explanatory flowchart illustrating a merge mode encoding process. The merge mode encoding process is performed in, for example, units of the CUs (PUs).

In step S101 of FIG. 21, the prediction unit 119 determines whether affine_flag is 1. In a case in which it is determined in step S101 that affine_flag is not 1, that is, a case in which affine_flag is 0, the process proceeds to step S102.

In step S102, the prediction unit 119 decides the prediction vector pv₀ on the basis of the parameter information. Specifically, in a case in which the parameter information is information for specifying the adjacent vector as the prediction vector, the prediction unit 119 decides the adjacent vector generated from the motion vector of one of the blocks a to c in which DV is the smallest as the prediction vector pv₀ on the basis of the motion vectors of the maintained blocks a to g.

In step S103, the prediction unit 119 performs the motion compensation in the translation mode on the reference image specified by the reference image specifying information stored in the frame memory 118 using the prediction vector pv₀ decided in step S102 as the motion vector v₀ of the processing target PU. The prediction unit 119 supplies the reference image subjected to the motion compensation as the predicted image P to the calculation unit 111 or the calculation unit 117. Then, the process proceeds to step S113.

Conversely, in a case in which it is determined in step S101 that affine_flag is 1, the process proceeds to step S104.

In step S104, the prediction unit 119 determines whether affine3parameter_flag is 1. In a case in which it is determined in step S104 that affine3parameter_flag is not 1, that is, a case in which affine3parameter_flag is 0, the process proceeds to step S105.

In step S105, the prediction unit 119 decides two prediction vector pv₀ and the prediction vector pv₁ on the basis of the parameter information.

Specifically, in a case in which the parameter information is information for specifying the adjacent vector as the prediction vector, the prediction unit 119 selects a combination of the motion vectors of one of the blocks d and e and one of the blocks a to c in which DV is the smallest on the basis of the motion vectors of the maintained blocks a to g. Then, the prediction unit 119 decides the adjacent vector generated using the motion vector of one of the selected blocks a to c as the prediction vector pv₀. In addition, the prediction unit 119 decides the adjacent vector generated using the motion vector of the selected block d or e as the prediction vector pv₁.

In step S106, the prediction unit 119 calculates the motion vector v of each unit block by Expression (1) described above using the prediction vectors decided in step S105 as the motion vectors v₀ and v₁ of the processing target PU.

In step S107, the prediction unit 119 performs the motion compensation in the affine transformation mode on the reference image by translating the block of the reference image specified by the reference image specifying information on the basis of the motion vector v for each unit block. The prediction unit 119 supplies the reference image subjected to the motion compensation as the predicted image P to the calculation unit 111 or the calculation unit 117. Then, the process proceeds to step S113.

Conversely, in a case in which it is determined in step S104 that affine3parameter_flag is 1, the process proceeds to step S108. In step S108, the prediction unit 119 determines whether rotate_scale_idx is 1.

In a case in which it is determined in step S108 that rotate_scale_idx is 1, the process proceeds to step S109.

In step S109, the prediction unit 119 decides one prediction vector pv₀ on the basis of the parameter information as in the process of step S102 and decides the prediction angle information.

In step S110, the motion compensation of the prediction vector and the prediction angle information decided in step S109 is performed on the reference image in the translation-rotation mode using the motion vector v₀ and the angle information of the processing target PU. The prediction unit 119 supplies the reference image subjected to the motion compensation as the predicted image P to the calculation unit 111 or the calculation unit 117. Then, the process proceeds to step S113.

Conversely, in a case in which it is determined in step S108 that rotate_scale_idx is not 1, that is, a case in which rotate_scale_idx is 0, the process proceeds to step S111.

In step S111, the prediction unit 119 decides one prediction vector pv₀ on the basis of the parameter information as in the process of step S102 and decides the prediction scaling information.

In step S112, the motion compensation of the prediction vector and the prediction scaling information decided in step S111 is performed on the reference image in the translation-scaling mode using the motion vector v₀ and the scaling information of the processing target PU. The prediction unit 119 supplies the reference image subjected to the motion compensation as the predicted image P to the calculation unit 111 or the calculation unit 117. Then, the process proceeds to step S113.

In step S113, the calculation unit 111 calculates a difference between an image I and the predicted image P as a prediction residue D and supplies the prediction residue D to the transformation unit 112. A data amount of the prediction residue D obtained in this way is reduced further than that of the original image I. Accordingly, the data amount can be compressed further than in the case of encoding of the image I without change.

In step S114, the transformation unit 112 performs an orthogonal transformation or the like on the prediction residue D supplied from the calculation unit 111 on the basis of the transformation information Tinfo supplied from the control unit 101 to derive a transformation coefficient Coeff. The transformation unit 112 supplies the transformation coefficient Coeff to the quantization unit 113.

In step S115, the quantization unit 113 scales (quantizes) the transformation coefficient Coeff supplied from the transformation unit 112 on the basis of the transformation information Tinfo supplied from the control unit 101 to derive a quantization transformation coefficient level level. The quantization unit 113 supplies the quantization transformation coefficient level level to the encoding unit 114 and the inverse quantization unit 115.

In step S116, the inverse quantization unit 115 performs inverse quantization on the quantization transformation coefficient level level supplied from the quantization unit 113 in accordance with characteristics corresponding to characteristics of the quantization of step S115 on the basis of the transformation information Tinfo supplied from the control unit 101. The inverse quantization unit 115 supplies the transformation coefficient Coeff_IQ obtained as the result to the inverse transformation unit 116.

In step S117, the inverse transformation unit 116 performs an inverse orthogonal transformation or the like on the transformation coefficient Coeff_IQ supplied from the inverse quantization unit 115 on the basis of the transformation information Tinfo supplied from the control unit 101 in accordance with a method corresponding to an orthogonal transformation or the like of step S114 to derive the prediction residue D′.

In step S118, the calculation unit 117 generates the local decoded image Rec by adding the prediction residue D′ derived through the process of step S117 and the predicted image P supplied from the prediction unit 119.

In step S119, the frame memory 118 reconstructs the decoded image in units of pictures using the local decoded image Rec obtained through the process of step S118 and stores the decoded image in the buffer in the frame memory 118.

In step S120, the encoding unit 114 encodes the encoding parameters set through the process of step S11 of FIG. 19 and the quantization transformation coefficient level level obtained through the process of step S115 in accordance with a predetermined method. The encoding unit 114 multiplexes the encoded data obtained as the result and output the multiplexed encoded data as an encoded stream to the outside of the image encoding apparatus 100. For example, the encoded stream is transmitted to a decoding side via a transmission path or a recording medium.

When the process of step S120 ends, the merge mode encoding process ends.

FIG. 22 is an explanatory flowchart illustrating an AMVP mode encoding process. The AMVP mode encoding process is performed in, for example, units of the CUs (PUs).

Since steps S131 and S132 of FIG. 22 are similar to the processes of steps S101 and S102 of FIG. 21, the description thereof will be omitted.

After the process of step S132, the process proceeds to step S133. In step S133, the prediction unit 119 adds one prediction vector pv₀ decided in step S132 and the difference dv₀ between the prediction vector pv₀ in the parameter information and the motion vector v₀ of the processing target PU to calculate the motion vector v₀ of the processing target PU.

In step S134, the prediction unit 119 performs the motion compensation in the translation mode on the reference image specified by the reference image specifying information stored in the frame memory 118 using the motion vector v₀ calculated in step S133. The prediction unit 119 supplies the reference image subjected to the motion compensation as the predicted image P to the calculation unit 111 or the calculation unit 117. Then, the process proceeds to step S147.

Conversely, in a case in which it is determined in step S131 that affine_flag is 1, the process proceeds to step S135. Since the processes of steps S135 and S136 are similar to the processes of steps S104 and S105 of FIG. 21, the description thereof will be omitted.

After the process of step S136, the process proceeds to step S137. In step S137, the prediction unit 119 adds each of the two prediction vectors decided in step S136 and the difference in the parameter information corresponding to the prediction vector to calculate two motion vectors of the processing target PU.

Specifically, the prediction unit 119 adds the prediction vector pv₀ and the difference dv₀ between the prediction vector pv₀ in the parameter information and the motion vector v₀ of the processing target PU to calculate the motion vector v₀ of the processing target PU. In addition, the prediction unit 119 adds the prediction vector pv₁ and the difference dv₁ between the prediction vector pv₁ in the parameter information and the motion vector v₁ of the processing target PU to calculate the motion vector v₁ of the processing target PU.

In step S138, the prediction unit 119 calculates the motion vector v of each unit block by Expression (1) described above using the two motion vectors v₀ and v₁ calculated in step S137. Then, the process proceeds to step S139.

Conversely, in a case in which it is determined in step S135 that affine3parameter_flag is 1, the process proceeds to step S140. Since the processes of steps S139 to S141 are similar to the processes of steps S107 to S109 of FIG. 21, the description thereof will be omitted.

After the process of step S141, the process proceeds to step S142. In step S142, the prediction unit 119 calculates one motion vector v₀ as in the process of step S133. In addition, the prediction unit 119 calculates angle information of the processing target PU by adding the prediction angle information decided in step S141 and a difference between the prediction angle information in the parameter information and the angle information of the processing target PU.

In step S143, the prediction unit 119 performs the motion compensation in the translation-rotation mode on the reference image using the one motion vector calculated in step S142 and the angle information. The prediction unit 119 supplies the reference image subjected to the motion compensation as the predicted image P to the calculation unit 111 or the calculation unit 117. Then, the process proceeds to step S147.

Conversely, in a case in which it is determined in step S140 that rotate_scale_idx is not 1, that is, a case in which rotate_scale_idx is 0, the process proceeds to step S144.

In step S144, the prediction unit 119 decides one prediction vector and the prediction scaling information as in the process of step S111.

In step S145, the prediction unit 119 calculates one motion vector v₀ as in the process of step S133. In addition, the prediction unit 119 calculates scaling information of the processing target PU by adding the prediction scaling information decided in step S144 and a difference between the prediction scaling information in the parameter information and the scaling information of the processing target PU.

In step S146, the prediction unit 119 performs the motion compensation in the translation-scaling mode on the reference image using the motion vector v₀ decided in step S145 and the scaling information. The prediction unit 119 supplies the reference image subjected to the motion compensation as the predicted image P to the calculation unit 111 or the calculation unit 117. Then, the process proceeds to step S147.

Since steps S147 to S154 are similar o the processes of steps S113 to S120 of FIG. 21, the description thereof will be omitted.

As described above, the image encoding apparatus 100 selects one of the translation mode, the affine transformation mode, the translation-rotation mode, and the translation-scaling mode as the motion compensation mode and performs the motion compensation in the selected motion compensation mode.

Accordingly, it is possible to reduce the number of parameters used in the motion compensation of the PU in which at least one of the translation, the motion in the rotational direction, or the scaling does not occur compared to the case in which the motion compensation is usually performed in the affine transformation mode. As a result, it is possible to reduce overhead at the time of the inter-prediction process of the AMVP mode, thereby improving encoding efficiency.

In addition, since only necessary compensation can be performed among the compensations of the translation, the motion in the rotational direction, and the scaling in the inter-prediction process, it is possible to improve image quality of the predicted image.

### (Configuration Example of Image Decoding Apparatus)

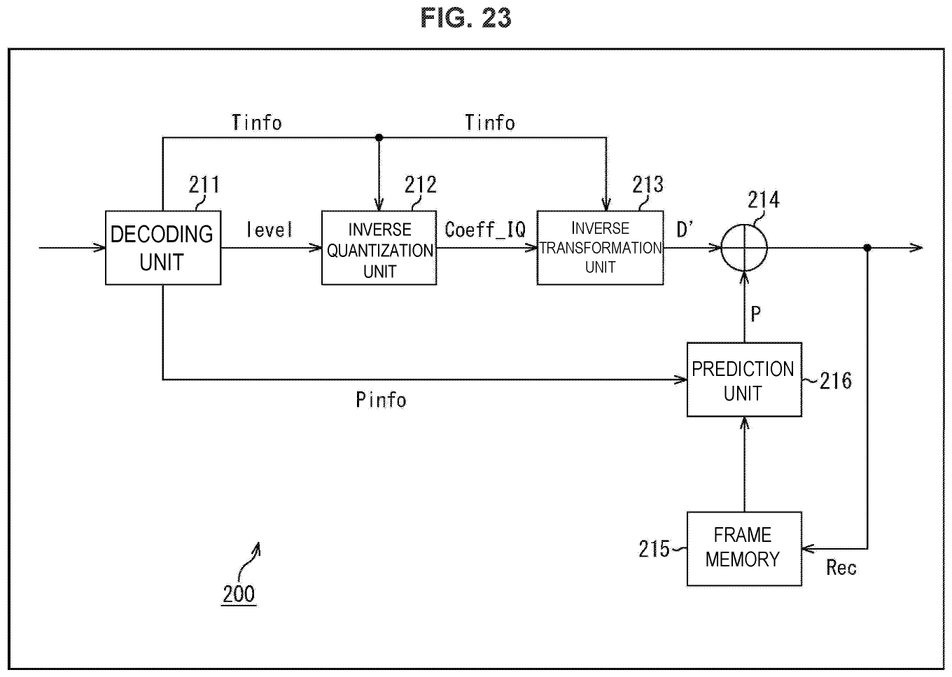

FIG. 23 is a block diagram illustrating a configuration example of an embodiment of an image decoding apparatus serving as an image processing apparatus which decodes an encoded stream generated by the image encoding apparatus 100 in FIG. 11 and to which the present technology is applied. An image decoding apparatus 200 in FIG. 23 decodes the encoded stream generated by the image encoding apparatus 100 in accordance with a decoding method corresponding to the encoding method in the image encoding apparatus 100. For example, a technology proposed in HEVC or a technology proposed in JVET is mounted on the image decoding apparatus 200.

Note that FIG. 23 illustrates main configurations such as flows of processing units and data, and the like, and FIG. 23 is not illustrating entire configurations. That is, there may be processing units in the image decoding apparatus 200 that are not illustrated as blocks in FIG. 23 or flows of processes and data that are not indicated by arrows and the like in FIG. 23.

The image decoding apparatus 200 in FIG. 23 includes a decoding unit 211, an inverse quantization unit 212, an inverse transformation unit 213, a calculation unit 214, a frame memory 215, and a prediction unit 216. The image decoding apparatus 200 decodes the encoded stream generated by the image encoding apparatus 100 for each CU.

Specifically, the decoding unit 211 of the image decoding apparatus 200 decodes the encoded stream generated by the image encoding apparatus 100 in accordance with a predetermined decoding method corresponding to the encoding method of the encoding unit 114. For example, the decoding unit 211 decodes the encoding parameters (the header information Hinfo, the prediction information Pinfo, the transformation information Tinfo, and the like) and the quantization transformation coefficient level level from the bit stream of the encoded stream in accordance with the definition of the syntax table. The decoding unit 211 splits the LCU on the basis of the split flag included in the encoding parameters and sets the CU corresponding to each quantization transformation coefficient level level to a decoding target CU (PU or TU) in order.

The decoding unit 211 supplies the encoding parameters to each block. For example, the decoding unit 211 supplies the prediction information Pinfo to the prediction unit 216, supplies the transformation information Tinfo to the inverse quantization unit 212 and the inverse transformation unit 213, and supplies the header information Hinfo to each block. In addition, the decoding unit 211 supplies the quantization transformation coefficient level level to the inverse quantization unit 212.

The inverse quantization unit 212 scales (performs inverse quantization on the value of the quantization transformation coefficient level level supplied from the decoding unit 211 on the basis of the transformation information Tinfo supplied from the decoding unit 211 to derive the transformation coefficient Coeff_IQ. This inverse quantization is an inverse process to the quantization performed by the quantization unit 113 (see FIG. 11) of the image encoding apparatus 100. Note that the inverse quantization unit 115 (see FIG. 11) performs the inverse quantization as in the inverse quantization unit 212. The inverse quantization unit 212 supplies the obtained transformation coefficient Coeff_IQ to the inverse transformation unit 213.

The inverse transformation unit 213 performs an inverse orthogonal transformation or the like on the transformation coefficient Coeff_IQ supplied from the inverse quantization unit 212 on the basis of the transformation information Tinfo supplied from the decoding unit 211 to derive a prediction residue D′. The inverse orthogonal transformation is an inverse process to the orthogonal transformation performed by the transformation unit 112 (see FIG. 11) of the image encoding apparatus 100. Note that the inverse transformation unit 116 performs the inverse orthogonal transformation as in the inverse transformation unit 213. The inverse transformation unit 213 supplies the obtained prediction residue D′ to the calculation unit 214.

The calculation unit 214 adds the prediction residue D′ supplied from the inverse transformation unit 213 and the predicted image P corresponding to the prediction residue D′ to derive a local decoded image Rec. The calculation unit 214 reconstructs the decoded image for each of the units of pictures using the obtained local decoded image Rec and outputs the obtained decoded image to the outside of the image decoding apparatus 200. In addition, the calculation unit 214 also supplies the local decoded image Rec to the frame memory 215.

The frame memory 215 reconstructs the decoded image for each of the units of pictures using the local decoded image Rec supplied from the calculation unit 214 and stores the decoded image in a buffer in the frame memory 215. The frame memory 215 reads the decoded image designated by the prediction unit 216 as a reference image from the buffer and supplies the decoded image to the prediction unit 216. In addition, the frame memory 215 may store the header information Hinfo, the prediction information Pinfo, the transformation information Tinfo, and the like related to the generation of the decoded image in the buffer in the frame memory 215.

In a case in which the mode information pred_mode_flag of the prediction information Pinfo indicate the intra-prediction process, the prediction unit 216 acquires the decoded image at the same time as the decoding target CU stored in the frame memory 215 as a reference image. Then, the prediction unit 216 performs the intra-prediction process of the intra-prediction mode indicated by the intra-prediction mode information on the decoding target PU using the reference image.

In addition, in a case in which the mode information pred_mode_flag indicates the inter-prediction process, the prediction unit 216 acquires a decoded image at a different time from the decoding target CU stored in the frame memory 215 as a reference image on the basis of the reference image specifying information. As in the prediction unit 119 of FIG. 11, the prediction unit 216 performs the inter-prediction process of the encoding target PU using the reference image on the basis of the merge flag, the motion compensation mode information, and the parameter information. The prediction unit 216 supplies the predicted image P generated as the result of the intra-prediction process or the inter-prediction process to the calculation unit 214.

### (Process of Image Decoding Apparatus)

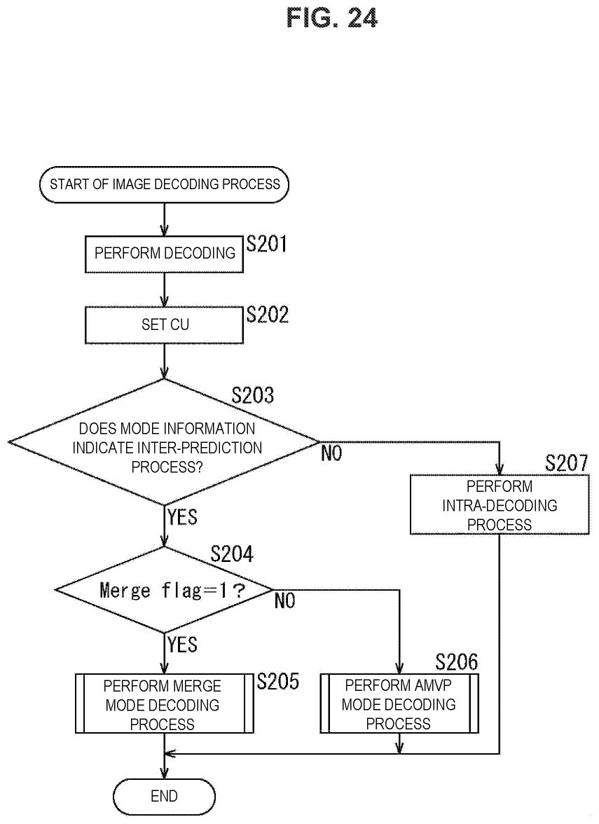

FIG. 24 is an explanatory flowchart illustrating an image decoding process of the image decoding apparatus 200 in FIG. 23.

In step S201, the decoding unit 211 decodes the encoded stream supplied to the image decoding apparatus 200 to obtain the encoding parameters and the quantization transformation coefficient level level. The decoding unit 211 supplies the encoding parameters to each block. In addition, the decoding unit 211 supplies the quantization transformation coefficient level level to the inverse quantization unit 212.

In step S202, the decoding unit 211 splits the LCU on the basis of the split flag included in the encoding parameters and sets the CU corresponding to the quantization transformation coefficient level level as the decoding target CU (PU and TU). The processes of steps S203 to S207 to be described below are performed for each decoding target CU (PU or TU).

Since the processes of steps S203 and S204 are the same as the processes of steps S12 and S13 except for being performed by the prediction unit 216 rather than the prediction unit 119, the description thereof will be omitted.

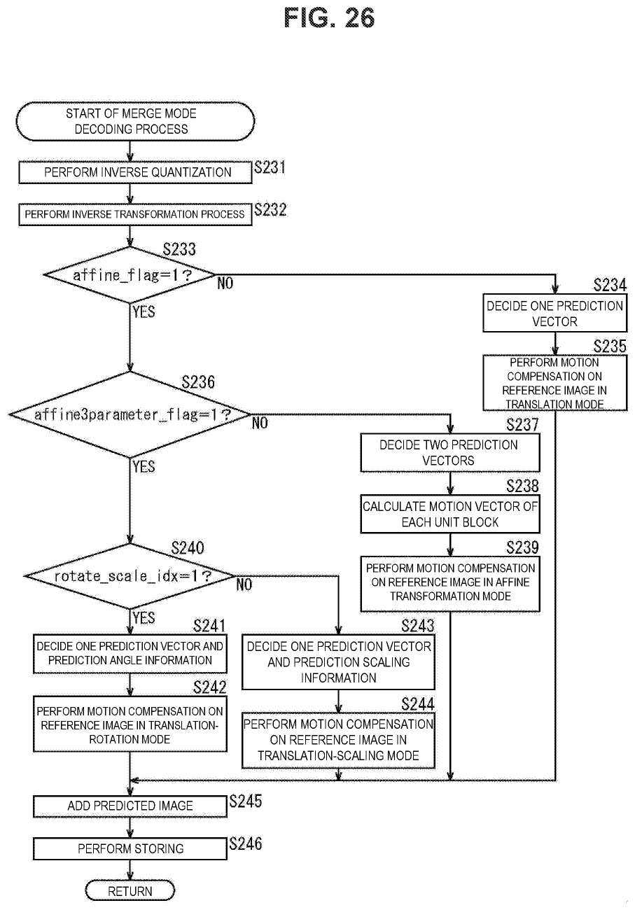

In step S205, the prediction unit 216 performs a merge mode decoding process of decoding a decoding target image using the predicted image P generated through the inter-prediction process of the merge mode. The details of the merge mode decoding process will be described with reference to FIG. 26 to be described below. After the merge mode decoding process ends, the image decoding process ends.

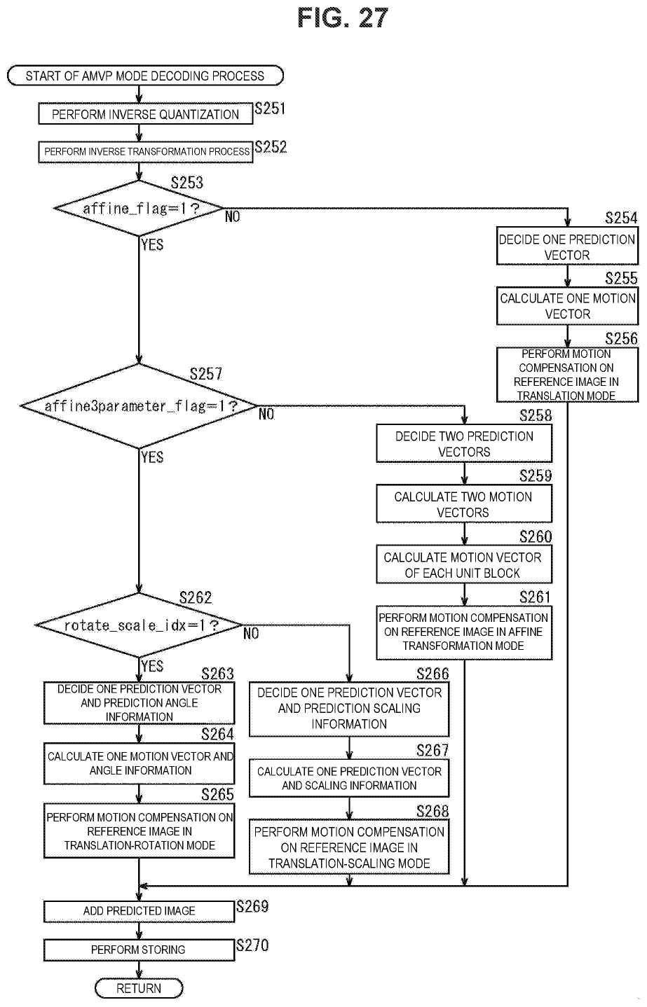

In addition, in a case in which it is determined in step S204 that the merge flag is not 1, the prediction unit 216 performs an AMVP mode decoding process of decoding the decoding target image using the predicted image P generated through the inter-prediction process of the AMVP mode in step S206. The details of the AMVP mode decoding process will be described with reference to FIG. 27 to be described below. After the AMVP mode decoding process ends, the image decoding process ends.

Conversely, in a case in which it is determined in step S203 that the inter-prediction process is not indicated, that is, a case in which the mode information pred_mode_flag indicates the intra-prediction process, the process proceeds to step S207.

In step S207, the prediction unit 216 performs an intra-decoding process of decoding the decoding target image using the predicted image P generated through the intra-prediction process, and then the image decoding process ends.

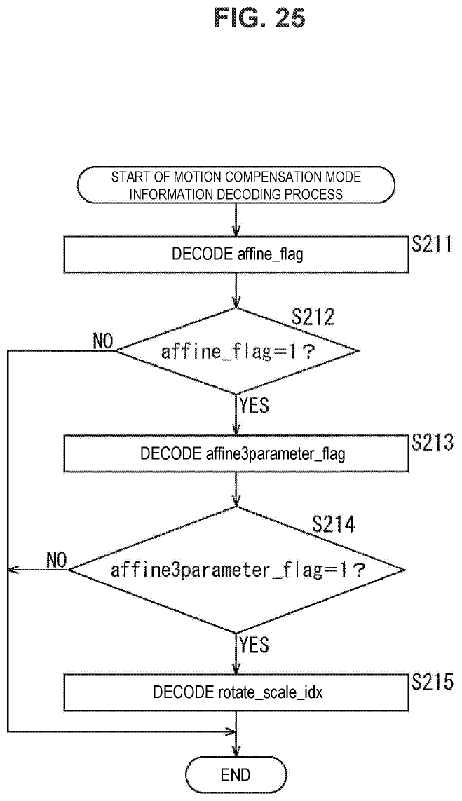

FIG. 25 is an explanatory flowchart illustrating a motion compensation mode information decoding process of decoding the motion compensation mode information in step S201 of FIG. 24.

In step S211 of FIG. 25, the decoding unit 211 decodes affine_flag of the prediction information Pinfo. In step S212, the decoding unit 211 determines whether affine_flag decoded in step S211 is 1. In a case in which it is determined in step S212 that affine_flag is 1, the process proceeds to step S213.

In step S213, the decoding unit 211 decodes affine3parameter_flag. In step S214, it is determined whether affine3parameter_flag decoded in step S213 is 1. In a case in which it is determined in step S214 that affine3parameter_flag is 1, the process proceeds to step S215.

In step S215, the decoding unit 211 decodes rotate_scale_idx, and then the motion compensation mode information decoding process ends.

Conversely, in a case in which it is determined in step S212 that affine_flag is not 1 or a case in which it is determined in step S214 that affine3parameter_flag is not 1, the motion compensation mode information decoding process ends.

FIG. 26 is an explanatory flowchart illustrating the merge mode decoding process of step S205 of FIG. 24.

In step S231, the inverse quantization unit 212 performs inverse quantization on the quantization transformation coefficient level level obtained through the process of step S201 of FIG. 24 to derive the transformation coefficient Coeff_IQ. The inverse quantization is an inverse process to the quantization performed in step S115 (FIG. 21) of the image encoding process and is a similar process to the inverse quantization performed in step S116 (see FIG. 21) of the image encoding process.

In step S232, the inverse transformation unit 213 performs an inverse orthogonal transformation or the like on the transformation coefficient Coeff_IQ obtained through the process of step S231 to derive the prediction residue D′. The inverse orthogonal transformation is an inverse process to the orthogonal transformation performed in step S114 (FIG. 21) of the image encoding process and is a similar process to the inverse orthogonal transformation performed in step S117 (see FIG. 21) of the image encoding process.

Since the processes of steps S233 and S244 are the same as the processes of steps S101 to S112 of FIG. 21 except for being performed by the prediction unit 216 rather than the prediction unit 119, the description thereof will be omitted.

In step S245, the calculation unit 214 adds the prediction residue D′ derived in step S232 and the predicted image P supplied from the prediction unit 216 to derive the local decoded image Rec. The calculation unit 214 reconstructs the decoded image for each of the units of pictures using the obtained local decoded image Rec and outputs the obtained decoded image to the outside of the image decoding apparatus 200. In addition, the calculation unit 214 supplies the local decoded image Rec to the frame memory 215.

In step S246, the frame memory 215 reconstructs the decoded image for each of the units of pictures using the local decoded image Rec supplied from the calculation unit 214 and stores the decoded image in the buffer of the frame memory 215. Then, the process returns to step S205 of FIG. 24 and the image decoding process ends.

FIG. 27 is an explanatory flowchart illustrating the AMVP mode decoding process of step S206 of FIG. 24.

Since the processes of steps S251 and S252 of FIG. 27 are similar to the processes of steps S231 and S232 of FIG. 26, the description thereof will be omitted.

Since the processes of steps S253 to S268 are the same as the processes of steps S131 to S146 of FIG. 22 except for being performed by the prediction unit 216 rather than the prediction unit 119, the description thereof will be omitted.

Since the processes of steps s269 and S270 are similar to the processes of steps S245 and S246 of FIG. 26, the description thereof will be omitted. After the process of step S270, the process returns to step S206 of FIG. 24 and the image decoding process ends.

As described above, the image decoding apparatus 200 selects one of the translation mode, the affine transformation mode, the translation-rotation mode, and the translation-scaling mode as the motion compensation mode and performs the motion compensation in the selected motion compensation mode.

Accordingly, by reducing overhead at the time of the inter-prediction process of the AMVP mode generated by the image encoding apparatus 100, it is possible to decode the encoded stream for which the encoding efficiency is caused to he improved. In addition, since only necessary compensation can be performed among the compensations of the translation, the motion in the rotational direction, and the scaling in the inter-prediction process, it is possible to improve image quality of the predicted image.

Note that in a case in which the image encoding apparatus 100 and the image decoding apparatus 200 perform an intra-BC prediction process instead of the intra-prediction process or the inter-prediction process, the motion compensation in the intra-BC prediction process may be performed in one of the translation mode, the affine transformation mode, the translation-rotation mode, and the translation-scaling mode as in the motion compensation in the inter-prediction process.

### Second Embodiment

### (Motion Compensation of Translation-Rotation Mode)

FIG. 28 is an explanatory diagram further illustrating motion compensation of the translation-rotation mode (an inter-prediction process by the motion compensation).

Note that, hereinafter, both sizes of the processing target PU 31 in the x and y directions are assumed to be equal as W to facilitate the description. Accordingly, the PU 31 is a square block. Sizes of the unit block obtained by splitting the PU are assumed to be similarly equal in the x and y directions.

As the motion compensations of the translation-rotation mode, as described above, there are the motion compensation described in FIG. 13 and the motion compensation described in FIG. 14.

In the motion compensation described in FIG. 13, a predicted image of the PU 31 is generated by performing motion compensation of translating and rotating the block 134 that has the point A′ for which a distance from the PU 31 is the motion vector v₀ (the vertex A of the PU 31) in the reference image as the top left vertex, has the same size as the PU 31, and is rotated by the rotational angle θ on the basis of the motion vector v₀ (one motion vector) of the (top left) vertex A of the processing target PU 31 with horizontal W×vertical W and the rotational angle θ serving as the rotational angle information.

That is, in the motion compensation described in FIG. 13, by using the motion vector v₀=(v₀ₓ, v_{0y}) and the rotational angle θ, a vector (v₀ₓ+W cos θ−W, v_{0y}+W sin θ) that has the (top right) vertex B of the PU 31 as a start point and has the vertex B of the PU 31 as an end point at the time of translation of the PU 31 by the motion vector v₀=(v₀ₓ, v_{0y}) and rotation by the rotational angle θ about the vertex A after the translation is obtained as the motion vector v₁=(v₁ₓ, v_{1y}) of the vertex B of the PU 31. Note that in this case, when the rotational angle θ is small, the motion vector v₁=(v₁ₓ, v_{1y}) of the vertex B can be approximated to motion vector v₁=(v₁ₓ, v_{1y})=(v₀ₓ, v_{0y}+W sin θ).

Then, in the reference image, the motion compensation of translating and rotating the reference block 134 is performed using a square block that has a point moved by the motion vector v₀ from the vertex A of the PU 31 as the top left vertex A′, has a point moved by the motion vector v₁ from the vertex B of the PU 31 as the top right vertex B′, and has a line segment A′B′ as one side as the block 134 used to generate a predicted image of the PU 31 (hereinafter also referred to as a reference block).

The translation and the rotation of the reference block 134 are performed through translation in units of blocks of the reference image corresponding to a unit block (hereinafter also referred to as a reference unit block) and obtained by splitting the PU 31 into the unit blocks with, for example, 2 horizontal pixels×2 vertical pixels, 4 horizontal pixels×4 vertical pixels, or the like as a predetermined size. That is, the translation and the rotation of the reference block 134 are performed by approximating the PU 31 by translation of the reference unit block corresponding to the split unit block.

Specifically, the motion vector v=(vₓ, v_{y}) of each unit block can be obtained in accordance with Expression (1) described above on the basis of the motion vector v₀=(v₀ₓ, v_{0y}) of the vertex A and the motion vector v₁=(v₁ₓ, v_{1y}) of the vertex B.

Then, a predicted image of the PU 31 is generated in units of unit blocks by translating the reference unit block which is a block with the same size as a unit block for which a distance from each unit block is the motion vector v in the reference image on the basis of the motion vector v.

As described above, the motion compensation described in FIG. 13 is also called motion compensation based on the rotational angle θ since the motion compensation is performed on the basis of the motion vector v₀ of the processing target PU 31 and the rotational angle θ serving as the rotation angle information.

Note that the size W of the PU 31 is necessary when the motion vector v₁=(v₁ₓ, v_{1y})=(v₀ₓ+W cos θ−W, v_{0y}+W sin θ) of the vertex B is obtained.

On the other hand, for example, in HEVC, in the formation of the CU, splitting of one block into four subblocks is recursively repeated, and thus a tree structure with a quad-tree shape is formed.

Now, as in HEVC, when the CU is formed and the PU is assumed to be the same as the CU, for example, the split flag indicating the splitting into the subblocks is included in the encoded stream transmitted by the image encoding apparatus 100 of FIG. 11, and thus the image decoding apparatus 200 of FIG. 23 can specify the number of times the block is split into the subblocks on the basis of the split flag and specify the size W of the PU (CU) from the number of times.

In the motion compensation described in FIG. 14, a predicted image of the PU 31 is generated by performing the motion compensation of translating and rotating the block 134 that has the point A′ for which a distance from the PU 31 is the motion vector v₀ in the reference image as the top left vertex in the reference image, is rotated by the rotational angle θ, and has (substantially) the same size as the PU 31 on the basis of the motion vector v₀ (one motion vector) of the vertex A of the processing target PU 31 with horizontal W×vertical W and a difference dv_{y} between the motion vector v₀ of the vertex point A and the motion vector v1 (another motion vector) of the vertex B in the vertical direction (hereinafter also referred to as a vertical difference) which is the rotational angle information.

That is, in the motion compensation described in FIG. 14, as illustrated in FIG. 28, by using the motion vector v₀=(v₀ₓ, v_{0y}) and the vertical difference dvₓ on the assumption that the rotational angle θ is small, a vector (v₀ₓ, v_{0y}+dv_{y}) approximated to a vector (v₀ₓ+W cos θ−W, v_{0y}+W sin θ) that has the vertex B of the PU 31 as a start point and has the vertex B of the PU 31 as an end point at the time of translation of the PU 31 by the motion vector v₀=(v₀ₓ, v_{0y}) and rotation by the rotational angle θ about the vertex A after the translation is obtained as the motion vector v₁=(v₁ₓ, v_{1y}) of the vertex B of the PU 31.

Then, in the reference image, the motion compensation of translating and rotating the reference block 134 is performed using a square block that has a point moved by the motion vector v₀ from the vertex A of the PU 31 as the top left vertex A′, has a point moved by the motion vector v₁ from the vertex B of the PU 31 as the top right vertex B′, and has a line segment A′B′ as one side as the reference block 134 used to generate a predicted image of the PU 31.

As in the case of the motion compensation based on the rotational angle θ, the translation and the rotation of the reference block 134 are performed through translation in a reference unit block unit which is a block of the reference image corresponding to the unit block which can be obtained by splitting the PU 31 into the unit blocks with a predetermined size. That is, the translation and the rotation of the reference block 134 are performed by approximating the PU 31 through translation of the reference unit block corresponding to the unit block obtained by splitting the PU 31, as illustrated in FIG. 28.

Specifically, the motion vector v=(vₓ, v_{y}) of each unit block can be obtained in accordance with Expression (1) described above on the basis of the motion vector v₀=(v₀ₓ, v_{0y}) of the vertex A and the motion vector v₁=(v₁ₓ, v_{1y}) of the vertex B.

Then, a predicted image of the PU 31 is generated in units of unit blocks by translating the reference unit block which is in the same size as a unit block for which a distance from each unit block is the motion vector v in the reference image on the basis of the motion vector v.

As described above, the motion compensation described in FIG. 14 is also called motion compensation based on the vertical difference dv_{y} since the motion compensation is performed on the basis of the motion vector v₀ of the processing target PU 31 and the vertical difference dv_{y} serving as the rotation angle information.

Parameters necessary in the motion compensation based on the vertical difference dv_{y} are three parameters, the motion vector v₀=(v₀ₓ, v_{0y}) of the vertex A and the vertical difference dv_{y}, that is, v₀ₓ, v_{0y}, and dv_{y}.

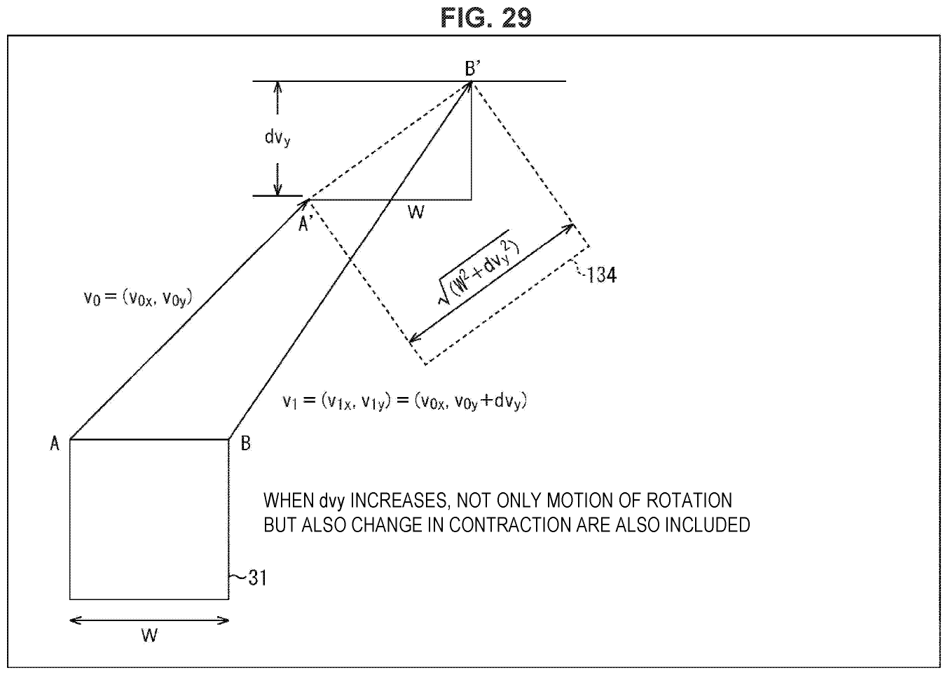

FIG. 29 is an explanatory diagram illustrating motion compensation based on a vertical difference dv_{y} in a case in which a rotational angle θ is a size which cannot be called small.

In the motion compensation based on the vertical difference dv_{y}, as described in FIG. 28, the motion compensation of performing the translation and the rotation of the reference block 134 is performed using a square block that has a point translated by the motion vector v₀=(v₀ₓ, v_{0y}) from the vertex A of the PU 31 as the top left vertex A′ in the reference image, has a point moved by the motion vector v₁=(v₁ₓ, v_{1y})=(v₀ₓ, v_{0y}+dv_{y}) from the vertex B of the PU 31 as the top right vertex B′, and has a line segment A′B as one side, as the reference block 134, on the basis of the motion vector v₀=(v₀ₓ, v_{0y}) and the vertical difference dv_{y}.

In the motion compensation based on the vertical difference dv_{y}, a size (a length of one side) of the reference block 134 is accurately √(W²_dv_{y}²). In a case in which the rotational angle θ is small, a square dv_{y}² of the vertical difference dv_{y} is a size which can be ignored with respect to a square W² of the size W and the size of the reference block 134 can be considered to be equal to the size W of the PU 31.

However, when the rotational angle θ is a size which cannot be called small, the square dv_{y}² of the vertical difference dv_{y} is a size which cannot be ignored with respect to the square W² of the size W and the size √(W²_dv_{y}²) of the reference block 134 is large to the extent that the size of the reference block 134 cannot be called equal to the size W of the PU 31.

As a result, as described in FIG. 28, in a case in which the motion compensation based on the vertical difference dv_{y} is performed, the square reference block 134 with one side √(W²+dv_{y}²) which has a larger size than the PU 31 can be contracted to the PU 31 with the size W in addition to the translation and the rotation of the reference block 134.

As described above, in a case in which the rotational angle θ is a size which cannot be called small, the contraction is performed in addition to the translation and the rotation of the reference block 134 in the motion compensation based on the vertical difference dv_{y}. Therefore, precision of the prediction image of the PU 31 obtained through the motion compensation based on the vertical difference dv_{y} deteriorates, and the encoding efficiency and the image quality of the decoded image deteriorate in some cases.

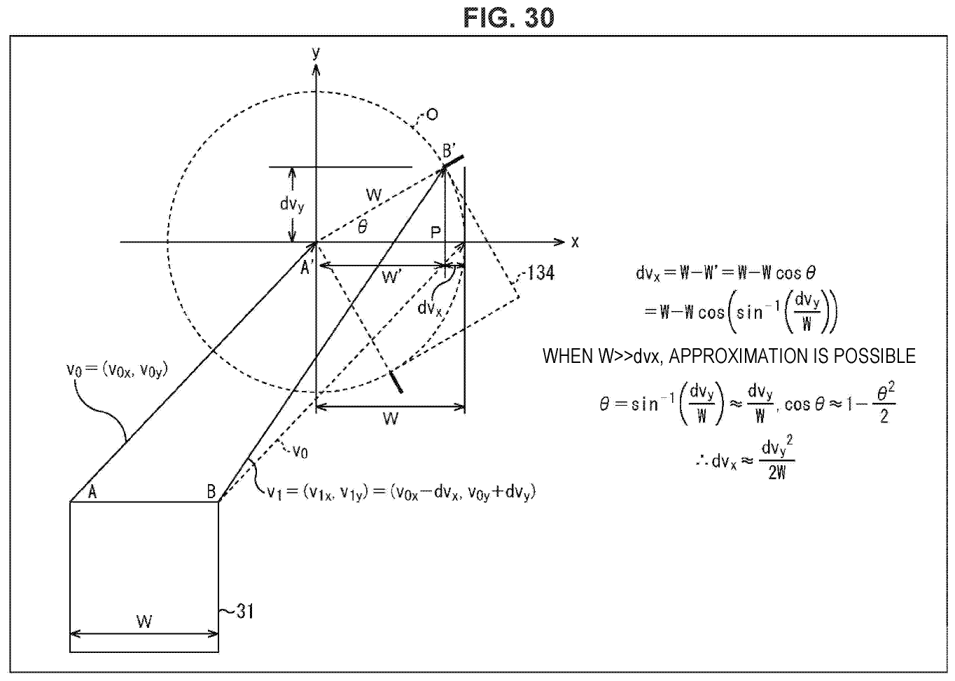

FIG. 30 is an explanatory diagram illustrating motion compensation for suppressing contraction of a reference block 134 in motion compensation based on the vertical difference dv_{y} and causing precision of a predicted image of PU 31 to be improved.

FIG. 30 illustrates the square reference block 134 that has the point A′ for which a distance from the vertex A of the PU 31 is the motion vector v₀ in the reference image as the top left vertex A′ and has the same size as the PU 31 rotated by the rotational angle θ about the vertex A′, that is, one side of W.

When the reference block 134 is caused to be rotated about the top left vertex A′ of the reference block 134, the top right vertex B′ of the reference block 134 is drawn in a circle O (the circumference of the circle) with a radius W.

Now, a 2-dimensional coordinate system (xy coordinate system) that has the vertex A′ as the origin is considered. In the motion compensation based on the vertical difference dv_{y}, the vertical difference dv_{y} is used as rotational angle information and the y coordinate of the vertex B′ is equal to the vertical difference dv_{y}. Accordingly, the y coordinate v_{1y} of the motion vector v₁=(v₁ₓ, v_{1y}) of the vertex B of the PU 31 is expressed as v_{0y}+dv_{y} using the y coordinate v_{0y} of the motion vector v₀=(v₀ₓ, v_{0y}) of the vertex A.

On the other hand, an intersection of a perpendicular line drawn from the vertex B′ to the x axis is represented as a point P, a distance from the vertex A′ to the point P is represented as W′, and a difference between the distance W′ and the size W in the horizontal direction of the PU 31 for generating a predicted image is represented as dvₓ.

Here, since the difference dvₓ is a difference v₁ₓ−v₀ₓ between the x coordinate v₀ₓ of the motion vector v₀=(v₀ₓ, v_{0y}) (one motion vector) of the vertex A and the x coordinate v₁ₓ of the motion vector v₁=(v₁ₓ, v_{1y}) (another motion vector) of the vertex B, that is, a difference between the motion vectors v₀ and v₁ in the horizontal direction, the difference dvₓ is also referred to as a horizontal difference dvₓ below.

The horizontal difference dvₓ can be obtained in accordance with Expression (3).

dvₓ=W−W′

W−W cos θ

W−W cos(sin⁻¹(dv_{y}/W)) (3)

In a case in which the rotational angle θ is not large to that extent and the size W of the PU 31 is sufficiently larger than the horizontal difference dvₓ (in the case of W>>dvₓ), the rotational angle θ and cos θ can be approximated in accordance with Expression (4).

θ=sin⁻¹(dv_{y}/W)≈dv_{y}/W

cos θ≈1−θ²/2 (4)

By applying the approximation of Expression (4) to Expression (3), the horizontal difference dvₓ can be obtained in accordance with an approximation expression of Expression (5).

dvₓ≈dv_{y}²/(2W) (5)

Since the x coordinate v₁ₓ of the motion vector v₁=(v₁ₓ, v_{1y}) of the vertex B of the PU 31 is smaller by the horizontal difference dvₓ than the x coordinate v₀ₓ of the motion vector v₀=(v₀ₓ, v_{0y}) of the vertex A, the x coordinate v₁ₓ is represented as v₀ₓ−dvₓ.

As described above, the motion vector v₁=(v₁ₓ, v_{1y}) of the vertex B, that is, a vector that has the vertex B as a start point and the vertex B′ on the circumference of the circle O with the radius W as an end point is represented as (v₀ₓ−dvₓ, v_{0y}+dv_{y}).

By adopting the vector (v₀ₓ−dvₓ, v_{0y}+dv_{y}) obtained from the vertical difference dv_{y} and the horizontal difference dvₓ obtained from the vertical difference dv_{y} serving as the angle information in accordance with Expression (5) as the motion vector v₁=(v₁ₓ, v_{1y}) of the vertex B, it is possible to perform the motion compensation of suppressing contraction of the reference block 134 in the motion compensation based on the vertical difference dv_{y} so that precision of a predicted image of the PU 31 is caused to be improved.

Here, as the motion compensation based on the vertical difference dv_{y}, there are the motion compensation (the motion compensation described in FIG. 28) in which only the vertical difference dv_{y} is used between the vertical difference dv_{y} and the horizontal difference dvₓ and the motion compensation (the motion compensation described in FIG. 30) in which both the vertical difference dv_{y} and the horizontal difference dvₓ are used, as the motion vector v₁=(v₁ₓ, v_{1y}) of the vertex B.

The motion compression based on the vertical difference dv_{y} in which only the vertical difference dv_{y} is used is also referred to as simple motion compensation based on the vertical difference dv_{y} and the motion compensation in which both the vertical difference dv_{y} and the horizontal difference dvₓ are used is also referred to as motion compensation based on the horizontal difference dvₓ.

In the motion compensation based on the horizontal difference dvₓ, parameters necessary in the motion compensation are three parameters, the motion vector v₀=(v₀ₓ, v_{0y}) of the vertex A and the vertical difference dv_{y}, that is, v₀ₓ, v_{0y}, and dv_{y}, as in the simple motion compensation based on the vertical difference dv_{y}. However, compared to the simple motion compensation based on the vertical difference dv_{y}, it is possible to suppress the contraction of the reference block 134 and perform the motion compensation so that the precision of the predicted image of the PU 31 is caused to be improved. As a result, it is possible to improve the encoding efficiency and the image quality of the decoded image.

Further, in the motion compensation based on the horizontal difference dvₓ, it is not necessary to perform calculation of a trigonometric function using the rotational angle θ and a calculation amount at the time of the motion compensation can be reduced, as in the simple motion compensation based on the vertical difference dv_{y}. In addition, it is not necessary to prepare a transformation table for calculating the trigonometric function using the rotational angle θ.

Note that in the motion compensation based on the horizontal difference dvₓ, after the horizontal difference dvₓ is obtained using the vertical difference dv_{y} and the motion vector v₁=(v₁ₓ, v_{1y})=(v₀ₓ−dvₓ, v_{0y}+dv_{y}) of the vertex B of the PU 31 is obtained using the vertical difference dv_{y} and the horizontal difference dvₓ, the motion compensation is performed as in the case of the motion compensation based on the rotational angle θ.

In other words, in the reference image, the motion compensation of translating and rotating the reference block 134 is performed using a square block that has a point moved by the motion vector v₀ from the vertex A of the PU 31 as the top left vertex A′, has a point moved by the motion vector v₁ from the vertex B of the PU 31 as the top right vertex B′, and has a line segment A′B′ as one side as the reference block 134 used to generate a predicted image of the PU 31.

The translation and the rotation of the reference block 134 are performed through translation in the reference unit block unit which is a block of the reference image corresponding to the unit block which can be obtained by splitting the PU 31 as in the case of the motion compensation based on the rotational angle θ.

Specifically, the motion vector v=(vₓ, v_{y}) of each unit block can be obtained in accordance with Expression (1) described above on the basis of the motion vector v₀=(v₀ₓ, v_{0y}) of the vertex A and the motion vector v₁=(v₁ₓ, v_{1y}) of the vertex B.

Then, a predicted image of the PU 31 is generated in units of unit blocks by translating the reference unit block which is in the same size as a unit block for which a distance from each unit block is the motion vector v in the reference image on the basis of the motion vector v.

Here, in a case in which the motion compensation based on the horizontal difference dvₓ is performed as the motion compensation of the translation-rotation mode, the horizontal difference dvₓ (information corresponding to the horizontal difference dvₓ) can be included in the encoded stream as the parameter information of the motion compensation instead of the vertical difference dv_{y} (information corresponding to the vertical difference dv_{y} (a difference between prediction angle information and the vertical difference dv_{y} serving as the angle information)).

In this case, in the motion compensation based on the horizontal difference dvₓ, the vertical difference dv_{y} is obtained in accordance with an expression dv_{y}≈√(2Wdvₓ) which is a modification of Expression (5) from the horizontal difference dvₓ. Further, the motion vector v₁=(v₁ₓ, v_{1y})=(v₀ₓ−dvₓ, v_{0y}+dv_{y}) of the vertex B is obtained.

Accordingly, even in the case in which the horizontal difference dvₓ is included in the encoded stream instead of the vertical difference dv_{y}, the motion compensation can be performed so that the contraction of the reference block 134 is suppressed and the precision of the predicted image of the PU 31 is caused to be improved as in the case in which the vertical difference dv_{y} is included in the encoded stream.

Here, in the case in which the horizontal difference dvₓ is included in the encoded stream instead of the vertical difference dv_{y}, the vertical difference dv_{y} is obtained in accordance with an expression dv_{y}≈√(2Wdvₓ). Therefore, calculation of a square root which is not performed in a case in which the horizontal difference dvₓ is obtained from the vertical difference dv_{y} in accordance with Expression (5) is necessary.

Therefore, even in the case in which the horizontal difference dvₓ is included in the encoded stream instead of the vertical difference dv_{y}, compared to the case in which the vertical difference dv_{y} is included in the encoded stream, a load of calculation at the time of the motion compensation increases and a transformation table for calculating a square root is necessary.

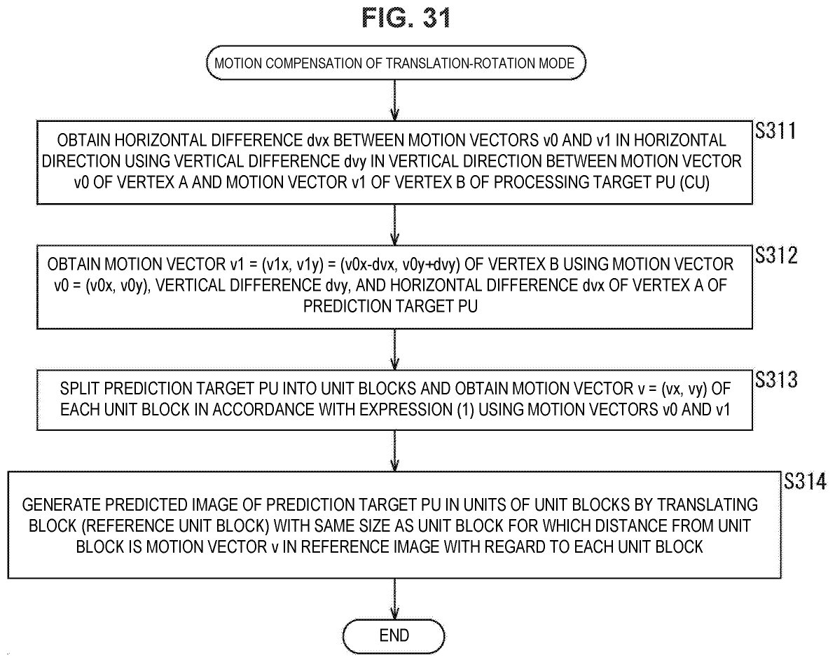

FIG. 31 is an explanatory flowchart illustrating an example of a process for motion compensation of the translation-rotation mode in a case in which motion compensation based on a horizontal difference dvₓ is adopted as motion compensation of the translation-rotation mode.

That is, FIG. 31 is an explanatory flowchart illustrating the process of the motion compensation of the translation-rotation mode performed in steps S42 and S43 of FIG. 20, step S110 of FIG. 21, step S143 of FIG. 22, step S242 of FIG. 26, and step S265 of FIG. 27 in a case in which motion compensation based on the horizontal difference dvₓ is adopted as the motion compensation of the translation-rotation mode.

Note that, herein, the process of the motion compensation of the translation-rotation mode performed by the prediction unit 119 of the image encoding apparatus 100 in FIG. 11 has been described, but a similar process is performed even in the prediction unit 216 of the image decoding apparatus 200 in FIG. 23.

In step S311, the prediction unit 119 obtains the horizontal difference dvₓ using the vertical difference dv_{y} in the vertical direction between the motion vector v₀ of the vertex A and the motion vector v₁ of the vertex B of the processing target PU (CU) obtained from the parameter information in accordance with Expression (5), and then the process proceeds to step S312.

In step S312, the prediction unit 119 obtains the motion vector v₁=(v₁ₓ, v_{1y})=(v₀ₓ−dvₓ, v_{0y}+dv_{y}) of the vertex B of the PU 31 using the motion vector v₀=(v₀ₓ, v_{0y}), the vertical difference dv_{y}, and the horizontal difference dvₓ of the vertex A, and then the process proceeds to step S313.

In step S313, the prediction unit 119 splits the prediction target PU into unit blocks. Further, the prediction unit 119 obtains the motion vector v=(vₓ, v_{y}) of each unit block in accordance with Expression (1) on the basis of the motion vector v₀=(v₀ₓ, v_{0y}) of the vertex A and the motion vector v₁=(v₁ₓ, v_{1y}) of the vertex B, and then the process proceeds from step S313 to step S314.

In step S314, the prediction unit 119 generates the predicted image of the PU 31 in units of unit blocks by translating the reference unit block with the same size as the unit block for which a distance from the unit block is the motion vector v in the reference image on the basis of the motion vector v with regard to each unit block, and the process of the motion compensation of the translation-rotation mode ends (is returned).

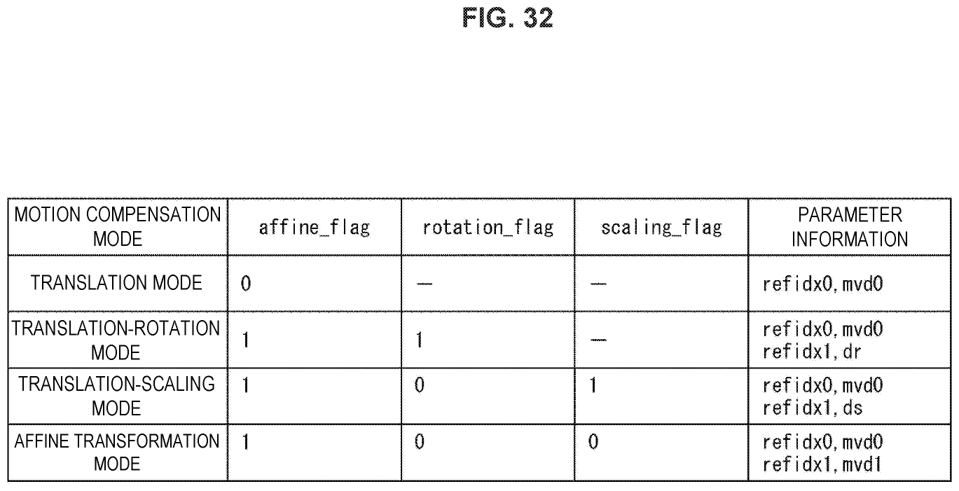

FIG. 32 is an explanatory diagram illustrating another example of the motion compensation mode information.

In FIG. 32, the motion compensation mode information includes affine_flag, rotation_flag, and scaling_flag.

Accordingly, the motion compensation mode information in FIG. 32 is common to the case of FIG. 17 in that there is affine_flag. Here, the motion compensation mode information in FIG. 32 is different from the case of FIG. 17 in that there are no affine3parameter_flag and rotate_scale_idx and rotation_flag and scaling_flag are newly provided.

As described in FIG. 17, affine_flag is information indicating whether the motion compensation mode is the affine transformation mode, the translation-scaling mode, or the translation-rotation mode other than the translation mode. Here, affine_flag is set to 1 in a case in which the motion compensation mode is the affine transformation mode, the translation-rotation mode, or the translation-scaling mode. Conversely, affine_flag is set to 0 in a case in which the motion compensation mode is not the affine transformation mode, the translation-rotation mode, or the translation-scaling mode, that is, a case in which the motion compensation mode is the translation mode.

In addition, rotation_flag is information indicating whether the motion compensation mode is the translation-rotation mode and is set in a case in which affine_flag is 1. In addition, rotation_flag is set to 1 in a case in which the motion compensation mode is the translation-rotation mode. Conversely, rotation_flag is set to 0 in a case in which the motion compensation mode is not the translation-rotation mode, that is, a case in which the motion compensation mode is the translation-scaling mode or the affine transformation mode.

In addition, scaling_flag is information indicating whether the motion compensation mode is the translation-scaling mode and is set in a case in which rotation_flag is 0. In addition, scaling_flag is set to 1 in a case in which the motion compensation mode is the translation-scaling mode, and is set to 0 in a case in which the motion compensation mode is not the translation-scaling mode, that is, a case in which the motion compensation mode is the affine transformation mode.

Accordingly, in a case in which the motion compensation mode is the translation mode, the motion compensation mode information includes affine_flag, and affine_flag is set to 0.

Further, in a case in which the motion compensation mode is the translation-rotation mode, the motion compensation mode information includes affine_flag and rotation_flag, and both affine_flag and rotation_flag are set to 1.

In addition, in a case in which the motion compensation mode is the translation-scaling mode or the affine transformation mode, the motion compensation mode information includes affine_flag, rotation_flag, and scaling_flag, and affine_flag and rotation_flag are set to 1 and 0, respectively. In addition, in a case in which the motion compensation mode is the translation-scaling mode, scaling_flag is set to 1. In a case in which the motion compensation mode is the affine transformation mode, scaling_flag is set to 0.

In FIG. 32, since each piece of parameter information in the case in which the motion compensation mode is the translation mode, the translation-rotation mode, the translation-scaling mode, and the affine transformation mode is the same as that in FIG. 17, the description thereof will be omitted.

### Third Embodiment

(Description of Computer to which the Present Disclosure is Applied)

The series of processes described above can be executed by hardware, and can also be executed in software. In the case of executing the series of processes by software, a program forming the software is installed on a computer. Herein, the term computer includes a computer built into special-purpose hardware, a computer able to execute various functions by installing various programs thereon, such as a general-purpose personal computer, for example, and the like.

FIG. 33 is a block diagram illustrating an exemplary hardware configuration of a computer that executes the series of processes described above according to a program.

In the computer 800, a central processing unit (CPU) 801, read-only memory (ROM) 802, and random access memory (RAM) 803 are interconnected by a bus 804.

Additionally, an input/output interface 810 is connected to the bus 804. An input unit 811, an output unit 812, a storage unit 813, a communication unit 814, and a drive 815 are connected to the input/output interface 810.

The input unit 811 includes a keyboard, a mouse, a microphone, and the like, for example. The output unit 812 includes a display, a speaker, and the like, for example. The storage unit 813 includes a hard disk, non-volatile memory, and the like, for example. The communication unit 814 includes a network interface, for example. The drive 815 drives a removable medium 821 such as a magnetic disk, an optical disc, a magneto-optical disc, or semiconductor memory.

In a computer 800 configured as above, the series of processes described above are performed by having the CPU 801 load a program stored in the storage unit 813 into the RAM 803 via the input/output interface 810 and the bus 804, and execute the program, for example.

The program executed by the computer 800 (the CPU 801) can be recorded on, for example, the removable medium 821 serving as a package medium or the like for supply. In addition, the program can be supplied via a wired or wireless transmission medium such as a local area network, the Internet, or digital satellite broadcast.

In the computer 800, the program can be installed to the storage unit 813 via the input/output interface 810 by mounting the removable medium 821 on the drive 815. In addition, the program can be received by the communication unit 814 via a wired or wireless transmission medium and can be installed in the storage unit 813. Additionally, the program can be installed in advance in the ROM 802 or the storage unit 813.

Note that the program executed by the computer 800 may be a program which is processed chronologically in the sequence described in the present specification or may be a program which is processed in parallel or at a necessary timing such as the calling time.

### Fourth Application Example

FIG. 34 illustrates an example of a schematic configuration of a television apparatus to which the above-described embodiment is applied. The television apparatus 900 has an antenna 901, a tuner 902, a demultiplexer 903, a decoder 904, a video signal processing unit 905, a display unit 906, an audio signal processing unit 907, a speaker 908, an external interface (I/F) unit 909, a control unit 910, a user interface (I/F) unit 911, and a bus 912.

The tuner 902 extracts a signal of a desired channel from a broadcasting signal received via the antenna 901 and demodulates the extracted signal. Then, the tuner 902 outputs an encoded bit stream obtained from the demodulation to the demultiplexer 903. That is, the tuner 902 plays a role as a transmission section of the television apparatus 900 which receives an encoded stream in which images are encoded.

The demultiplexer 903 demultiplexes a video stream and an audio stream of a program to be viewed from the encoded bit stream and outputs the demultiplexed streams to the decoder 904. In addition, the demultiplexer 903 extracts auxiliary data such as an electronic program guide (EPG) from the encoded bit stream and supplies the extracted data to the control unit 910. Note that, in the case where the encoded bit stream has been scrambled, the demultiplexer 903 may perform descrambling.

The decoder 904 decodes the video stream and the audio stream input from the demultiplexer 903. Then, the decoder 904 outputs video data generated from the decoding process to the video signal processing unit 905. In addition, the decoder 904 outputs audio data generated from the decoding process to the audio signal processing unit 907.

The video signal processing unit 905 reproduces the video data input from the decoder 904 to cause the display unit 906 to display a video. In addition, the video signal processing unit 905 may cause the display unit 906 to display an application screen supplied via a network. Furthermore, the video signal processing unit 905 may perform an additional process, for example, noise reduction, on the video data in accordance with a setting. Moreover, the video signal processing unit 905 may generate an image of a graphical user interface (GUI), for example, a menu, a button, or a cursor and superimpose the generated image on an output image.

The display unit 906 is driven with a driving signal supplied from the video signal processing unit 905 and displays a video or an image on a video plane of a display device (e.g., a liquid crystal display, a plasma display, an organic electroluminescence display (OLED), etc.).

The audio signal processing unit 907 performs a reproduction process including D/A conversion and amplification on the audio data input from the decoder 904 and causes the speaker 908 to output a sound. In addition, the audio signal processing unit 907 may perform an additional process such as noise removal on the audio data.

The external interface unit 909 is an interface for connecting the television apparatus 900 to an external apparatus or a network. For example, a video stream or an audio stream received via the external interface unit 909 may be decoded by the decoder 904. In other words, the external interface unit 909 also plays the role as a transmission sections of the television apparatus 900 which receives an encoded stream in which images are encoded.

The control unit 910 has a processor such as a CPU and a memory such as a RAM and a ROM. The memory stores a program executed by the CPU, program data, EPG data, and data acquired via a network. The program stored in the memory is read and executed by the CPU at the time of, for example, start-up of the television apparatus 900. The CPU controls operations of the television apparatus 900 by executing the program in response to, for example, operation signals input from the user interface section 911.

The user interface section 911 is connected to the control unit 910. The user interface section 911 includes, for example, buttons and switches with which a user operates the television apparatus 900, a reception unit for remote control signals, and the like. The user interface section 911 generates an operation signal by detecting an operation by a user via any aforementioned constituent element and outputs the generated operation signal to the control unit 910.

The bus 912 connects the tuner 902, the demultiplexer 903, the decoder 904, the video signal processing unit 905, the audio signal processing unit 907, the external interface unit 909, and the control unit 910 to one another.

In the television apparatus 900 configured in this way, the decoder 904 may also include the functions of the image decoding apparatus 200 described above. In other words, the decoder 904 may be configured to decode encoded data according to the method described in each of the above embodiments. Thus, the television apparatus 900 can obtain the same effects as each of the embodiments described above with reference to FIGS. 11 to 32.

Also, in the television apparatus 900 configured in this way, the video signal processing unit 905 may be able to encode image data provided from the decoder 904, and cause the obtained encoded data to be output externally to the television apparatus 900 through external interface unit 909. Additionally, the video signal processing unit 905 may also include the functions of the image encoding apparatus 100 described above. In other words, the video signal processing unit 905 may be configured to encode image data provided from the decoder 904 according to the method described in each of the above embodiments. Thus, the television apparatus 900 can obtain the same effects as each of the embodiments described above with reference to FIGS. 11 to 32.

### Fifth Application Example

FIG. 35 illustrates an example of a schematic configuration of a mobile telephone to which the above-described embodiments are applied. A mobile telephone 920 includes an antenna 921, a communication unit 922, an audio codec 923, a speaker 924, a microphone 925, a camera unit 926, an image processing unit 927, a multiplexing/demultiplexing unit 928, a recording/reproducing unit 929, a display unit 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 mutually connects the communication unit 922, the audio codec 923, the camera unit 926, the image processing unit 927, the multiplexing/demultiplexing unit 928, the recording/reproducing unit 929, the display unit 930, and the control unit 931.

The mobile telephone 920 performs actions such as transmitting/receiving an audio signal, transmitting/receiving an electronic mail or image data, capturing an image, and recording data in various operation modes including an audio call mode, a data communication mode, a photography mode, and a videophone mode.

In the audio call mode, an analog audio signal generated by the microphone 925 is supplied to the audio codec 923. The audio codec 923 then converts the analog audio signal into audio data, performs A/D conversion on the converted audio data, and compresses the data. The audio codec 923 thereafter outputs the compressed audio data to the communication unit 922. The communication unit 922 encodes and modulates the audio data to generate a transmission signal. The communication unit 922 then transmits the generated transmission signal to a base station (not shown) through the antenna 921. Furthermore, the communication unit 922 amplifies a radio signal received through the antenna 921, performs frequency conversion, and acquires a reception signal. The communication unit 922 thereafter demodulates and decodes the reception signal to generate the audio data and output the generated audio data to the audio codec 923. The audio codec 923 expands the audio data, performs D/A conversion on the data, and generates the analog audio signal. The audio codec 923 then supplies the generated audio signal to the speaker 924 to cause it to output the audio.

In the data communication mode, for example, the control unit 931 generates character data configuring an electronic mail, in accordance with a user operation detected through the operation unit 932. The control unit 931 further displays characters on the display unit 930. Moreover, the control unit 931 generates electronic mail data in accordance with an instruction to send it obtained from a user through the operation unit 932 and outputs the generated electronic mail data to the communication unit 922. The communication unit 922 encodes and modulates the electronic mail data to generate a transmission signal. Then, the communication unit 922 transmits the generated transmission signal to the base station (not shown) through the antenna 921. The communication unit 922 further amplifies a radio signal received through the antenna 921, performs frequency conversion, and acquires a reception signal. The communication unit 922 thereafter demodulates and decodes the reception signal, restores the electronic mail data, and outputs the restored electronic mail data to the control unit 931. The control unit 931 displays the content of the electronic mail on the display unit 930 as well as supplies the electronic mail data to a storage medium of the recording/reproducing unit 929 to cause the data to be recorded in the medium.

The recording/reproducing unit 929 includes an arbitrary storage medium that is readable and writable. For example, the storage medium may be a built-in storage medium such as a RAM or a flash memory, or may be an externally-mounted storage medium such as a hard disk, a magnetic disk, a magneto-optical disk, an optical disk, a USB memory, or a memory card.

In the photography mode, for example, the camera unit 926 images an object to generate image data and outputs the generated image data to the image processing unit 927. The image processing unit 927 encodes the image data input from the camera unit 926 and supplies an encoded stream to the storage medium of the recording/reproducing unit 929 to cause the encoded stream to be recorded in the medium.

Furthermore, in the image display mode, the recording/reproducing unit 929 reads out an encoded stream recorded on a storage medium, and outputs to the image processing unit 927. The image processing unit 927 decodes the encoded stream input from the recording/reproducing unit 929, supplies image data to the display unit 930, and causes the image to be displayed.

In the videophone mode, for example, the multiplexing/demultiplexing unit 928 multiplexes a video stream encoded by the image processing unit 927 and an audio stream input from the audio codec 923, and outputs the multiplexed stream to the communication unit 922. The communication unit 922 encodes and modulates the stream to generate a transmission signal. The communication unit 922 then transmits the generated transmission signal to the base station (not shown) through the antenna 921. Moreover, the communication unit 922 amplifies a radio signal received through the antenna 921, performs frequency conversion, and acquires a reception signal. The transmission signal and the reception signal can include an encoded bit stream. The communication unit 922 thus demodulates and decodes the reception signal to restore the stream, and outputs the restored stream to the multiplexing/demultiplexing unit 928. The multiplexing/demultiplexing unit 928 demultiplexes the video stream and the audio stream from the input stream and outputs the video stream and the audio stream to the image processing unit 927 and the audio codec 923, respectively. The image processing unit 927 decodes the video stream to generate video data. The video data is then supplied to the display unit 930, which displays a series of images. The audio codec 923 expands and performs D/A conversion on the audio stream to generate an analog audio signal. The audio codec 923 then supplies the generated audio signal to the speaker 924 to cause it to output the audio.

In the mobile telephone 920 configured in this way, the image processing unit 927 may include the functions of the image encoding apparatus 100 described above, for example. In other words, the image processing unit 927 may be configured to encode image data according to the method described in each of the above embodiments. Thus, the mobile telephone 920 can obtain the same effects as each of the embodiments described above with reference to FIGS. 11 to 32.

In addition, in the mobile telephone 920 configured in this way, the image processing unit 927 may include the functions of the image decoding apparatus 200 described above, for example. In other words, the image processing unit 927 may be configured to decode encoded data according to the method described in each of the above embodiments. Thus, the mobile telephone 920 can obtain the same effects as each of the embodiments described above with reference to FIGS. 11 to 32.

### Sixth Application Example

FIG. 36 illustrates an example of a schematic configuration of a recording/reproducing apparatus to which the above-described embodiments are applied. The recording/reproducing apparatus 940 encodes audio data and video data of a received broadcast program and records the data into a recording medium, for example. The recording/reproducing apparatus 940 may also encode audio data and video data acquired from another apparatus and record the data into the recording medium, for example. The recording/reproducing apparatus 940 reproduces the data recorded in the recording medium on a monitor and a speaker, for example, in response to a user instruction. In this case, recording/reproducing apparatus 940 decodes the audio data and the video data.

The recording/reproducing apparatus 940 includes a tuner 941, an external interface unit 942, an encoder 943, a hard disk drive (HDD) 944, a disk drive 945, a selector 946, a decoder 947, an on-screen display (OSD) unit 948, a control unit 949, and a user interface unit 950.

The tuner 941 extracts a signal of a desired channel from a broadcast signal received through an antenna (not shown) and demodulates the extracted signal. The tuner 941 then outputs an encoded bit stream obtained by the demodulation to the selector 946. That is, the tuner 941 has a role as a transmission unit in the recording/reproducing apparatus 940.

The external interface unit 942 is an interface which connects the recording/reproducing apparatus 940 with an external device or a network. The external interface unit 942 may be, for example, an institute of electrical and electronic engineers (IEEE) 1394 interface, a network interface, a USB interface, or a flash memory interface. The video data and the audio data received through the external interface unit 942 are input to the encoder 943, for example. That is, the external interface unit 942 has a role as a transmission unit in the recording/reproducing apparatus 940.

The encoder 943 encodes the video data and the audio data in the case where the video data and the audio data input from the external interface unit 942 are not encoded. The encoder 943 thereafter outputs an encoded bit stream to the selector 946.

The HDD unit 944 records, into an internal hard disk, the encoded bit stream in which content data such as video and audio is compressed, various programs, and other data. The HDD unit 944 reads these data from the hard disk when the video and the audio are reproduced.

The disk drive 945 records and reads data into/from a recording medium attached to the disk drive. The recording medium attached to the disk drive 945 may be, for example, a digital versatile disc (DVD) disc (such as DVD-Video, DVD-random access memory (DVD-RAM), DVD-recordable (DVD-R), DVD-rewritable (DVD-RW), DVD+recordable (DVD+R), or DVD+rewritable (DVD+RW)) or a Blu-ray (Registered Trademark) disk.

The selector 946 selects the encoded bit stream input from the tuner 941 or the encoder 943 when recording the video and audio, and outputs the selected encoded bit stream to the HDD unit 944 or the disk drive 945. When reproducing the video and audio, on the other hand, the selector 946 outputs the encoded bit stream input from the HDD unit 944 or the disk drive 945 to the decoder 947.

The decoder 947 decodes the encoded bit stream to generate the video data and the audio data. The decoder 947 then outputs the generated video data to the OSD unit 948. Further, the decoder 947outputs the generated audio data to an external speaker.

The OSD unit 948 reproduces the video data input from the decoder 947 and displays the video. The OSD unit 948 may also superpose an image of a GUI such as a menu, buttons, or a cursor onto the displayed video.

The control unit 949 includes a processor such as a CPU and a memory such as a RAM and a ROM. The memory stores a program executed by the CPU as well as program data. The program stored in the memory is read by the CPU at the start-up of the recording/reproducing apparatus 940 and executed, for example. By executing the program, the CPU controls the operation of the recording/reproducing apparatus 940 in accordance with an operation signal that is input from the user interface unit 950, for example.

The user interface unit 950 is connected to the control unit 949. The user interface unit 950 includes a button and a switch for a user to operate the recording/reproducing apparatus 940 as well as a reception part which receives a remote control signal, for example. The user interface unit 950 detects a user operation through these components to generate an operation signal, and outputs the generated operation signal to the control unit 949.

In the recording/reproducing apparatus 940 configured in this way, the encoder 943 may include the functions of the image encoding apparatus 100 described above, for example. In other words, the encoder 943 may be configured to encode image data according to the method described in each of the above embodiments. Thus, the recording/reproducing apparatus 940 can obtain the same effects as each of the embodiments described above with reference to FIGS. 11 to 32.

In addition, in the recording/reproducing apparatus 940 configured in this way, the decoder 947 may include the functions of the image decoding apparatus 200 described above, for example. In other words, the decoder 947 may be configured to decode encoded data according to the method described in each of the above embodiments. Thus, the recording/reproducing apparatus 940 can obtain the same effects as each of the embodiments described above with reference to FIGS. 11 to 32.

### Seventh Application Example

FIG. 37 illustrates an example of a schematic configuration of an imaging apparatus to which the above-described embodiments are applied. The imaging apparatus 960 images an object to generate an image, encodes image data, and records the data into a recording medium.

The imaging apparatus 960 includes an optical block 961, an imaging unit 962, a signal processing unit 963, an image processing unit 964, a display unit 965, an external interface unit 966, a memory unit 967, a media drive 968, an OSD unit 969, a control unit 970, a user interface unit 971, and a bus 972.

The optical block 961 is connected to the imaging unit 962. The imaging unit 962 is connected to the signal processing unit 963. The display unit 965 is connected to the image processing unit 964. The user interface unit 971 is connected to the control unit 970. The bus 972 mutually connects the image processing unit 964, the external interface unit 966, the memory unit 967, the media drive 968, the OSD unit 969, and the control unit 970.

The optical block 961 includes a focus lens and a diaphragm mechanism. The optical block 961 forms an optical image of an object on an imaging plane of the imaging unit 962. The imaging unit 962 includes an image sensor such as a Charge Coupled Device (CCD) or a Complementary Metal Oxide Semiconductor (CMOS) and performs photoelectric conversion to convert the optical image formed on the imaging plane into an image signal as an electric signal. Then, the imaging unit 962 outputs the image signal to the signal processing unit 963.

The signal processing unit 963 performs various camera signal processes such as a knee correction, a gamma correction and a color correction on the image signal input from the imaging unit 962. The signal processing unit 963 outputs the image data, on which the camera signal processes have been performed, to the image processing unit 964.

The image processing unit 964 encodes the image data input from the signal processing unit 963 and generates the encoded data. The image processing unit 964 then outputs the generated encoded data to the external interface unit 966 or the media drive 968. The image processing unit 964 also decodes the encoded data input from the external interface unit 966 or the media drive 968 to generate image data. The image processing unit 964 then outputs the generated image data to the display unit 965. Moreover, the image processing unit 964 may output to the display unit 965 the image data input from the signal processing unit 963 to cause the display unit 965 to display the image. Furthermore, the image processing unit 964 may superpose display data acquired from the OSD unit 969 onto the image that is output on the display unit 965.

The OSD unit 969 generates an image of a GUI such as a menu, buttons, or a cursor and outputs the generated image to the image processing unit 964.

The external interface unit 966 is configured as a USB input/output terminal, for example. The external interface unit 966 connects the imaging apparatus 960 with a printer when printing an image, for example. Moreover, a drive is connected to the external interface unit 966 as needed. A removable medium such as a magnetic disk or an optical disk is attached to the drive, for example, so that a program read from the removable medium can be installed to the imaging apparatus 960. The external interface unit 966 may also be configured as a network interface that is connected to a network such as a LAN or the Internet. That is, the external interface unit 966 has a role as a transmission unit in the imaging apparatus 960.

The recording medium attached to the media drive 968 may be an arbitrary removable medium that is readable and writable such as a magnetic disk, a magneto-optical disk, an optical disk, or a semiconductor memory. Furthermore, the recording medium may be attached to the media drive 968 in a fixed manner so that a non-transportable storage unit such as a built-in hard disk drive or a solid state drive (SSD) is configured, for example.

The control unit 970 includes a processor such as a CPU and a memory such as a RAM and a ROM. The memory stores a program executed by the CPU as well as program data. The program stored in the memory is read by the CPU at the start-up of the imaging apparatus 960 and then executed. By executing the program, the CPU controls the operation of the imaging apparatus 960 in accordance with an operation signal that is input from the user interface unit 971, for example.

The user interface unit 971 is connected to the control unit 970. The user interface unit 971 includes buttons and switches for a user to operate the imaging apparatus 960, for example. The user interface unit 971 detects a user operation through these components to generate an operation signal, and outputs the generated operation signal to the control unit 970.

In the imaging apparatus 960 configured in this way, the image processing unit 964 may include the functions of the image encoding apparatus 100 described above, for example. In other words, the image processing unit 964 may be configured to encode image data according to the method described in each of the above embodiments. Thus, the imaging apparatus 960 can obtain the same effects as each of the embodiments described above with reference to FIGS. 11 to 32.

In addition, in the imaging apparatus 960 configured in this way, the image processing unit 964 may include the functions of the image decoding apparatus 200 described above, for example. In other words, the image processing unit 964 may be configured to decode encoded data according to the method described in each of the above embodiments. Thus, the imaging apparatus 960 can obtain the same effects as each of the embodiments described above with reference to FIGS. 11 to 32.

### Eighth Application Example: Video Set

Additionally, the present technology may also be implemented as any kind of configuration installed in any apparatus or an apparatus included in a system, such as a processor provided as a large-scale integration (LSI) chip or the like, a module that uses multiple processors or the like, a unit that uses multiple modules or the like, a set that further adds other functions to a unit (that is, a configuration of a part of an apparatus), or the like. FIG. 38 illustrates one example of a schematic configuration of a video set applying the present technology.

Recently, electronic devices are becoming more multifunctional, and in the development and manufacture of such electronic devices, in the case of implementing a partial configuration thereof for sale, offer, or the like, it has become commonplace not only to carry out the implementation as a configuration that includes a single function, but also to combine multiple configurations that include related functions and carry out the implementation as a single set including multiple functions.

The video set 1300 illustrated in FIG. 38 is such a multifunctional configuration, and is a combination of a device that includes functions related to image encoding and decoding (either one, or both) with a device that includes other functions related to such functions.

As illustrated in FIG. 38, the video set 1300 includes a module group such as a video module 1311, external memory 1312, a power management module 1313, and a front-end module 1314, and a device that includes related functions such as connectivity 1321, a camera 1322 and a sensor 1323.

A module is a part that collects several interrelated partial functions into a unified function. The specific physical configuration may be any configuration, but for example, it is conceivable to dispose and integrate multiple processors with respective functions, electronic circuit elements such as resistors and capacitors, other devices, and the like onto a circuit board or the like. It is also conceivable to combine a module with another module, processor, or the like to create a new module.

In the case of the example in FIG. 38, the video module 1311 is a combination of configurations that include functions related to image processing, and includes an application processor, a video processor, a broadband modem 1333, and an RF module 1334.

The processor is an integration of configurations having predetermined functions into a semiconductor chip as a system on a chip (SoC), and may also be designated a large-scale integration (LSI) chip or the like, for example. The configurations having predetermined functions may be logic circuits (hardware configurations), but may also be a CPU, ROM, RAM, and the like as well as a program executed using these (software configurations), and may also be a combination of both. For example, a processor may include logic circuits and CPU, ROM, RAM, and the like, and may be configured to realize a subset of the functions with the logic circuits (hardware configurations) while realizing other functions with programs (software configurations) executed on the CPU.

The application processor 1331 in FIG. 38 is a processor that executes an application related to image processing. To realize a predetermined function, the application executed in the application processor 1331 is able to not only execute computational processing, but is also able to control configurations inside and outside the video module 1311, such as the video processor 1332, for example, as necessary.

The video processor 1332 is a processor that includes functions related to image encoding/decoding (either one, or both).

The broadband modem 1333 performs digital modulation and the like to convert data (a digital signal) transmitted by wired or wireless (or both) broadband communication performed over a broadband connection such as the Internet or the public telephone network into an analog signal, and also performs demodulation to convert an analog signal received by such broadband communication into data (a digital signal). The broadband modem 1333 processes any kind of information, such as image data processed by the video processor 1332, a stream in which image data is encoded, application programs, and settings data, for example.

The RF module 1334 is a module that performs frequency conversion, modulation/demodulation, amplification, filter processing, and the like on radio frequency (RF) signals transmitted and received through an antenna. For example, the RF module 1334 generates an RF signal by performing frequency conversion and the like on a baseband signal generated by the broadband modem 1333. Also, for example, the RF module 1334 generates a baseband signal by performing frequency conversion and the like on an RF signal received via the front-end module 1314.

Note that as illustrated by the dashed line 1341 in FIG. 38, the application processor 1331 and the video processor 1332 may also be unified and configured as a single processor.

The external memory 1312 is a module provided externally to the video module 1311 that includes a storage device utilized by the video module 1311. The storage device of the external memory 1312 may be realized by any kind of physical configuration, but since the storage device typically is used to store large amounts of data such as image data in units of frames, it is desirable to realize the storage device with relatively inexpensive and high-capacity semiconductor memory such as dynamic random access memory (DRAM), for example.

The power management module 1313 manages and controls the supply of power to the video module 1311 (each configuration inside the video module 1311).

The front-end module 1314 is a module that provides a front-end function (a circuit on the antenna-side transmit/receive port) to the RF module 1334. As illustrated in FIG. 38, the front-end module 1314 includes an antenna unit 1351, a filter 1352, and an amplification unit 1353, for example.

The antenna unit 1351 includes an antenna that transmits and receives wireless signals, and a peripheral configuration thereof. The antenna unit 1351 transmits a signal supplied from the amplification unit 1353 as a wireless signal, and supplies a received wireless signal to the filter 1352 as an electric signal (RF signal). The filter 1352 performs filter processing and the like on the RF signal received through the antenna unit 1351, and supplies the processed RF signal to the RF module 1334. The amplification unit 1353 amplifies and supplies the RF signal supplied from the RF module 1334 to the antenna unit 1351.

The connectivity 1321 is a module that includes functions related to external connections. The physical configuration of the connectivity 1321 may be any configuration. For example, the connectivity 1321 includes a configuration having a communication function other than the communication standard supporting by the broadband modem 1333, an external input/output terminal, or the like.

For example, the connectivity 1321 may include a module having a communication function conforming to a wireless communication standard such as Bluetooth (registered trademark), IEEE 802.11 (for example, Wireless Fidelity (Wi-Fi (registered trademark))), near field communication (NFC), or infrared Data Association (IrDA), and an antenna or the like that transmits and receives signals conforming to the standard. Also, for example, the connectivity 1321 may include a module having a communication function conforming to a wired communication function such as Universal Serial Bus (USB) or High-Definition Multimedia interface (HDMI) (registered trademark), and a port conforming to the standard. Furthermore, for example, the connectivity 1321 may include a function of transmitting another kind of data (signal), such as an analog input/output terminal.

Note that the connectivity 1321 may include the transmission destination device of the data (signal). For example, the connectivity 1321 may include a drive (not only a drive for removable media, but also including a hard disk, a solid-state drive (SSD), network-attached storage (NAS), and the like) that reads and writes data with respect to a recording medium such as a magnetic disk, an optical disc, a magneto-optical disc, or semiconductor memory. Also, the connectivity 1321 may include devices (such as a monitor and a speaker) that output images and sound.

The camera 1322 is a module that has a function of imaging a subject and obtaining image data of the subject. The image data obtained by the imaging by the camera 1322 is supplied to the video processor 1332 and encoded, for example.

The sensor 1323 is a module having any type of sensor function, such as a sound sensor, an ultrasonic sensor, a light sensor, an illumination sensor, an infrared sensor, an image sensor, a rotation sensor, an angle sensor, an angular velocity sensor, a speed sensor, an acceleration sensor, an inclination sensor, a magnetic field sensor, a shock sensor, or a temperature sensor, for example. Data detected by the sensor 1323 is supplied to the application processor 1331 and utilized by an application and the like, for example.

The configurations described as a module above may also be realized as a processor, while conversely, the configurations described as a processor may also be realized as a module.

In the video set 1300 with a configuration like the above, the present technology can be applied to the video processor 1332 as described later. Consequently, the video set 1300 may be carried out as a set applying the present technology.

### (Exemplary Configuration of Video Processor)

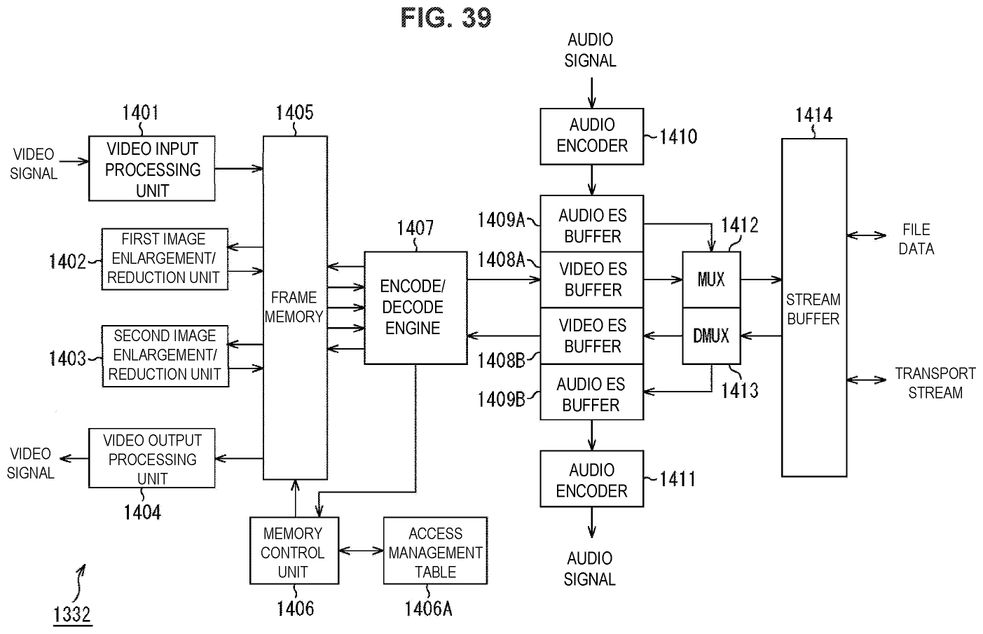

FIG. 39 illustrates one example of a schematic configuration of the video processor 1332 (FIG. 38) applying the present technology.

In the case of the example in FIG. 39, the video processor 1332 includes a function of receiving the input of a video signal and an audio signal and encoding these signals according to a predetermined method, and a function of decoding encoded video data and audio data, and reproducing and outputting a video signal and an audio signal.

As illustrated in FIG. 39, the video processor 1332 includes a video input processing unit 1401, a first image enlargement/reduction unit 1402, a second image enlargement/reduction unit 1403, a video output processing unit 1404, frame memory 1405, and a memory control unit 1406. Also, the video processor 1332 includes an encode/decode engine 1407, video elementary stream (ES) buffers 1408A and 1408B, and audio ES buffers 1409A and 1409B. Additionally, the video processor 1332 includes an audio encoder 1410, an audio decoder 1411, a multiplexer (MUX) 1412, a demultiplexer (DMUX) 1413, and a stream buffer 1414.

The video input processing unit 1401 acquires a video signal input from the connectivity 1321 (FIG. 38) or the like, for example, and converts the video signal into digital image data. The first image enlargement/reduction unit 1402 performs format conversion, image enlargement/reduction processing, and the like on the image data. The second image enlargement/reduction unit 1403 performs a process of enlarging or reducing the image according to the format at the destination to which to output through the video output processing unit 1404, format conversion and image enlargement/reduction processing similar to the first image enlargement/reduction unit 1402, and the like on the image data. The video output processing unit 1404 performs format conversion, conversion to an analog signal, and the like on the image data, and outputs the result to the connectivity 1321 for example as a reproduced video signal.

The frame memory 1405 is memory for image data shared by the video input processing unit 1401, the first image enlargement/reduction unit 1402, the second image enlargement/reduction unit 1403, the video output processing unit 1404, and the encode/decode engine 1407. The frame memory 1405 is realized as semiconductor memory such as DRAM, for example.

The memory control unit 1406 receives a synchronization signal from the encode/decode engine 1407, and controls the access and writes and reads to the frame memory 1405 in accordance with an access schedule of access to the frame memory 1405 written in an access management table 1406A. The access management table 1406A is updated by the memory control unit 1406 according to processes executed by the encode/decode engine 1407, the first image enlargement/reduction unit 1402, the second image enlargement/reduction unit 1403, and the like.

The encode/decode engine 1407 executes a process of encoding image data as well as a process of decoding a video stream, which is data in which image data is encoded. For example, the encode/decode engine 1407 encodes image data read from the frame memory 1405, and successively writes the encoded data to the video ES buffer 1408A as a video stream. Also, for example, the encode/decode engine 1407 successively reads and decodes a video stream from the video ES buffer 1408B, and writes the decoded data to the frame memory 1405 as image data. During this encoding and decoding, the encode/decode engine 1407 uses the frame memory 1405 as a work area. Also, the encode/decode engine 1407 outputs a synchronization signal to the memory control unit 1406 at the timing of starting the process for each macroblock, for example.

The video ES buffer 1408A buffers and supplies a video stream generated by the encode/decode engine 1407 to the multiplexer (MUX) 1412. The video ES buffer 1408B buffers and supplies a video stream supplied from the demultiplexer (DMUX) 1413 to the encode/decode engine 1407.

The audio ES buffer 1409A buffers and supplies an audio stream generated by the audio encoder 1410 to the multiplexer (MUX) 1412. The audio ES buffer 1409B buffers and supplies an audio stream supplied from the demultiplexer (DMUX) 1413 to the audio decoder 1411.

The audio encoder 1410 for example digitally converts an audio signal input from the connectivity 1321 or the like, for example, and encodes the audio signal according to a predetermined method such as the MPEG Audio method or the AudioCode number 3 (AC3) method, for example. The audio encoder 1410 successively writes an audio stream, which is data in which an audio signal is encoded, to the audio ES buffer 1409A. The audio decoder 1411 decodes an audio stream supplied from the audio ES buffer 1409B, performs conversion to an analog signal and the like, for example, and supplies the result to the connectivity 1321 and the like for example as a reproduced audio signal.

The multiplexer (MUX) 1412 multiplexes a video stream and an audio stream. The multiplexing method (that is, the format of the bit stream generated by multiplexing) may be any method. Additionally, during this multiplexing, the multiplexer (MUX) 1412 is also able to add predetermined header information or the like to the bit stream. In other words, the multiplexer (MUX) 1412 is able to convert the format of the streams by multiplexing. For example, by multiplexing a video stream and an audio stream, the multiplexer (MUX) 1412 converts the streams to a transport stream, which is a bit stream in a format for transmission. Also, for example, by multiplexing a video stream and an audio stream, the multiplexer (MUX) 1412 converts the streams to data (file data) in a file format for recording.

The demultiplexer (DMUX) 1413 demultiplexes a bit stream in which a video stream and an audio stream are multiplexed, according to a method corresponding to the multiplexed by the multiplexer (MUX) 1412. In other words, the demultiplexer (DMUX) 1413 extracts the video stream and the audio stream (separates the video stream and the audio stream) from a bit stream read out from the stream buffer 1414. In other words, the demultiplexer (DMUX) 1413 is able to convert the format of the stream by demultiplexing (an inverse conversion of the conversion by the multiplexer (MUX) 1412). For example, the demultiplexer (DMUX) 1413 is able to acquire a transport stream supplied from the connectivity 1321, the broadband modem 1333, or the like for example via the stream buffer 1414, and by demultiplexing, is able to convert the transport stream into a video stream and an audio stream. Also, for example, the demultiplexer (DMUX) 1413 is able to acquire file data read out from any of various types of recording media by the connectivity 1321, for example via the stream buffer 1414, and by demultiplexing, is able to convert the file data into a video stream and an audio stream.

The stream buffer 1414 buffers a bit stream. For example, the stream buffer 1414 buffers a transport stream supplied from the multiplexer (MUX) 1412, and at a predetermined timing, or on the basis of an external request or the like, supplies the transport stream to the connectivity 1321, the broadband modem 1333, or the like, for example.

Also, for example, the stream buffer 1414 buffers file data supplied from the multiplexer (MUX) 1412, and at a predetermined timing, or on the basis of an external request or the like, supplies the file data to the connectivity 1321 or the like, for example, and causes the file data to be recorded on any of various types of recording media.

Furthermore, the stream buffer 1414 buffers a transport stream acquired via the connectivity 1321, the broadband modem 1333, and the like, for example, and at a predetermined timing, or on the basis of an external request or the like, supplies the transport stream to the demultiplexer (DMUX) 1413.

Additionally, the stream buffer 1414 buffers file data read out from any of various types of recording media in the connectivity 1321 or the like, for example, and at a predetermined timing, or on the basis of an external request or the like, supplies the file data to the demultiplexer (DMUX) 1413.

Next, an example of the operation of the video processor 1332 with such a configuration will be described. For example, a video signal input into the video processor 1332 from the connectivity 1321 or the like is converted to digital image data of a predetermined format such as 4:2:2 Y/Cb/Cr format in the video input processing unit 1401, and is successively written to the frame memory 1405. The digital image data is read out to the first image enlargement/reduction unit 1402 or the second image enlargement/reduction unit 1403, subjected to a format conversion to a predetermined format such as 4:2:0 Y/Cb/Cr or the like and an enlargement/reduction process, and again written to the frame memory 1405. The image data is encoded by the encode/decode engine 1407, and written to the video ES buffer 1408A as a video stream.

Also, an audio signal input into the video processor 1332 from the connectivity 1321 or the like is encoded by the audio encoder 1410, and written to the audio ES buffer 1409A as an audio stream.

The video stream in the video ES buffer 1408A and the audio stream in the audio ES buffer 14094 are read out and multiplexed by the multiplexer (MUX) 1412, and converted to a transport stream, file data, or the like. The transport stream generated by the multiplexer (MLA) 1412 is buffered in the stream buffer 1414, and then output to an external network via the connectivity 1321, the broadband modem 1333, or the like, for example. Also, the file data generated by the multiplexer (MUX) 1412 is buffered in the stream buffer 1414, and then output to the connectivity 1321 or the like, for example, and recorded to any of various types of recording media.

Also, a transport stream input into the video processor 1332 from an external network via the connectivity 1321, the broadband modem 1333, or the like for example is buffered in the stream buffer 1414, and then demultiplexed by the demultiplexer (DMUX) 1413. Also, file data read out from any of various types of recording media in the connectivity 1321 or the like, for example, and input into the video processor 1332 is buffered in the stream buffer 1414, and then demultiplexed by the demultiplexer (DMUX) 1413. In other words, a transport stream or file data input into the video processor 1332 is separated into a video stream and an audio stream by the demultiplexer (DMUX) 1413.

The audio stream is supplied to the audio decoder 1411 via the audio ES buffer 1409B and decoded, and an audio signal is reproduced. Also, the video stream, after being written to the video ES buffer 1408B, is successively read out and decoded by the encode/decode engine 1407, and written to the flame memory 1405. The decoded image data is subjected to an enlargement/reduction process by the second image enlargement/reduction unit 1403, and written to the frame memory 1405. Subsequently, the decoded image data is read out to the video output processing unit 1404, format-converted to a predetermined format such as 4:2:2 Y/Cb/Cr format, additionally converted to an analog signal, and a video signal is reproduced and output.

In the case of applying the present technology to the video processor 1332 configured in this way, it is sufficient to apply the present technology according to the embodiments described above to the encode/decode engine 1407. In other words, for example, the encode/decode engine 1407 may include the functions of the image encoding apparatus 100 or the functions of the image decoding apparatus 200 described above, or both. With this arrangement, the video processor 1332 is able to obtain effects similar to each of the embodiments described above with reference to FIGS. 11 to 32.

Note that in the encode/decode engine 1407, the present technology (that is, the functions of the image encoding apparatus 100, the functions of the image decoding apparatus 200, or both) may be realized by hardware such as a logic circuit or the like, may be realized by software such as an embedded program, or may be realized by both of the above.

### (Another Exemplary Configuration of Video Processor)

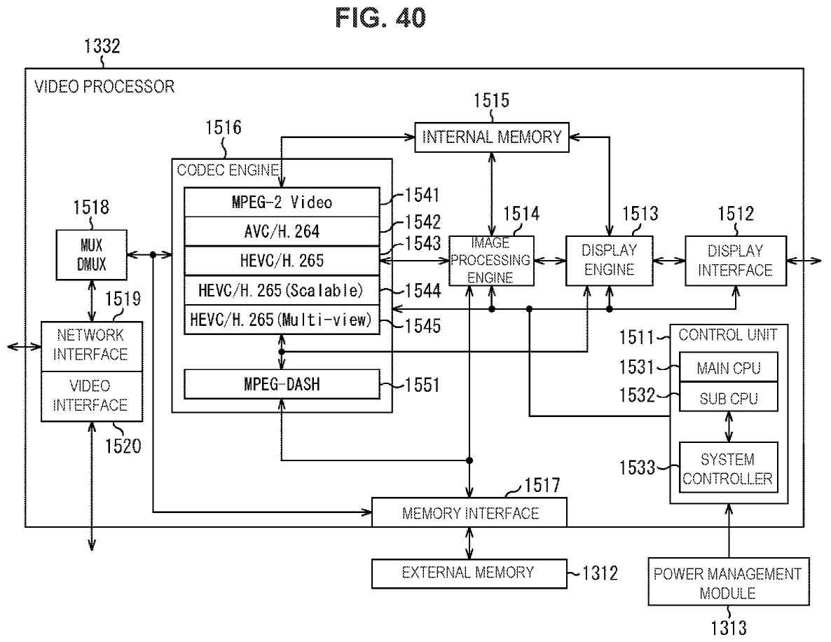

FIG. 40 illustrates another example of a schematic configuration of the video processor 1332 applying the present technology. In the case of the example in FIG. 40, the video processor 1332 includes a function of encoding/decoding video data according to a predetermined method.

More specifically, as illustrated in FIG. 40, the video processor 1332 includes a control unit 1511, a display interface 1512, a display engine 1513, an image processing engine 1514, and internal memory 1515. Also, the video processor 1332 includes a codec engine 1516, a memory interface 1517, a multiplexer/demultiplexer (MUX DMUX) 1518, a network interface 1519, and a video interface 1520.

The control unit 1511 controls the operation of each processing unit in the video processor 1332, such as the display interface 1512, the display engine 1513, the image processing engine 1514, and the codec engine 1516.

As illustrated in FIG. 40, the control unit 1511 includes a main CPU 1531, a sub CPU 1532, and a system controller 1533, for example. The main CPU 1531 executes a program or the like for controlling the operation of each processing unit in the video processor 1332. The main CPU 1531 generates control signals in accordance with the program or the like, and supplies the control signals to each processing unit (in other words, controls the operation of each processing unit). The sub CPU 1532 fulfills a supplementary role to the main CPU 1531. For example, the sub CPU 1532 executes child processes, subroutines, and the like of the program or the like executed by the main CPU 1531. The system controller 1533 controls the operations of the main CPU 1531 and the sub CPU 1532, such as specifying programs to be executed by the main CPU 1531 and the sub CPU 1532.

The display interface 1512, under control by the control unit 1511, outputs image data to the connectivity 1321 and the like, for example. For example, the display interface 1512 converts digital image data to an analog signal and outputs an analog signal, or outputs the digital image data directly, as a reproduced video signal to a monitor apparatus or the like of the connectivity 1321.

The display engine 1513, under control by the control unit 1511, performs various conversion processes such as format conversion, size conversion, and gamut conversion on the image data to match the hardware specs of the monitor apparatus or the like that is to display the image.

The image processing engine 1514, under control by the control unit 1511 performs predetermined image processing on the image data, such as filter processing for improving image quality, for example.

The internal memory 1515 is memory provided inside the video processor 1332, and shared by the display engine 1513, the image processing engine 1514, and the codec engine 1516. For example, the internal memory 1515 is used to exchange data between the display engine 1513, the image processing engine 1514, and the codec engine 1516. For example, the internal memory 1515 stores data supplied from the display engine 1513, the image processing engine 1514, or the codec engine 1516, and as necessary (for example, in response to a request), supplies the data to the display engine 1513, the image processing engine 1514, or the codec engine 1516. The internal memory 1515 may be realized by any kind of storage device, but since the storage device typically is used to store small amounts of data such as image data in units of blocks, parameters, and the like, it is desirable to realize the storage device with semiconductor memory that is relatively (for example, compared to the external memory 1312) small in capacity but has a fast response speed, such as static random access memory (SRAM), for example.

The codec engine 1516 executes processes related to the encoding and decoding of image data. The encoding/decoding method supported by the codec engine 1516 may be any method, and there may be one or multiple such methods. For example, the codec engine 1516 may be provided with a codec function for multiple encoding/decoding methods, and may be configured to encode or decode image data by selecting from among the multiple methods.

In the example illustrated in FIG. 40, the codec engine 1516 includes MPEG-2 Video 1541, AVC/H.264 1542, HEVC/H.265 1543, HEVC/H.265 (Scalable) 1544, HEVC/H.265 (Multi-view) 1545, and MPEG-DASH 1551 as function blocks of codec-related processing, for example.

The MPEG-2 Video 1541 is a function block that encodes and decodes image data according to the MPEG-2 method. The AVC/H.264 1542 is a function block that encodes and decodes image data according to the AVC method. The HEVC/H.265 1543 is a function block that encodes and decodes image data according to the HEVC method. The HEVC/H.265 (Scalable) 1544 is a function block that scalably encodes and scalably decodes image data according to the HEVC method. The HEVC/H.265 (Multi-view) 1545 is a function block that multi-view encodes and multi-view decodes image data according to the HEVC method.

The MPEG-DASH 1551 is a function block that transmits and receives image data according to the MPEG Dynamic Adaptive Streaming over HTTP (MPEG-DASH) method. MPEG-DASH is a technology that uses the Hypertext Transfer Protocol (HTTP) to stream video, one feature of which being that appropriate encoded data is selected and transmitted in units of segments from among multiple sets of encoded data having different resolutions or the like prepared in advance. The MPEG-DASH 1551 executes the generation, transmission control, and the like of a stream conforming to the standard, while for the encoding/decoding of image data, the MPEG-2 Video 1541 to the HEVC/H.265 (Multi-view) 1545 are used.

The memory interface 1517 is an interface for the external memory 1312. Data supplied from the image processing engine 1514 and the codec engine 1516 is supplied to the external memory 1312 through the memory interface 1517. Also, data read out from the external memory 1312 is supplied to the video processor 1332 (the image processing engine 1514 or the codec engine 1516) through the memory interface 1517.

The multiplexer/demultiplexer (MUX DMUX) 1518 multiplexes and demultiplexes various image-related data, such as a bit stream of encoded data, image data, a video signal, and the like. The multiplexing/demultiplexing method may be any method. For example, when multiplexing, the multiplexer/demultiplexer (MUX DMUX) 1518 is not only able to collect multiple pieces of data into a single piece of data, but also add predetermined header information and the like to the data. Also, when demultiplexing, the multiplexer/demultiplexer (MUX DMUX) 1518 is not only able to divide a single piece of data into multiple pieces of data, but also add predetermined header information and the like to each divided piece of data. In other words, the multiplexer/demultiplexer (MUX DMUX) 1518 is able to convert the format of data by multiplexing/demultiplexing. For example, by multiplexing a bit stream, the multiplexer/demultiplexer (MUX DMUX) 1518 is able to convert the bit stream to a transport stream, which is a bit stream in a format for transmission, or to data in a file format (file data) for recording. Obviously, by demultiplexing, the inverse conversion is also possible.

The network interface 1519 is an interface for the broadband modem 1333, the connectivity 1321, and the like, for example. The video interface 1520 is an interface for the connectivity 1321, the camera 1322, and the like, for example.

Next, an example of the operation of such a video processor 1332 will be described. For example, when a transport stream is received from an external network through the connectivity 1321, the broadband modem 1333, or the like, the transport stream is supplied to the multiplexer/demultiplexer (MUX DMUX) 1518 through the network interface 1519 and demultiplexed, and decoded by the codec engine 1516. The image data obtained by the decoding of the codec engine 1516 is, for example, subjected to predetermined image processing by the image processing engine 1514, subjected to a predetermined conversion by the display engine 1513, supplied to the connectivity 1321 or the like for example through the display interface 1512, and the image is displayed on a monitor. Also, for example, the image data obtained by the decoding of the codec engine 1516 is re-encoded by the codec engine 1516, multiplexed and converted to file data by the multiplexer/demultiplexer (MUX DMUX) 1518, output to the connectivity 1321 or the like for example through the video interface 1520, and recorded on any of various types of recording media.

Furthermore, for example, file data of encoded data in which image data is encoded that is read out from a recording medium not illustrated by the connectivity 1321 or the like is supplied to the multiplexer/demultiplexer (MUX DMUX) 1518 through the video interface 1520 and demultiplexed, and decoded by the codec engine 1516. The image data obtained by the decoding of the codec engine 1516 is subjected to predetermined image processing by the image processing engine 1514, subjected to a predetermined conversion by the display engine 1513, supplied to the connectivity 1321 or the like for example through the display interface 1512, and the image is displayed on a monitor. Also, for example, the image data obtained by the decoding of the codec engine 1516 is re-encoded by the codec engine 1516, multiplexed and converted to a transport stream by the multiplexer/demultiplexer (MUX DMUX) 1518, supplied to the connectivity 1321, the broadband modem 1333, or the like for example through the network interface 1519, and transmitted to another apparatus not illustrated.

Note that the exchange of image data and other data between each of the processing units inside the video processor 1332 is performed by utilizing the internal memory 1515 and the external memory 1312, for example. Additionally, the power management module 1313 controls the supply of power to the control unit 1511, for example.

In the case of applying the present technology to the video processor 1332 configured in this way, it is sufficient to apply the present technology according to the embodiments described above to the codec engine 1516. In other words, for example, it is sufficient for the codec engine 1516 to include the functions of the image encoding apparatus 100 or the functions of the image decoding apparatus 200 described above, or both. With this arrangement, the video processor 1332 is able to obtain effects similar to each of the embodiments described above with reference to FIGS. 11 to 32.

Note that in the codec engine 1516, the present technology (that is, the functions of the image encoding apparatus 100) may be realized by hardware such as a logic circuit or the like, may be realized by software such as an embedded program, or may be realized by both of the above.

The above illustrates two configurations of the video processor 1332 as examples, but the configuration of the video processor 1332 may be any configuration, and may be a configuration other than the two examples described above. Also, the video processor 1332 may be configured as a single semiconductor chip, but may also be configured as multiple semiconductor chips. For example, a three-dimensionally stacked LSI chip in which multiple semiconductors are stacked is possible. Also, a configuration realized by multiple LSI chips is possible.

### (Example of Application to Apparatus)

The video set 1300 can be embedded into any of various types of apparatus that process image data. For example, the video set 1300 can be embedded into the television apparatus 900 (FIG. 34), the mobile telephone 920 (FIG. 35), the recording/reproducing apparatus 940 (FIG. 36), the imaging apparatus 960 (FIG. 37), and the like. By embedding the video set 1300, the apparatus is able to obtain effects similar to each of the embodiments described above with reference to FIGS. 11 to 32.

Note that as long as the video processor 1332 is included, even a part of each configuration of the video set 1300 described above can be carried out as a configuration applying the present technology. For example, it is possible to carry out only the video processor 1332 as a video processor applying the present technology. Also, for example, the processor illustrated by the dashed line 1341 as described above, the video module 1311, and the like can be carried out as a processor, module, or the like applying the present technology. Furthermore, for example, the video module 1311, the external memory 1312, the power management module 1313, and the front-end module 1314 can also be combined and carried out as a video unit 1361 applying the present technology. With any of these configurations, it is possible to obtain effects similar to each of the embodiments described above with reference to FIGS. 11 to 32.

In other words, as long as the video processor 1332 is included, any type of configuration can be embedded into any of various types of apparatus that process image data, similarly to the case of the video set 1300. For example, the video processor 1332, the processor illustrated by the dashed line 1341, the video module 1311, or the video unit 1361 can be embedded into the television apparatus 900 (FIG. 34), the mobile telephone 920 (FIG. 35), the recording/reproducing apparatus 940 (FIG. 36), the imaging apparatus 960 (FIG. 37), and the like. Additionally, by embedding any configuration applying the present technology, the apparatus is able to obtain effects similar to each of the embodiments described above with reference to FIGS. 11 to 32, similarly to the video set 1300.

### Ninth Application Example

Additionally, the present technology is also applicable to a network system that includes multiple apparatus. FIG. 41 illustrates one example of a schematic configuration of a network system applying the present technology.

The network system 1600 illustrated in FIG. 41 is a system in which devices exchange information related to images (moving images) with each other over a network. The cloud service 1601 of the network system 1600 is a system that provides a service related to images (moving images) to terminals such as a computer 1611, audio-visual (AV) equipment 1612, a mobile information processing terminal 1613, and an Internet of Things (IoT) device 1614 communicably connected to the cloud service 1601. For example, the cloud service 1601 provides a service of supplying image (moving image) content to terminals, like what is called video streaming (on-demand or live streaming). As another example, the cloud service 1601 provides a backup service that receives and stores image (moving image) content from terminals. As another example, the cloud service 1601 provides a service of mediating the exchange of image (moving image) content between terminals.

The physical configuration of the cloud service 1601 may be any configuration. For example, the cloud service 1601 may include various servers, such as a server that saves and manages moving images, a server that delivers moving images to terminals, a server that acquires moving images from terminals, and a server that manages users (terminals) and payments, as well as any type of network, such as the Internet or a LAN.

The computer 1611 includes an information processing apparatus such as a personal computer, server, or workstation, for example. The AV equipment 1612 includes image processing apparatus such as a television receiver, a hard disk recorder, a game console, or a camera, for example. The mobile information processing terminal 1613 includes a mobile information processing apparatus such as a notebook personal computer, a tablet terminal, a mobile telephone, or a smartphone, for example. The IoT device 1614 includes any object that executes image-related processing, such as a machine, an electric appliance, a piece of furniture, some other thing, an IC tag, or a card-shaped device, for example. These terminals all include a communication function, and are able to connect to (establish a session with) the cloud service 1601 and exchange information with (that is, communicate with) the cloud service 1601. Also, each terminal is also able to communicate with another terminal. Communication between terminals may be performed by going through the cloud service 1601, or may be performed without going through the cloud service 1601.

When the present technology is applied to the network system 1600 as above, and image (moving image) data is exchanged between terminals or between a terminal and the cloud service 1601, the image data may be encoded/decoded as described above in each of the embodiments. In other words, the terminals (from the computer 1611 to the IoT device 1614) and the cloud service 1601 each may include the functions of the image encoding apparatus 100 and the image decoding apparatus 200 described above. Thus, the terminals (from the computer 1611 to the IoT device 1614) and the cloud service 1601 both which receive image data can obtain the same effects as each of the embodiments described above with reference to FIGS. 11 to 32.

Note that various kinds of information regarding the encoded data (the bit stream) may be multiplexed to the encoded data to be transmitted or recorded, or may be transmitted or recorded as separate data associated with the encoded data without being multiplexed to the encoded data. The term “associated with” used herein means, in one example, that when one data is processed, other data can be used (linkable). In other words, the data associated with each other may be collected as one data or may be individual data. In one example, information associated with encoded data (image) may be transmitted on a transmission path different from that of the encoded data (image). In addition, in one example, the information associated with encoded data (image) may be recorded on a recording medium (or other recording areas of the same recording medium) different from that of the encoded data (image). Moreover, this term “associated with” may be a part of data, not the entire data. In one example, an image and information corresponding to the image may be associated with each other in any units such as a plurality of frames, one frame, a part within a frame, or the like.

Further, as described above, herein, the terms “combine”, “multiplex”, “attach”, “integrate”, “include”, “store”, “push into”, “put into, “insert”, and the like mean combining a plurality of objects into one, for example, combining encoded data and metadata into a single data item, which means one usage of “associated with” described above.

Furthermore, the effects described in the specification are not limiting. That is, the present disclosure can exhibit other effects.

In addition, an embodiment of the present disclosure is not limited to the embodiments described above, and various changes and modifications may be made without departing from the scope of the present disclosure.

Additionally, the present technology may also be configured as below.
(1)

An image processing apparatus including:

a prediction unit configured to generate a predicted image by performing motion compensation on a reference image in one mode among a translation mode in which the motion compensation is performed by translation, an affine transformation mode in which the motion compensation is performed by an affine transformation, a translation-rotation mode in which the motion compensation is performed by translation and rotation, and a translation-scaling mode in which the motion compensation is performed by translation and scaling.
(2)

The image processing apparatus according to (1), in which the prediction unit performs the motion compensation on the reference image on the basis of one motion vector in a case in which the motion compensation is performed on the reference image in the translation mode.
(3)

The image processing apparatus according to (1) or (2), in which the prediction unit performs the motion compensation by performing the affine transformation on the reference image based on two motion vectors in a case in which the motion compensation is performed on the reference image in the affine transformation mode.
(4)

The image processing apparatus according to any one of (1) to (3), in which the prediction unit performs the motion compensation on the reference image on the basis of one motion vector and a rotational angle in a case in which the motion compensation is performed on the reference image in the translation-rotation mode.
(5)

The image processing apparatus according to any one of (1) to (3), in which the prediction unit performs the motion compensation on the reference image on the basis of one motion vector and a difference between the one motion vector and another motion vector in a vertical direction in a case in which the motion compensation is performed on the reference image in the translation-rotation mode.
(6)

The image processing apparatus according to (5), in which the prediction unit obtains a difference between the one motion vector and the other motion vector in a horizontal direction using the difference in the vertical direction and performs the motion compensation on the reference image on the basis of the one motion vector, the difference in the vertical direction, and the difference in the horizontal direction.
(7)

The image processing apparatus according to any one of (1) to (6), in which, in a case in which the motion compensation is performed on the reference image in the translation-scaling mode, the prediction unit performs the motion compensation on the reference image on the basis of one motion vector and a scaling ratio.
(8)

The image processing apparatus according to any one of (1) to (6), in which, in a case in which the motion compensation is performed on the reference image in the translation-scaling mode, the prediction unit performs the motion compensation on the reference image on the basis of one motion vector and a difference between the one motion vector and another motion vector in a horizontal direction.
(9)

The image processing apparatus according to any one of (1) to (8), further including:

a setting unit configured to set affine transformation information indicating the affine transformation mode, the translation-rotation mode, or the translation-scaling mode.
(10)

The image processing apparatus according to any one of (1) to (8), further including:

a setting unit configured to set translation expansion information indicating the translation-rotation mode or the translation-scaling mode.
(11)

The image processing apparatus according to any one of (1) to (8), further including:

a setting unit configured to set translation rotation information indicating the translation-rotation mode.
(12)

The image processing apparatus according to any one of (1) to (8), in which the prediction unit performs the motion compensation on the reference image in the affine transformation mode, the translation-rotation mode, or the translation-scaling mode on the basis of affine transformation information indicating the affine transformation mode, the translation-rotation mode, or the translation-scaling mode.
(13)

The image processing apparatus according to any one of (1) to (8) or (12), in which the prediction unit performs the motion compensation on the reference image in the translation-rotation mode or the translation-scaling mode on the basis of translation expansion information indicating the translation-rotation mode or the translation-scaling mode.
(14)

The image processing apparatus according to any one of (1) to (8), (12), or (13), in which the prediction unit performs the motion compensation on the reference image in the translation-rotation mode on the basis of translation rotation information indicating the translation-rotation mode.
(15)

An image processing method including:

a prediction step of generating, by an image processing apparatus, a predicted image by performing motion compensation on a reference image in one mode among a translation mode in which the motion compensation is performed by translation, an affine transformation mode in which the motion compensation is performed by an affine transformation, a translation-rotation mode in which the motion compensation is performed by translation and rotation, and a translation-scaling mode in which the motion compensation is performed by translation and scaling.

### REFERENCE SIGNS LIST

100 image encoding apparatus
101 control unit
119 prediction unit
200 image decoding apparatus
216 prediction unit

1. An image processing apparatus comprising:
a prediction unit configured to generate a predicted image by performing motion compensation on a reference image in one mode among a translation mode in which the motion compensation is performed by translation, an affine transformation mode in which the motion compensation is performed by an affine transformation, a translation-rotation mode in which the motion compensation is performed by translation and rotation, and a translation-scaling mode in which the motion compensation is performed by translation and scaling.

2. The image processing apparatus according to claim 1, wherein the prediction unit performs the motion compensation on the reference image on a basis of one motion vector in a case in which the motion compensation is performed on the reference image in the translation mode.

3. The image processing apparatus according to claim 1, wherein the prediction unit performs the motion compensation by performing the affine transformation on the reference image based on two motion vectors in a case in which the motion compensation is performed on the reference image in the affine transformation mode.

4. The image processing apparatus according to claim 1, wherein the prediction unit performs the motion compensation on the reference image on a basis of one motion vector and a rotational angle in a case in which the motion compensation is performed on the reference image in the translation-rotation mode.

5. The image processing apparatus according to claim 1, wherein the prediction unit performs the motion compensation on the reference image on a basis of one motion vector and a difference between the one motion vector and another motion vector in a vertical direction in a case in which the motion compensation is performed on the reference image in the translation-rotation mode.

6. The image processing apparatus according to claim 5, wherein the prediction unit obtains a difference between the one motion vector and the other motion vector in a horizontal direction using the difference in the vertical direction and performs the motion compensation on the reference image on a basis of the one motion vector, the difference in the vertical direction, and the difference in the horizontal direction.

7. The image processing apparatus according to claim 1, wherein, in a case in which the motion compensation is performed on the reference image in the translation-scaling mode, the prediction unit performs the motion compensation on the reference image on a basis of one motion vector and a scaling ratio.

8. The image processing apparatus according to claim 1, wherein, in a case in which the motion compensation is performed on the reference image in the translation-scaling mode, the prediction unit performs the motion compensation on the reference image on a basis of one motion vector and a difference between the one motion vector and another motion vector in a horizontal direction.

9. The image processing apparatus according to claim 1, further comprising:
a setting unit configured to set affine transformation information indicating the affine transformation mode, the translation-rotation mode, or the translation-scaling mode.

10. The image processing apparatus according to claim 1, further comprising:
a setting unit configured to set translation expansion information indicating the translation-rotation mode or the translation-scaling mode.

11. The image processing apparatus according to claim 1, further comprising:
a setting unit configured to set translation rotation information indicating the translation-rotation mode.

12. The image processing apparatus according to claim 1, wherein the prediction unit performs the motion compensation on the reference image in the affine transformation mode, the translation-rotation mode, or the translation-scaling mode on a basis of affine transformation information indicating the affine transformation mode, the translation-rotation mode, or the translation-scaling mode.

13. The image processing apparatus according to claim 1, wherein the prediction unit performs the motion compensation on the reference image in the translation-rotation mode or the translation-scaling mode on a basis of translation expansion information indicating the translation-rotation mode or the translation-scaling mode.

14. The image processing apparatus according to claim 1, wherein the prediction unit performs the motion compensation on the reference image in the translation-rotation mode on a basis of translation rotation information indicating the translation-rotation mode.

15. An image processing method comprising:
a prediction step of generating, by an image processing apparatus, a predicted image by performing motion compensation on a reference image in one mode among a translation mode in which the motion compensation is performed by translation, an affine transformation mode in which the motion compensation is performed by an affine transformation, a translation-rotation mode in which the motion compensation is performed by translation and rotation, and a translation-scaling mode in which the motion compensation is performed by translation and scaling.
